(19) United States
(12) Patent Application Publication
(10) Pub. No.: US 2025/0259082 A1
(43) Pub. Date: Aug. 14, 2025

(54) AI AGENT DECISION PLATFORM WITH DEONTIC REASONING AND QUANTUM-INSPIRED TOKEN MANAGEMENT

(71) Applicant: QOMPLX LLC, Reston, VA (US)

(72) Inventors: Jason Crabtree, Vienna, VA (US); Richard Kelley, Woodbridge, VA (US); Jason Hopper, Halifax (CA); David Park, Fairfax, VA (US)

(21) Appl. No.: 19/078,256

(22) Filed: Mar. 12, 2025

Related U.S. Application Data
(63) Continuation-in-part of application No. 19/041,999, filed on Jan. 31, 2025.
Application No. 19/041,999 is a continuation-in-part of application No. 18/656,612, filed on May 7, 2024.
(60) Provisional application No. 63/551,328, filed on Feb. 8, 2024.

(51) Int. Cl. G06N 5/02

(52) U.S. Cl. CPC G06N 5/027

(57) ABSTRACT

A system and method for extending AI-enhanced decision platforms with deontic and normative reasoning capabilities that enhance adjustably autonomous decision-making through a novel integration of symbolic and neural approaches alongside quantum-inspired token management. The invention uses hierarchical and fuzzy deontic logic implementations and quantum-inspired state representations that combine complex amplitudes and phase information to manage obligations, permissions, and prohibitions while maintaining observer awareness to achieve complex goals while incorporating knowledge across multiple expert domains. The system employs dynamic event and spatio-temporal knowledge graphs along with debate mechanisms, enabling high-assurance automated reasoning while preserving explainability through neuro-symbolic integration and information-theoretic metrics. The platform is capable of operating through a federated distributed computational graph architecture that allows for arbitrary scaling while maintaining system coherence and logical consistency using quantum-inspired token operations and phase alignment transformations for optimizing information transfer between states.

### CROSS-REFERENCE TO RELATED APPLICATIONS

Priority is claimed in the application data sheet to the following patents or patent applications, each of which is expressly incorporated herein by reference in its entirety:
Ser. No. 19/041,999
Ser. No. 18/656,612
63/551,328

### BACKGROUND OF THE INVENTION

### Field of the Art

The present invention relates to federated large-scale cloud and edge computing, and more particularly to federated distributed graph-based computing platforms designed to enhance artificial intelligence based on enabled compliant decision-making, user experiences, and intelligent automation capabilities using deontic reasoning capabilities for individuals and groups across heterogeneous computing environments, including but not limited to cloud infrastructures, managed data centers, edge computing nodes, wearable/mobile devices, embedded devices, and robotics. By leveraging federated neuro-symbolic AI architectures, this invention ensures scalable, ethically aligned AI interactions within dynamic multi-agent ecosystems while maintaining compliance with regulatory, operational, and security constraints.

### Discussion of the State of the Art

The increasingly rapid evolution of artificial intelligence systems and computing experiences, particularly in multi-agent and distributed computing environments, has highlighted challenges in coordinating AI agent behaviors while ensuring ethical, legal, and operational compliance, especially across multiple devices, roles, and personas. Traditional approaches to AI agent goal specification, analysis, reasoning, action facilitation, policy adherence, and coordination typically rely on rigid rule-based (expert systems, explicitly encoded logic) systems or purely neural-based architectures, neither of which adequately addresses the need for flexible yet principled decision-making in complex real-world scenarios or addresses role-specific, task-specific, and other contextual factors core to improving outcomes and meeting ultimate human and application-level goals and objectives. The emergence of large language models (LLMs) and other AI technologies has further complicated this landscape by introducing powerful but potentially unpredictable agents that require careful oversight, ethical compliance layers, and constraint mechanisms, yet still lack acceptable levels of explainability, predictability, or trustworthiness and regularly demonstrate hallucination, inconsistency, or security vulnerabilities.

Current AI agent platforms or agentic applications primarily focus on task orchestration and completion and resulting completion and efficiency metrics, without robust mechanisms for encoding and enforcing obligations, permissions, and prohibitions that govern agent behavior (e.g., autonomous decision-making consistency), agent-in-application behavior (e.g., how agents interact with various applications), and emergent risks and states created when building or operating compound agentic systems and application at scale. While some systems implement basic rule-following capabilities (e.g., verification of schemas, keyword and category checks, schematization and serialization checks, or content blocks) or retrieval-augmented generation (RAG) and rule setups, they typically lack the sophistication to handle complex normative reasoning and iterative problem-solving with the context and continuity that many important real-world applications demand. This is powerfully evidenced by ongoing gap analysis in explainability, unlearning, jailbreaking, and hallucination or falsehood research for individual or mixtures of agents with or without chain-of-thought or other iterative attempts at reasoning-like behavior. This limitation becomes particularly acute in scenarios involving multiple agents operating across different jurisdictions, regulatory frameworks, and ethical contexts, and is further complicated when agents interact as part of larger applications or when mixtures of compound agents and applications and people interact with one another with varied degrees of the data flow process, data and model provenance, or even participants making decision-making provenance and traceability unlikely or untrusted.

Most existing agent coordination systems rely either on centralized control and orchestration architectures that create bottlenecks, scalability limitations, and single points of failure, or on decentralized approaches that struggle to maintain consistent provenance, traceability, explainability, and behavioral alignment across the system (in both single-agent and multi-agent contexts). The challenge of balancing individual agent or team autonomy with system-wide governance constraints and goals remains largely unresolved. Furthermore, these systems often lack the ability to adapt their constraints dynamically or to adjust themselves to meet practical objectives, especially if those objectives are specified informally such as via natural language and not expressly declared objective functions, in response to changing contexts, and they struggle to reason about the implications of their actions across different temporal and operational scales. These limitations become particularly apparent when systems operate in conditions dissimilar or contradictory to their training datasets, or when they face adversarial activity from other actors, whether in-part or wholly human or artificial or agentic applications.

What is needed is a federated neuro-symbolic compound agentic platform that seamlessly integrates deontic logic and normative reasoning capabilities with modern AI technologies, enabling principled yet flexible agent enabled behavior and adjustable automation in complex, real-world environments. Such a system must be capable of managing distributed agent interactions efficiently while maintaining rigorous compliance with ethical, legal, and operational constraints, all while scaling effectively across heterogeneous computing environments and dynamically adapting to evolving regulatory and operational requirements.

### SUMMARY OF THE INVENTION

Accordingly, the inventor has conceived and reduced to practice, an AI agent decision platform with deontic reasoning and quantum-inspired token management. The agent platform represents an innovative approach to multi-agent coordination that combines deontic reasoning and normative reasoning with sophisticated knowledge exchange mechanisms. At its core, the platform employs domain-specific expert agents—including legal, medical, robotic, observer, and leadership agents—each maintaining domain-specific expertise and unique knowledge bases while operating within a framework of ethical constraints. These agents collaborate within a dynamic framework of ethical constraints, enabling rapid geometric debate and automated decision-making while preserving semantic relationships across agent reasoning processes, ethical and legal compliance boundaries, and a mix of agent-specific, group-specific, or platform level knowledge corpora. The platform's federation manager coordinates agent activities while a deontically informed role-based knowledge orchestrator maintains semantic consistency and contextual relevance across the system's distributed knowledge graphs and analysis processes.

What sets this platform apart is its implementation of advanced orchestration across multiple tiers and tessellations of compute-enabled devices alongside observer-aware processing and dynamic responsibility allocation. Agents can assume different roles based on task requirements and cognitive load assessments (e.g., for themselves, a group of agents or bots, a paired human or groups of people, or hybrid blends of multiple participants), with sophisticated monitoring systems ensuring optimal task distribution between human and machine agents or groups. The platform incorporates advanced resource management capabilities that balance computational needs with overarching goals and context alongside broader longstanding and situation-specific ethical considerations, while maintaining explainability and decision-making or chain-of-thought provenance through generated human-readable outputs or human-understandable outputs (which may be stored or compressed into non-human readable forms). By integrating large language models with deontic reasoning, normative reasoning, and semantic knowledge representations distilled from broader simulated, synthetic and empirical observations, the platform enables agents to engage in collegiate-style debates and knowledge exchange, mimicking practical academic or applied discourse to observer, orient, decide, and act on an ongoing while maintaining strict ethical compliance and operational efficiency across changing active sets of considerations with varied finite time horizons of interest.

According to a preferred embodiment, a computing system comprising a hardware memory, wherein the computer system is configured to execute software instructions stored on non-transitory machine-readable storage media that: receive a plurality of tokens representing deontic constraints and domain-specific knowledge; encode the plurality of tokens into a plurality of quantum state representations, wherein each quantum state representation comprises complex amplitudes and phase information; calculate a plurality of information-theoretic metrics for the quantum state representations, wherein the information-theoretic metrics comprise von

Neumann entropy and quantum mutual information; generate quantum similarity scores between the plurality of quantum state representations based on the calculated plurality of information-theoretic metrics; create weighted superpositions of quantum state representations according to a plurality of priority weights; apply a plurality of phase alignment transformations to the weighted superpositions to maximize coherence between quantum-inspired state representations; generate compute graphs for distributing quantum token operations across processing nodes while maintaining deontic constraints; and update knowledge graphs with the quantum state representations, is disclosed.

According to a preferred embodiment, a computing system for an AI agent decision platform with deontic and normative reasoning, the computing system comprising: one or more hardware processors configured for: receiving a plurality of tasks at a network of specialized AI agents, wherein each agent comprises domain-specific knowledge and is bound by deontic constraints comprising at least one of either obligations, permissions, prohibitions, social norms, or actions and consequences stored in knowledge graphs; forwarding the plurality of tasks to a centralized distributed graph-based system incrementally or en masse; analyzing the tasks using a deontic reasoning subsystem to evaluate compliance with the stored deontic constraints from knowledge graphs; generating a plurality of potential compute graphs that represent the plurality of subtasks, which may be calculated before or at the execution time of a pipeline or pipeline step; decomposing compliant tasks into subtasks based on agent domain expertise and associated deontic or normative constraints or goals; generating compute graphs that represent the subtasks with their associated deontic constraints or goals; distributing the tasks or compute graphs to agents within the network based on the agents' domain expertise, available resources, and deontic permissions or goals (optionally to include agent-based supervision, judging or supervision agent selection and role declaration by system); and executing the subtasks while maintaining compliance with the stored deontic constraints or goals, is disclosed.

According to a preferred embodiment, a computer-implemented method for an AI agent decision platform with deontic reasoning and quantum-inspired token management, the computer-implemented method comprising the steps of: receiving a plurality of tokens representing deontic constraints and domain-specific knowledge; encoding the plurality of tokens into a plurality of quantum state representations, wherein each quantum state representation comprises complex amplitudes and phase information; calculating a plurality of information-theoretic metrics for the quantum state representations, wherein the information-theoretic metrics comprise von Neumann entropy and quantum mutual information; generating quantum similarity scores between the plurality of quantum state representations based on the calculated plurality of information-theoretic metrics; creating weighted superpositions of quantum state representations according to a plurality of priority weights; applying a plurality of phase alignment transformations to the weighted superpositions to maximize coherence between quantum-inspired state representations; generating compute graphs for distributing quantum token operations across processing nodes while maintaining deontic constraints; and updating knowledge graphs with the quantum state representations, is disclosed.

According to a preferred embodiment, the system implements an optional token-space concurrency with operations, where multiple specialized agents converge on decisions with minimal latency using geometric and wave-interference mechanisms for combining and evaluating vector embeddings within a high-dimensional token space. Rather than requiring physical quantum computing hardware or quantum entanglement, these operations draw conceptual parallels from quantum superposition, treating each agent's partial states (e.g., constraints, risk indicators, or subtask results) like waveforms whose amplitudes and phases can constructively or destructively interfere. Each token captures both magnitude (e.g., a confidence score) and a learned phase or direction encoding the agent's current stance or domain-specific perspective, enabling rapid detection of consensus or conflicts among agents without requiring full multi-round dialogues. The system's geometric interpretation allows efficient parallel evaluation of multiple agent perspectives by encoding them as vectors in a high-dimensional space where similarity and conflicts can be detected through mathematical operations analogous to wave interference patterns. The embedding framework incorporates a graph neural network that processes and learns from complex relational data, enabling the system to capture subtle patterns and relationships through geometric operations in token space. Domain-specific embeddings implement specialized knowledge representations for different fields using techniques from relation-aware entity alignment research, operating in high-dimensional spaces that preserve semantic relationships while enabling efficient computation through quantum-inspired operations. For instance, when specialized agents must coordinate under time pressure, token-space operations allow them to exchange ephemeral “micro-updates” of their states, unifying or flagging collisions as vectors misalign. While the architecture optionally permits integration with genuine quantum computing resources for specialized optimizations or advanced search routines, the primary implementation uses classical, geometry-based methods that borrow wave-like principles to enhance how information is merged and compared at scale. The system employs these token-space operations within its collegiate-style debate framework, enabling structured argumentation between different specialized agents through rapid geometric interactions while maintaining deontic constraints. This integration extends to the system's advanced information theoretic principles, which optimize knowledge transfer between components using mutual information measurements and transfer entropy calculations to quantify and optimize information flow between different knowledge domains. By coupling this quantum-inspired token-space concurrency with the deontic reasoning subsystem, the platform ensures any partial agreement emerging from geometric unification respects obligations, permissions, and prohibitions before finalizing actions, while maintaining the sophisticated causal entropy measurements used to understand and maintain causal relationships within the knowledge structure.

According to a preferred embodiment, while the system can utilize standard LazyGraphRAG approaches for basic retrieval tasks, it implements a significantly enhanced spatiotemporal and event-capable variant that fundamentally extends beyond traditional LazyGraphRAG capabilities. This enhanced embodiment adds several components: 1) a sophisticated event knowledge graph (EKG) that treats events as first-class nodes complete with timestamps, participants, triggers, outcomes and location references; 2) a spatiotemporal knowledge graph (STKG) that integrates both temporal and spatial dimensions where nodes and edges carry spatial coordinates plus temporal intervals, enabling phenomena like movements of vehicles or changes in climate data to be represented; 3) a multi-layered knowledge graph that implements specialized node types including entity nodes and deontic nodes, with edges labeled for relationships like “Applies to”, “overrides or ConflictsWith,” and “TemporalValidity”; and 4) a deontic reasoning subsystem that enforces obligations, permissions, and prohibitions at each retrieval step. Unlike traditional LazyGraphRAG which primarily focuses on chunk-based text retrieval with minimal overhead, this enhanced variant enables true real-time, event-driven intelligence and advanced location and time-based retrieval through deep integration of EKG and STKG features. The system supports iterative expansions that factor in both textual relevance and spatiotemporal constraints, yielding a more nuanced, multi-dimensional retrieval experience that unifies textual evidence with numeric or geometry-based properties in the same knowledge retrieval pass. Through this comprehensive enhancement of the base LazyGraphRAG approach, the system achieves capabilities essential for complex real-world applications requiring sophisticated spatiotemporal reasoning and ethical compliance that would be impossible with standard LazyGraphRAG implementations alone.

According to a preferred embodiment, a computer-implemented method for an AI agent decision platform with normative and deontic reasoning, the computer-implemented method comprising the steps of: receiving a goal or objective, determining a potential set of associated tasks, determining a data flow, process flow, and control flow for a plurality of tasks and preparing it for submission to a distributed computational graph based network of orchestration and compute nodes with at least one specialized model or agent, wherein each model or agent was trained upon or fine-tuned or is augmented by (e.g., via RAG or vector database) domain-specific knowledge and is bound by deontic constraints comprising at least one of either obligations, permissions, social norms, prohibitions, actions or consequences stored in knowledge graphs or vectorized representations; forwarding the plurality of tasks to a centralized distributed graph-based processing system; analyzing the ongoing tasks and emergent data and process flows throughout emergent pipeline execution, dynamic branching, and pruning processes using a deontic reasoning subsystem to evaluate compliance with the stored deontic constraints and goals; generating a plurality of active and potential compute graphs that represent the plurality of executed, potential, or in-execution subtasks; decomposing compliant tasks into subtasks or subgraphs based on agent domain expertise and associated deontic constraints or goals; generating compute graphs that represent the subtasks or subgraphs with their associated deontic constraints; generating additional graph layers or edges relating appropriateness of potential models or agents known to the system with various tasks to aid in agent and model selection traversals and optimization; parameterizing tasks (e.g., injecting the appropriate model or agent selection) from the available set for a given task node from scored, ranked, or constraint-satisfied entities; distributing en masse or incrementally during ongoing computation the compute graphs or subgraphs to all or a selection of models agents within the network based on availability, resource constraints, and the agents' domain expertise and deontic permissions and appropriateness metrics; and executing the subtasks while maintaining compliance and logging execution and observability details supporting provenance and performance management of resultant data and process elements with the stored deontic constraints, is disclosed.

According to a preferred embodiment, a system for an AI agent decision platform with normative or deontic reasoning, comprising one or more computers or mobile/wearables, embedded, or robotic devices with executable instructions that, when executed, cause the system to: receive a plurality of tasks directed to a network of specialized agents, wherein each agent comprises domain-specific models, knowledge, context, or training and is bound by deontic goals or constraints comprising at least one of either obligations, permissions, or prohibitions stored in knowledge graphs; forwarding the plurality of tasks to a centralized distributed graph-based system; analyze the tasks using a deontic reasoning subsystem to evaluate compliance with the stored deontic constraints; generating a plurality of compute graphs that represent the plurality of subtasks; decompose compliant tasks into subtasks based on agent domain expertise and associated deontic constraints; generate compute graphs that represent the subtasks with their associated deontic constraints; distribute the compute graphs, subgraphs, or tasks to agents within the network based on the agents' domain expertise and deontic permissions; and execute the subtasks while maintaining compliance with the stored deontic constraints, is disclosed.

According to a preferred embodiment, the system implements an optional token-space concurrency with operations, where multiple specialized agents converge on decisions with minimal latency using geometric and wave-interference mechanisms for combining and evaluating vector embeddings within a high-dimensional token space. Rather than requiring physical quantum computing hardware or quantum entanglement, these operations draw conceptual parallels from quantum superposition, treating each agent's partial states (e.g., constraints, risk indicators, or subtask results) like waveforms whose amplitudes and phases can constructively or destructively interfere. Each token captures both magnitude (e.g., a confidence score) and a learned phase or direction encoding the agent's current stance or domain-specific perspective, enabling rapid detection of consensus or conflicts among agents without requiring full multi-round dialogues. The system's geometric interpretation allows efficient parallel evaluation of multiple agent perspectives by encoding them as vectors in a high-dimensional space where similarity and conflicts can be detected through mathematical operations analogous to wave interference patterns. The embedding framework incorporates a graph neural network that processes and learns from complex relational data, enabling the system to capture subtle patterns and relationships through geometric operations in token space. Domain-specific embeddings implement specialized knowledge representations for different fields using techniques from relation-aware entity alignment research, operating in high-dimensional spaces that preserve semantic relationships while enabling efficient computation through quantum-inspired operations. For instance, when specialized agents must coordinate under time pressure, token-space operations allow them to exchange ephemeral “micro-updates” of their states, unifying or flagging collisions as vectors misalign. While the architecture optionally permits integration with genuine quantum computing resources for specialized optimizations or advanced search routines, the primary implementation uses classical, geometry-based methods that borrow wave-like principles to enhance how information is merged and compared at scale. The system employs these token-space operations within its collegiate-style debate framework, enabling structured argumentation between different specialized agents through rapid geometric interactions while maintaining deontic constraints. This integration extends to the system's advanced information theoretic principles, which optimize knowledge transfer between components using mutual information measurements and transfer entropy calculations to quantify and optimize information flow between different knowledge domains. By coupling this quantum-inspired token-space concurrency with the deontic reasoning subsystem, the platform ensures any partial agreement emerging from geometric unification respects obligations, permissions, and prohibitions before finalizing actions, while maintaining the sophisticated causal entropy measurements used to understand and maintain causal relationships within the knowledge structure.

According to an aspect of an embodiment, the agents may be human or non-human agents.

According to an aspect of an embodiment, the agents receive feedback and adjust task allocation based on the feedback.

According to an aspect of an embodiment, knowledge graphs are updated based on a plurality of contextual data and sensor data.

According to an aspect of an embodiment, sensor data includes but is not limited to Internet of Things (IoT) data, medical device data, wearable device data, video data, and image data.

### BRIEF DESCRIPTION OF THE DRAWING FIGURES

FIG. 1 is a block diagram illustrating an exemplary system architecture for an AI agent decision platform with deontic reasoning.

FIG. 2 is a block diagram illustrating an exemplary system architecture for an AI agent decision platform with deontic reasoning that can be configured with edge devices.

FIG. 3 is a block diagram illustrating an exemplary component of a system for an AI agent decision platform with deontic reasoning, a deontic reasoning subsystem.

FIG. 4 is a block diagram illustrating an exemplary component of a system for an AI agent decision platform with deontic reasoning, a deontic learning training subsystem.

FIG. 5 is a block diagram illustrating an exemplary component of a system for an AI agent decision platform with deontic reasoning, an agent network.

FIG. 6 is a block diagram illustrating an exemplary component of a system for an AI agent decision platform with deontic reasoning, a knowledge graph network.

FIG. 7 is a block diagram illustrating an exemplary component of a system for an AI agent decision platform with deontic reasoning wherein an agent can predict and optimize actions based on user feedback and contextual information.

FIG. 8 is a block diagram illustrating an exemplary component of a system for an AI agent decision platform with deontic reasoning and agents organized in a hierarchy that store task and action information.

FIG. 9 is a block diagram illustrating an exemplary component of a system for an AI agent decision platform with deontic reasoning and an integrated LLM network capable of managing resources.

FIG. 10 is a flow diagram illustrating an exemplary method for an AI agent decision platform with deontic reasoning that can be configured with edge devices.

FIG. 11 is a flow diagram illustrating an exemplary method for updating knowledge graphs based on incoming sensor and contextual information.

FIG. 12 is a flow diagram illustrating an exemplary method for integrating deontic constraints into UCT planning.

FIG. 13 is a flow diagram illustrating an exemplary method of an AI agent decision platform with deontic reasoning with task optimization and monitoring.

FIG. 14 is a flow diagram illustrating an exemplary method for integrating specialized knowledge into a knowledge graph and leveraging the platform in a simulated routine surgery.

FIG. 15 is a block diagram illustrating an exemplary system architecture for a distributed generative artificial intelligence reasoning and action platform, according to an embodiment.

FIG. 16 is a block diagram illustrating an exemplary aspect of a distributed generative AI reasoning and action platform incorporating various additional contextual data.

FIG. 17 is a diagram illustrating incorporating symbolic reasoning in support of LLM-based generative AI, according to an aspect of a neuro-symbolic generative AI reasoning and action platform.

FIG. 18 is a diagram of an exemplary architecture for a system for rapid predictive analysis of very large data sets using an actor-driven distributed computational graph, according to one aspect.

FIG. 19 is a diagram of an exemplary architecture for a system for rapid predictive analysis of very large data sets using an actor-driven distributed computational graph, according to one aspect.

FIG. 20 is a diagram of an exemplary architecture for a system for rapid predictive analysis of very large data sets using an actor-driven distributed computational graph, according to one aspect.

FIG. 21 is a block diagram of an architecture for a transformation pipeline within a system for predictive analysis of very large data sets using a distributed computational graph computing system.

FIG. 22 is a block diagram illustrating an exemplary system architecture for a federated distributed graph-based computing platform.

FIG. 23 is a block diagram illustrating an exemplary system architecture for a federated distributed graph-based computing platform that includes a federation manager.

FIG. 24 is a block diagram illustrating an exemplary component of a federated distributed graph-based computing platform that includes a federation manager, the federation manager.

FIG. 25 is a block diagram illustrating an exemplary system architecture for a federated distributed graph-based computing platform that includes a federation manager where different compute graphs are forward to various federated distributed computation graph systems.

FIG. 26 is a flow diagram illustrating an exemplary method for a federated distributed graph-based computing platform.

FIG. 27 is a flow diagram illustrating an exemplary method for a federated distributed graph-based computing platform that includes a federation manager.

FIG. 28 is a block diagram illustrating an exemplary system architecture for an AI agent decision platform with deontic reasoning and quantum-inspired token management.

FIG. 29 is a block diagram illustrating an exemplary system architecture depicting the core components in an AI agent decision platform with deontic reasoning and quantum-inspired token management.

FIG. 30 is a block diagram illustrating an exemplary component of a system for an AI agent decision platform with deontic reasoning and quantum-inspired token management, quantum knowledge orchestrator.

FIG. 31 is a block diagram illustrating an exemplary component of a system for an AI agent decision platform with deontic reasoning and quantum-inspired token management, quantum inspired similarity.

FIG. 32 is a block diagram illustrating an exemplary component of a system for an AI agent decision platform with deontic reasoning and quantum-inspired token management, a quantum knowledge graph network.

FIG. 33 is a flow diagram illustrating an exemplary method for implementing quantum-inspired token management in a deontic reasoning system.

FIG. 34 is a flow diagram illustrating an exemplary method for implementing quantum-inspired agent debate mechanisms in a deontic reasoning system.

FIG. 35 is a flow diagram illustrating an exemplary method for managing temporal deontic constraints for an AI agent decision platform with deontic reasoning and quantum-inspired token management.

FIG. 36 is a flow diagram illustrating an exemplary method for implementing dynamic deontic circuit breakers in a system for an AI agent decision platform with deontic reasoning and quantum-inspired token management.

FIG. 37 illustrates an exemplary computing environment on which an embodiment described herein may be implemented.

### DETAILED DESCRIPTION OF THE INVENTION

The inventor has conceived and reduced to practice an AI agent decision platform with deontic reasoning and quantum-inspired token management. The platform represents a sophisticated AI-enhanced decision system that seamlessly integrates ethical reasoning with distributed computing, enabling automated decision-making across multiple domains in complex, federated, and resource-constrained environments. At its core, the system employs a novel fusion of symbolic and neural approaches, utilizing quantum-inspired token space operations and advanced information theoretic principles in certain embodiments to achieve both logical consistency and operational efficiency. The platform's federated distributed computational graph (DCG) architecture facilitates seamless scaling, while its integrated semantic knowledge corpora-governed by role-based and deontic access constraints enables system components, individual constituent models, and agents to maintain system-wide compliance, preserve privacy, enforce ethical constraints, and manage knowledge relationships. This architecture further supports knowledge corpora development and curation within appropriate access pools.

A key innovation is the platform's ability to coordinate numerous and distinct specialized agents (which may also have additional heterogeneity such as in their embeddings, input or output formats, resource use or needs, execution costs, license terms, ethical restrictions, other legal use restrictions such as export bans or sale restrictions) through a collegiate-style knowledge exchange framework that enables structured debates and dynamic ongoing task, computational subgraph formulation, allocation, and dissemination. The system maintains sophisticated observer-aware processing capabilities that ensure appropriate perspective and context across different knowledge domains, spatial localities and contexts, or temporal frames. Through its integration of large language models, other AI/ML techniques modeling simulation, spatiotemporal and event enhanced knowledge graphs with supporting vector databases and structured/unstructured databases (e.g., SQL, noSQL, graph, document, key value), and normative and deontic reasoning, the platform can handle complex scenarios requiring cross-domain expertise while maintaining strict reasoning processes, threshold based sufficiency scoring, analysis and data fidelity monitoring, role or team-level ethical, normative data and model compliance and auditability. Resource management and task optimization are handled through advanced mechanisms that consider both computational efficiency and ethical implications, enabling the system to balance operational requirements with moral constraints. The result is a highly adaptable, ethically-sound decision-making platform that can operate across various domains while maintaining transparency, accountability, and logical consistency).

The present invention addresses fundamental limitations in traditional machine learning and artificial intelligence approaches to AI-enhanced decision-making and automation processes. While neural network-based systems excel at pattern recognition and general task completion, they struggle with providing verifiable logical reasoning and guaranteed correctness in decision-making processes. This limitation becomes particularly acute in scenarios requiring explicit reasoning about obligations, permissions, and prohibitions—the domain of deontic logic. By combining normative and deontic reasoning capabilities with modern AI-based or enhanced reasoning and planning technologies, the system achieves both the flexibility of machine learning, AI methods and the verifiable correctness of formal logical systems. The system further extends its capabilities through the incorporation of variants of formal logic, which enhance formal logic and rule performance beyond historical norms. For example, the system can extend standard rule-based languages (such as Datalog or Vadalog, which typically operate with existential rules or tuple-generating dependencies) to a fuzzy setting by implementing arbitrary t-norms in place of classical conjunctions in rule bodies. The system may also incorporate advanced logical frameworks including dyadic existential rules for Datalog, or similar extensions for other formal logic languages such as Vadalog, DDlog, Prolog, Logica, Yedalog, Answer Set Programming (including Potassco), Mercury, or Curry. This implementation enables sophisticated reasoning capabilities while maintaining computational efficiency and logical consistency across the platform's distributed architecture. Specifically, the system implements dyadic decomposable sets that provide decidable query answering while maintaining polynomial data complexity for various rule classes. The platform leverages the key properties of dyadic pairs of tuple-generating dependencies (TGDs), where one component contains head-ground rules that generate only ground facts, and the other component belongs to an underlying decidable class of rules. This architectural choice ensures that query evaluation complexity remains within PTIME for data complexity when the underlying class exhibits polynomial data complexity, and within EXPTIME for combined complexity when there is an exponential gap between data and combined complexities. The system's implementation of dyadic existential rules allows it to systematically decompose complex rule sets into more manageable components while preserving decidability and computational efficiency properties. The platform employs an evolved hybrid approach to selectively formalize rule-based knowledge and reasoning, combining mixtures and debate between AI agents, specialized models, authoritative data sources, structured expert judgment, and corpora of rulesets to maintain rigorous yet adjustable logical consistency while handling the complexity and scale of real-world applications. The system's architecture ensures that all decisions are optimal not only from an operational perspective but also provably compliant with defined ethical and regulatory constraints, priorities, and objectives. This compliance is verified through multiple mechanisms including formalized checks, consensus or model blends, accumulated evidence/agreement, model-based expert judgment or debate, and selective crowdsourcing with supplemental human experts. This architectural approach has significant implications for both trustworthiness and explainability scoring, rating, estimation, and risk determination for individual transformations, subgraphs, or full end-to-end data and process flows, particularly when orchestrated through federated distributed computational graphs. The system ensures that rules, data flow, control flow, and execution topologies (both explicit and implicit) across federated resources can be analyzed through a priori or pre-mortem analysis, during execution, and through post-hoc evaluation to verify that individual transformation steps (such as persistence, query, model execution/evaluation, retraining, and rule evaluation) are answerable. The system can therefore evaluate characteristics of individual transformations, subgraphs, or full pipelines including computational complexity estimation, resource utilization, evaluation time, cost, processing nature (e.g., transactional guarantees such as at-least-once versus exactly-once or none), and decidability of model response or query answering.

Many advanced features disclosed in the parent patent applications may be used with one or more embodiments. Neuro-symbolic integration addresses a fundamental challenge in AI by combining connectionist and symbolic approaches. The system recognizes that foundational large language models (like GPT-3 and GPT-4) are connectionist AI models with neural network architectures containing billions of parameters, but lack explicit symbolic representations or rules. To bridge this gap, the system integrates both approaches by combining the pattern-recognition strengths of deep neural networks with explicit symbolic reasoning capabilities. The architectural components reflect this hybrid approach through a specialized structure that combines connectionist elements (deep neural networks with millions to billions of parameters organized in interconnected layers) with symbolic systems. These neural networks employ distributed representation, where each neuron contributes to representing multiple features or concepts simultaneously, while the symbolic component maintains explicit representations of symbols and rules. The system then maps these learned representations to symbolic concepts and rules through a sophisticated integration process. This allows for both learning from massive amounts of data through the neural components while maintaining explicit knowledge representation through the symbolic elements. Unlike traditional connectionist models that struggle with hallucination, this integration enables the system to validate outputs against established knowledge bases, providing more reliable and verifiable results. The logic-based knowledge graphs serve as a foundation for maintaining and reasoning about these symbolic relationships, while the neural components handle pattern recognition and learning from unstructured data. The system implements a sophisticated approach to combining neural and symbolic processing through several key interconnected mechanisms. At its foundation, the system maps learned patterns to symbolic rules through a carefully orchestrated multi-step process. This begins with obtaining diverse input data, including enterprise knowledge and expert knowledge, which is processed through embedding models to create vectorized datasets. These vectorized datasets serve as training data for machine learning models that learn complex representations of the underlying patterns and relationships. The learned representations are then systematically mapped to symbolic concepts and rules, creating a crucial bridge between connectionist learning approaches and symbolic reasoning frameworks. This mapping process enables the system to translate the distributed representations learned by neural networks into explicit symbolic forms that can be manipulated using logical reasoning. The system's capabilities are significantly enhanced through RAG (Retrieval-Augmented Generation) integration, which provides a sophisticated mechanism for incorporating external knowledge sources and contextual data into the processing pipeline. The RAG functionality serves as a powerful tool for knowledge enhancement, allowing organizations to leverage proprietary datasets in a controlled manner. For example, a medical research company can share valuable information with other institutions through RAG-based augmentation rather than providing direct access to raw training data. The RAG marketplace described in the parent patent application enables the buying and selling of these knowledge augmentation capabilities, creating an ecosystem for knowledge sharing while protecting proprietary information. The RAG system can store vectorized context in specialized vector databases like Pinecone, enabling efficient retrieval and incorporation of relevant contextual information during processing. The other major component involves combining pattern matching with logical reasoning through an advanced neuro-symbolic architecture. This integration allows the system to leverage both the powerful pattern recognition capabilities of neural networks and the structured logical reasoning of symbolic systems. The platform implements this through a feedback loop where symbolic reasoning outputs are incorporated back into the neural network to refine learned representations over time. This bidirectional flow of information enables the system to perform sophisticated reasoning tasks while maintaining the ability to learn from and adapt to new data. The architecture supports various reasoning techniques, including logic rules and inference engines, which can be applied to the symbolic representations derived from the neural network's learned patterns. This combination allows the system to handle both the uncertainty and pattern recognition strengths of neural networks while maintaining the explicit reasoning capabilities of symbolic systems. The integration of these mechanisms is orchestrated through a distributed computational graph (DCG) that manages complex workflows and data pipelines. The DCG can dynamically select, create, and incorporate trained models with external data sources and marketplace components, enabling flexible deployment of these integrated capabilities in practical applications. This orchestration layer ensures that the mapping of learned patterns, RAG augmentation, and combined reasoning processes work together seamlessly to provide enhanced artificial intelligence capabilities.

In an exemplary embodiment, an orchestration system integrates Observer Theory, within a multi-tier hypergraph framework to direct ephemeral expansions, cloud or HPC or specialized device located tasks, and Cache-Augmented Generation (CAG) sub-models. The system ensures that all multiway expansions culminate in a single, unified “observer perspective,” thereby emulating a quantum-like “collapse” of partial states and guaranteeing a coherent vantage for user-consumable results.

At the core of this embodiment, the orchestrator is endowed with explicit “observer” constraints, reflecting two principal features: (1) computational boundedness (the observer cannot store or process all ephemeral expansions in unbounded fashion) and (2) persistent single-thread vantage (despite concurrency, the observer maintains a stable continuum of internal perspective). The orchestrator enforces these constraints by embedding specialized hypergraph nodes and edges that unify HPC ephemeral expansions, illusions synergy partial states, and domain-specific knowledge blocks (via CAG). This observer-centric approach compacts the underlying expansions into a single recognized vantage, forming the system's conclusive outcome for real-time execution.

In the multi-tier hypergraph orchestration scheme, the system defines new data structures to reflect observer-oriented constraints: Observer Node: A specialized node type that designates the observer's locus and perspective in a multi-tier environment. Each observer node is annotated with metadata specifying maximum steps, memory allowances, or analogous resource bounds (representing computational boundedness) and with persistence indicators requiring ephemeral expansions to converge into one canonical vantage state; Observation Edges: Edges that model the act of measurement, perception, or coarse-graining, thereby merging multiway expansions into observer-recognized equivalences. Multiple ephemeral expansions or illusions synergy sub-model states connect to the observer node via these edges, triggering a unification (or equivalencing) transform whenever resource/time constraints permit. In practice, expansions exceeding the observer's capacity are aggregated or pruned, ensuring the vantage remains singular; CAG Subgraphs (“Submarines”): Dedicated subgraphs or container-like modules preloaded with knowledge blocks in the form of key-value (KV) caches. The observer node “dispatches” or “requests” that these submarines be spawned co-located with the relevant data, thereby reducing retrieval overhead during illusions synergy or HPC ephemeral expansions. Partial merges from these submarine outputs continuously update the observer vantage subject to boundedness constraints; and Single-Thread Enforcement: The orchestrator ensures ephemeral expansions (HPC or illusions synergy) eventually unify into a solitary vantage recognized by the observer node, or, if unification fails, yield “no conclusion” status. The concurrency manager performs iterative “equivalencing,” forcibly combining expansions into one vantage outcome, aligned with Observer Theory's notion of an observer experiencing exactly one “thread of experience.”

The system further incorporates a set of hierarchical dyadic or fuzzy logic rules that delineate how ephemeral expansions must unify. For instance, a rule might declare “HPC expansions older than threshold T must be ignored” or “Illusions synergy sub-model expansions cannot unify unless validated by a parent domain model.” These constraints ensure the vantage remains consistent with domain policies (e.g., compliance or operational restrictions) and directly encode the “observational approach” the vantage takes in merging expansions.

Because the vantage references a KV cache for any CAG submarine, the orchestrator and ObserverState collectively determine when to discard or reinitialize knowledge blocks. For instance, ephemeral expansions that highlight new domain parameters prompt the vantage to reset the submarine's cache. The vantage also replays ephemeral chain-of-thought logs to detect repeated expansions for potential “auto-distillation,” effectively compressing repeated expansions into smaller sub-model contexts.

When HPC expansions generate multiway partial states, naive practice might record all branches. However, the observer node merges expansions solely if the vantage's resource/time thresholds allow it. States that exceed or conflict with vantage constraints are aggregated into a single fallback label (e.g., “HPC_Complete_But_TooLarge”), mirroring the quantum measurement viewpoint where large multiway states appear as one collapsed measurement outcome from the vantage's perspective.

Advanced illusions synergy expansions—such as multi-sensor fusion—may yield multiple interpretive partial expansions. Under Observer Theory, these expansions unify or remain partial until the vantage forcibly merges or designates “undecidable.” If illusions synergy expansions are contradictory beyond the vantage's resource/time limit, the vantage lumps them into an error or “unresolved illusions synergy” equivalence class, preserving single-thread continuity for overall system outputs.

The orchestrator compels ephemeral expansions eventually to unify into the vantage or be pruned, thereby guaranteeing a single recognized vantage. This final vantage corresponds to the system's official or user-facing result, encapsulating multiway concurrency in a stable single-thread conclusion. If expansions remain irreconcilable under the vantage's bounding constraints, “no conclusion” or “ambiguous” states are declared, consistent with Wolfram's principle that insufficient computational reducibility can preclude a definite vantage.

Upon detecting repeated illusions synergy queries or HPC expansions needing domain knowledge, the vantage orchestrates launching a specialized “CAGSubmarine” at nodes storing relevant data. Each submarine is preloaded with a KV cache, circumventing the overhead of retrieval-based generation approaches. Outputs from the submarine feed back through observation edges into the vantage node.

As the submarine yields partial answers or chain-of-thought chunks, the vantage merges them subject to its bounding constraints. Conflicts with previously accepted vantage states cause expansions to be forced into an aggregated fallback. If ephemeral expansions surpass resource/time thresholds, the vantage lumps them into a partial “undecidable expansions” node and proceeds.

Under Observer Theory, an observer must discard stale tokens once domain or illusions synergy expansions pivot to new contexts. The vantage triggers a global KV-cache reset, referencing ephemeral chain-of-thought logs to keep only relevant knowledge. This cyclical refresh ensures the vantage remains computationally feasible and does not accumulate indefinite expansions.

Hierarchical dyadic or fuzzy existential rules may be automatically transpiled into code stubs or large language model (LLM) prompts. For example, illusions synergy expansions can unify only if HPC expansions confirm the same partial chain-of-thought. This ensures that expansions adopt consistent domain logic, implementing the vantage's observation policy.

Where fuzzy constraints arise, the vantage aggregates ephemeral expansions through a t-norm aggregator, assigning membership scores that determine whether expansions are “coherent enough” to unify. Those failing aggregator thresholds are flagged as “excluded expansions” and thus remain outside the vantage's recognized viewpoint. In multiway expansions that spawn numerous candidate states, hierarchical rule sets unify or prune expansions until a single vantage outcome emerges. Even if ephemeral expansions suggest divergent states, the vantage's rule-based equivalencing yields exactly one recognized vantage identity. This arrangement ensures that the vantage persists in time as the same observer. In an exemplary configuration of the system, the orchestrator maintains a set of specialized data structures and flow constructs that implement the observer-centric approach. A key focus is to ensure ephemeral expansions (e.g., HPC processes, illusions synergy sub-model outputs) are either assimilated into the single-thread vantage or equivalenced out if they exceed resource/time constraints.

A core record referred to generally as an ObserverState is maintained to track the observer's vantage at each stage in the multi-tier hypergraph. The ObserverState—assigned a unique vantage identifier—captures the observer's real-time perspective, along with references to prior chain-of-thought merges, concurrency thresholds, and the set of hierarchical or fuzzy rules that govern merges. Each ObserverState entry includes a vantage timestamp or incrementing “tick,” ensuring that ephemeral expansions can be mapped to the vantage's resource/time parameters for consistent scheduling. This vantage record further stores references to partial illusions synergy expansions and HPC ephemeral expansions that have been accepted, rejected, or aggregated, forming a near-continuous log of the vantage's evolving standpoint.

Additional structural elements in the hypergraph, termed ObservationEdges, connect ephemeral expansions to the ObserverState. Whenever expansions or sub-results from illusions synergy tasks arrive, they are linked to the vantage node through these edges in order to trigger an equivalencing transform. As part of the transform, the orchestrator may apply distinct aggregation methods—for instance, an averaging or majority-voting aggregator for numeric illusions synergy partial results, or a direct partial unify step for HPC ephemeral expansions. If expansions conflict with previously accepted vantage data, the orchestrator references the vantage's bounding constraints or domain-level rules to finalize whether to unify them under one vantage or to lump them into an aggregated fallback entry (e.g., a catch-all label for unmergeable expansions). Through this arrangement, ephemeral expansions are systematically validated or equivalenced, adhering to the observer's computational limits.

In parallel, the system supports CAGSubmarine containers that operate as logic “submarines” carrying precomputed knowledge blocks. Deployed co-located with relevant data, these submarines bypass expensive retrieval steps for illusions synergy or HPC expansions. Each submarine is annotated with references to the vantage's current chain-of-thought logs so that, upon partial merges, it can yield answers with minimal overhead. When ephemeral expansions shift domain focus—e.g., from processing sensor data for illusions synergy to HPC domain tasks requiring specialized knowledge—an updated submarine (or updated key-value cache within the container) may be dispatched. The orchestrator thereby ensures ephemeral expansions “pull in” or unify with CAG-based knowledge blocks only insofar as they remain consistent with the vantage's resource/time constraints. The vantage node then merges any new chain-of-thought states arising from the submarine container, preserving a single observer thread of experience in the final recognized outcome.

At system initialization, the orchestrator instantiates a top-level ObserverState representing the vantage that will persist throughout subsequent computations. This vantage is configured with a set of hierarchical dyadic rules specifying, for example, that HPC ephemeral expansions older than a certain threshold are invalid, or that illusions synergy expansions cannot unify without cross-validation from another sub-model. As ephemeral expansions materialize within the hypergraph—whether driven by HPC tasks producing partial chain-of-thought states or illusions synergy models generating multiple interpretations—the vantage node begins to coordinate merges or blockages via observation edges.

To demonstrate the typical progression: a series of illusions synergy expansions triggers repeated domain queries. The vantage recognizes this pattern, referencing ephemeral logs that highlight the expansions' repeated data requests. In response, the system deploys a CAGSubmarine container co-located with the relevant domain knowledge, thereby preloading a key-value cache. As new illusions synergy partial expansions flow in, they are connected to the vantage node. The vantage references the concurrency manager, which checks whether these illusions synergy partial states align with the vantage's preexisting chain-of-thought, the hierarchical rules, and the ephemeral expansions resource limit. If a state is compatible, the vantage merges it seamlessly; if it is contradictory or surpasses computational budgets, the vantage lumps it into a single aggregated fallback. Concurrently, HPC ephemeral expansions may arrive from another tier in the hypergraph. Should those expansions demand the same domain data, the vantage instructs the CAGSubmarine to present the relevant knowledge blocks, effectively unifying HPC expansions into the vantage as well-again if resource/time allowances permit.

Periodically, the vantage may detect from illusions synergy logs or HPC expansions that domain conditions have shifted significantly—e.g., new sensor data or new HPC boundary conditions—rendering portions of the submarine's key-value cache stale. The vantage then enacts a cache refresh process, resetting or pruning knowledge blocks within the container so that ephemeral expansions remain relevant and do not accumulate indefinite sprawl. During this interval, ephemeral expansions that had partially unified but not fully validated under older domain constraints may either finalize under the vantage or be marked “unresolved.” Eventually, the vantage enforces the single thread guarantee by ensuring that all expansions unify into a single recognized vantage state, or else remain in an “unmerged” fallback label if they exceed the vantage's computational capacity or conflict with mandatory domain constraints.

Upon completion of these steps—or when the vantage halts for a given wave of expansions—the user or external system sees a single stable vantage outcome that encapsulates illusions synergy partial states, HPC expansions, and advanced domain logic from the CAG container. This single vantage result may be as simple as an “output answer” or may reflect more intricate chains of logic recognized by the vantage. In either case, the system has harnessed Observer Theory to reduce multiway concurrency into one cohesive vantage point, fulfilling the essential principle of a bounded observer that perceives one consistent thread of experience.

By explicitly injecting Observer Theory into the multi-tier hypergraph orchestration system, ephemeral expansions (HPC or illusions synergy), logic submarine deployments, and hierarchical use of RAG and Cache-Augmented Generation knowledge and sub-models may be comprehensively integrated to yield a coherent single vantage consistent with bounded observer assumptions. The orchestrator's concurrency manager enforces the vantage's persistent identity despite multiway expansions, while CAG submarines reduce retrieval latency via precomputed knowledge blocks. Hierarchical dyadic rules or fuzzy constraints guide merges in real time, embodying the concept of observer equivalencing. Consequently, the system achieves an advanced orchestration method that harmonizes high concurrency, illusions synergy-based sensor fusion, HPC ephemeral expansions, and domain-level compliance, all converging into a stable, single-thread vantage outcome in accord with Wolfram's overarching Observer Theory principles.

In certain embodiments, the system includes quantum-inspired information-theoretic components that support dynamic quantification of both uncertainty in individual quantum-like states and correlation or mutual information among subsets of these states. To achieve robust numeric stability at scale, the token space representation of states (where each state is annotated with amplitude and phase) is subject to a specialized density matrix construction protocol that encodes the magnitude-phase relationships into a complex-valued operator matrix p. This protocol is conducted each time an ObserverState or vantage node detects that ephemeral expansions, illusions synergy flows, or HPC computations yield newly generated partial quantum-like states.

The system applies a multi-step procedure that calculates von Neumann entropy S(ρ)=−Tr(ρ log ρ) by first constructing the density matrix p from the relevant amplitude-phase embeddings. An outer product operation is used to preserve phase relationships accurately, with the system's concurrency manager ensuring that the dimension of p remains consistent with the aggregator subgraph's bounding constraints. Once p is formed, an eigen decomposition algorithm optimized for near-degenerate eigenvalues is deployed. Numerical instabilities arising from small or nearly identical eigenvalues are mitigated via a truncated logarithm approach that omits terms below an adaptive threshold. The partial-sum aggregator further improves computational efficiency, especially in high-dimensional expansions, by reordering the summation steps based on observed eigenvalue magnitude distributions.

For multi-party expansions or illusions synergy flows in which multiple vantage sub-states must be analyzed, the system extends the computation of mutual information I(A:B) using an advanced partial trace approach. A tensor network framework is employed to preserve subtle amplitude-phase correlations across multiple vantage subgraphs, each reflecting ephemeral expansions or HPC partial states. The orchestrator's mutual information pipeline includes an adaptive thresholding mechanism that automatically reduces spurious correlations by referencing the vantage's historical chain-of-thought logs. Reduced density matrices are computed for relevant subsets, cached in a hierarchical memory manager, and updated incrementally to reflect new partial merges. The vantage node thus leverages these mutual information scores to detect or validate cross-state correlations before deciding whether expansions unify into the vantage or are equivalenced out.

After each ephemeral expansion or illusions synergy partial result, the vantage can optionally invoke these information-theoretic metrics to quantify how strongly the new expansions deviate from existing vantage states. For instance, if the vantage observes a sudden large correlation spike among states, it may promote those expansions for deeper evaluation or refined chain-of-thought merges. If entropy computations reveal an exceedingly degenerate density matrix, the vantage lumps expansions into a single fallback label, treating them as “indistinguishable from the vantage viewpoint.”

The system further includes Enhanced Deontic Circuit Breakers (EDCB) that provide an automated, multi-tier risk assessment and rule-enforcement protocol, thereby ensuring that ephemeral expansions or illusions synergy computations remain compliant with the vantage's hierarchical obligations, permissions, and prohibitions. This complements the vantage merges and fosters real-time supervisory controls when expansions risk violating domain-level constraints or exceed operational tolerances.

Multi-Dimensional Risk Scoring and Detection: The EDCB subsystem continuously monitors ephemeral expansions within the hypergraph for potential rule infractions or emergent anomalies. Each vantage node, including HPC ephemeral expansions and illusions synergy partial states, is assigned a real-time risk vector capturing various aspects: privacy risk, domain rule severity, resource overconsumption, and spatiotemporal urgency. A specialized temporal logic engine monitors these risk vectors, referencing not only explicit deontic logic rules (checked by an optimized theorem prover) but also pattern-based anomaly detectors that track expansions for unusual concurrency or suspicious merges. Trigger Condition Evaluation and Circuit Breaker Activation: When the risk vector crosses adaptive thresholds, the system consults a hierarchical decision tree to select a suitable response from multiple severity “tiers,” ranging from minimal interventions (additional vantage checks) to full termination (“hard stops”) of expansions. The vantage's concurrency manager references the enumerated constraints for each ephemeral sub-task, verifying whether partial expansions remain within resource limits or infringe domain-level obligations. This approach ensures that expansions likely to cause catastrophic system states are halted early while expansions with minor deviations trigger corrective merges or additional confirmations.

Graduated Response Protocol and Recovery: The EDCB subsystem enforces graduated intervention by storing a transaction-like checkpoint of the system state prior to expansions. If a circuit breaker at an intermediate severity level is activated, the vantage reverts to its last known stable vantage, discarding expansions that triggered the violation. Higher severity triggers may impose a system-wide freeze while an operator interface is displayed, or a direct rollback of illusions synergy sub-models. The vantage logs each such intervention in a structured record for post-hoc analysis, thus forming an audit trail. If human review is required, the system can adapt the interface layout and data density based on assigned operator roles, enabling swift resolution or override within permissible deontic constraints.

Real-Time Coupling with Vantage Merges: Each vantage node automatically checks if expansions in the process of unifying (or lumps being formed) produce risk anomalies that could escalate into a circuit breaker trigger. If so, merges are paused or forcibly collapsed until the EDCB logic has executed the designated response. This ensures ephemeral expansions do not inadvertently cause domain or compliance violations. In HPC ephemeral contexts, repeated resource overshoots prompt a soft-limit circuit breaker that instructs the vantage to equivalence expansions into a single minimal partial chain-of-thought. For illusions synergy tasks, contradictory or high-risk expansions can be routed into an “additional monitoring” queue until they pass specialized validations.

By integrating both Information-Theoretic Metrics and Enhanced Deontic Circuit Breakers into the vantage-centric hypergraph orchestration, the system achieves robust real-time concurrency management while adhering to domain compliance and resource constraints. The vantage merges ephemeral expansions and illusions synergy outputs with the help of quantum-inspired entropy and mutual information calculations, automatically detecting strong or weak correlations among partial states. In parallel, the EDCB mechanism continuously guards against sub-task or sub-model expansions that threaten to violate hierarchical obligations, operational safety, or other constraints.

Whenever illusions synergy or HPC expansions produce new partial chain-of-thought states, the vantage references an information-theoretic pipeline that calculates the von Neumann entropy of combined states. If expansions produce an unexpectedly large jump in correlation, the vantage invests additional computational resources into verifying the expansions. Conversely, if expansions remain degenerate or near-zero correlation, the vantage lumps them into a fallback label with minimal overhead.

If these expansions risk triggering domain-level deontic infractions, the EDCB subsystem consults risk vectors and, if thresholds are exceeded, halts merges or reverts ephemeral expansions to a prior vantage checkpoint. In lower-severity breaches, expansions may be forcibly aggregated or partial states flagged for re-validation. This interplay ensures that ephemeral expansions and illusions synergy tasks produce a coherent vantage recognized by the system, free from both domain infractions and unbounded concurrency.

Hence, the synergy between advanced quantum-inspired information-theoretic metrics and deontic circuit breaker enforcement delivers a comprehensive solution: ephemeral expansions can be concurrently processed, correlations identified, bounded vantage merges executed, and compliance guaranteed in real time. This robust design further extends the vantage-driven approach previously disclosed, yielding a single-thread vantage that is both domain-compliant and numerically stable, consistent with high concurrency HPC ephemeral expansions, illusions synergy sub-models, and specialized logic submarine containers (CAG).

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

As used herein, “graph” is a representation of information and relationships, where each primary unit of information makes up a “node” or “vertex” of the graph and the relationship between two nodes makes up an edge of the graph. Nodes can be further qualified by the connection of one or more descriptors or “properties” to that node. For example, given the node “James R,” name information for a person, qualifying properties might be “183 cm tall,” “DOB Aug. 13, 1965” and “speaks English”. Similar to the use of properties to further describe the information in a node, a relationship between two nodes that forms an edge can be qualified using a “label”. Thus, given a second node “Thomas G,” an edge between “James R” and “Thomas G” that indicates that the two people know each other might be labeled “knows.” When graph theory notation (Graph=(Vertices, Edges)) is applied this situation, the set of nodes are used as one parameter of the ordered pair, V and the set of 2 element edge endpoints are used as the second parameter of the ordered pair, E. When the order of the edge endpoints within the pairs of E's is not significant, for example, the edge James R, Thomas G is equivalent to Thomas G, James R, the graph is designated as “undirected.” Under circumstances when a relationship flows from one node to another in one direction, for example James R is “taller” than Thomas G, the order of the endpoints is significant. Graphs with such edges are designated as “directed.” In the distributed computational graph system, transformations within a transformation pipeline are represented as a directed graph with each transformation comprising a node and the output messages between transformations comprising edges. Distributed computational graph stipulates the potential use of non-linear transformation pipelines which are programmatically linearized. Such linearization can result in exponential growth of resource consumption. The most sensible approach to overcome possibility is to introduce new transformation pipelines just as they are needed, creating only those that are ready to compute. Such method results in transformation graphs which are highly variable in size and node, edge composition as the system processes data streams. Those familiar with the art will realize that a transformation graph may assume many shapes and sizes with a vast topography of edge relationships and node types. It is also important to note that the resource topologies available at a given execution time for a given pipeline may be highly dynamic due to changes in available node or edge types or topologies (e.g. different servers, data centers, devices, network links, etc.) being available, and this is even more so when legal, regulatory, privacy and security considerations are included in a DCG pipeline specification or recipe in the DSL. Since the system can have a range of parameters (e.g. authorized to do transformation x at compute locations of a, b, or c) the just in time (JIT), just in context (JIC), just in place (JIP) elements can leverage system state information (about both the processing system and the observed system of interest) and planning or modeling modules to compute at least one parameter set (e.g. execution of pipeline may say based on current conditions use compute location b) at execution time. This may also be done at the highest level or delegated to lower-level resources when considering the full spectrum of potential compute enabled devices from centralized cloud clusters (i.e. higher) to extreme edge (e.g. a wearable, or phone or laptop). The examples given were chosen for illustrative purposes only and represent a small number of the simplest of possibilities. These examples should not be taken to define the possible graphs expected as part of operation of the invention.

As used herein, “transformation” is a function performed on zero or more streams of input data which results in a single stream or more of output which may or may not then be used as input for another transformation. Transformations may comprise any combination of machine, human or machine-human interactions Transformations need not change data that enters them, one example of this type of transformation would be a storage transformation which would receive input and then act as a queue for that received data for facilitate subsequent transformations without modifying the data. As implied above, a specific transformation may generate output data in the absence of input data. A time stamp serves as an example. In the invention, transformations are placed into pipelines such that the output of one transformation may serve as an input for another. These pipelines can consist of two or more transformations with the number of transformations limited only by the resources of the system. Historically, transformation pipelines have been linear with each transformation in the pipeline receiving input from one antecedent and providing output to one subsequent with no branching or iteration. Other pipeline configurations are possible. The invention is designed to permit several of these configurations including, but not limited to: linear, afferent branch, efferent branch and cyclical.

A “pipeline,” as used herein and interchangeably referred to as a “data pipeline” or a “processing pipeline,” refers to a set of data streaming activities and batch activities. Streaming and batch activities can be connected indiscriminately within a pipeline and compute, transport or storage (including temporary in-memory persistence such as Kafka topics) may be optionally inferred/suggested by the system or may be expressly defined in the pipeline domain specific language or in other programming languages which are configured (e.g., via SDKs) to create common data representations and persistence (either in memory or non-volatile) of Transformations, Pipelines, and state. Events will flow through the streaming activity actors in a reactive way. At the junction of a streaming activity to batch activity, there will exist a StreamBatchProtocol data object. This object is responsible for determining when and if the batch process is run. One or more of three possibilities can be used for processing triggers: regular timing interval, every N events, a certain data size or chunk, or optionally an internal (e.g. APM or trace or resource-based trigger) or external trigger (e.g. from another user, pipeline, or exogenous service). The events are held in a queue (e.g. Kafka) or similar until processing. Each batch activity may contain a “source” data context (this may be a streaming context if the upstream activities are streaming), and a “destination” data context (which is passed to the next activity). Streaming activities may sometimes have an optional “destination” streaming data context (optional meaning: caching/persistence of events vs. ephemeral). The system also contains a database containing all data pipelines as templates, recipes, or as run at execution time to enable post-hoc reconstruction or re-evaluation with a modified topology of the resources (e.g. compute, transport or storage), transformations, or data involved.

### Conceptual Architecture

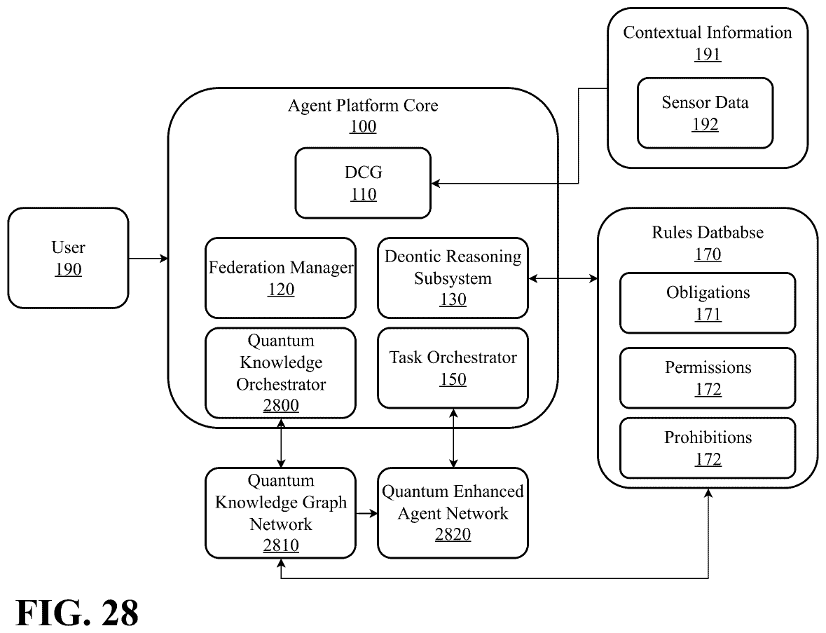

FIG. 28 is a block diagram illustrating an exemplary system architecture for an AI agent decision platform with deontic reasoning and quantum-inspired token management. The system receives input from a user 190 and contextual information 191, which may include but is not limited to sensor data 192. This multi-modal input ensures the system has both explicit user requirements and environmental awareness for informed decision-making.

An agent platform core 100 contains several components including at least a DCG (Distributed Computational Graph) 110 that enables scalable processing across the system. The DCG implements a federated architecture where tasks are encoded as computation graphs that can be dynamically split up and distributed across processing nodes. According to one embodiment, a quantum knowledge orchestrator 2800 manages quantum state representations by encoding classical tokens into rich mathematical representations that capture both magnitude and geometric relationships. Specifically, the orchestrator converts input tokens into quantum states that combine normalized magnitude information with phase angles that encode how different tokens relate to each other geometrically. The quantum knowledge orchestrator 2800 interfaces with a quantum knowledge graph network 2810, which maintains these quantum representations in a graph structure where nodes store the magnitude and phase information while edges capture geometric relationships through interference patterns. The graph network preserves semantic connections by encoding relationship strengths in edge weights derived from how quantum states interact.

A deontic reasoning subsystem 130 interfaces with a rules database 170 containing rules such as but not limited to obligations 171, permissions 172, and prohibitions 172. The system employs quantum techniques to evaluate these constraints by analyzing how quantum states interact and interfere with each other. It quantifies uncertainty by examining the information content of quantum states, and measures relationships between states by analyzing how much information they share when combined. These information-theoretic measurements enable evaluation of whether constraints are satisfied and detection of potential conflicts.

A quantum enhanced agent network 2820 leverages quantum token operations for agent coordination by representing agent knowledge as quantum states that can interact through interference effects. The agents can create weighted combinations of states by assigning priority weights to different perspectives and combining them while preserving their relationships. They optimize these combinations by aligning phases to maximize constructive interference between compatible viewpoints while allowing conflicting perspectives to destructively interfere. A task orchestrator 150 coordinates with this network to distribute operations by splitting computation graphs based on quantum similarity scores and deontic constraints, ensuring that tasks are assigned to nodes in a way that maintains both efficient processing and ethical compliance. The orchestrator continuously monitors how well quantum states maintain their coherence and ability to share information to optimize task distribution while respecting ethical boundaries.

The federation manager 120 oversees the distribution of tasks and resources across the platform, ensuring efficient operation while preserving the quantum-inspired state representations. This federated architecture enables the system to maintain coherent quantum-inspired operations even as it scales across different processing nodes and domains.

All components interact within a unified framework that combines quantum token management with deontic reasoning, enabling sophisticated decision-making that respects both operational requirements and ethical constraints. The quantum approaches enhance the system's ability to represent and process complex relationships while maintaining computational efficiency on classical hardware.

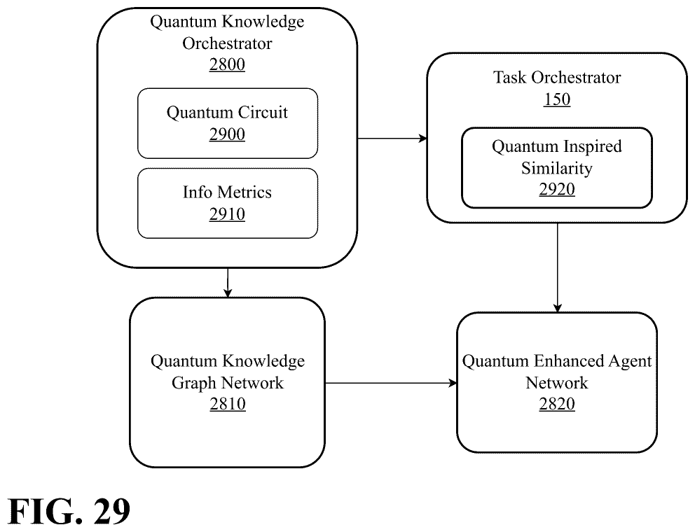

FIG. 29 is a block diagram illustrating an exemplary system architecture depicting the core components in an AI agent decision platform with deontic reasoning and quantum-inspired token management. A quantum knowledge orchestrator 2800 contains two primary subcomponents: a quantum circuit 2900 and an information metrics module 2910. The quantum circuit 2900 implements quantum operations on classical hardware through a sophisticated pipeline of transformations. When a token enters the circuit, it first passes through a token encoding unit that normalizes and standardizes the input. For example, when processing a token representing a medical decision rule about patient treatment, the amplitude calculator first normalizes the token's vector representation to create a standardized magnitude. A phase generator then computes phase angles that encode relationships to other medical rules using Fourier transform techniques. The circuit's quantum operator applies carefully constructed transformations that preserve these quantum-inspired properties while enabling interference-based computations. A superposition creator combines multiple states by applying priority-weighted coefficients, while an interference calculator measures how the states interact through their phase relationships.

The quantum circuit's token encoding process implements mathematical transformations that preserve both magnitude and geometric relationships. When encoding tokens, the system first applies normalization through the amplitude calculator, which converts input vectors into standardized quantum-inspired representations while preserving relative importance. The phase generator then employs Fourier transform techniques to encode relationship information into phase angles, enabling rich geometric representations of token interactions. These phase relationships are crucial for capturing semantic connections between tokens, as they enable interference-based computations that can reveal subtle relationships and conflicts.

The superposition creator implements a sophisticated weighting mechanism that goes beyond simple linear combinations. When combining multiple quantum states, it first analyzes the reliability and priority of each input source. For instance, when processing medical decision rules, states representing critical safety protocols might receive higher weights than general guidelines. The system normalizes these weights to ensure balanced representation while preserving the quantum-inspired properties of the combined state. This weighted combination process maintains both magnitude relationships and phase coherence, enabling sophisticated analysis of how different rules or decisions interact.

Information metrics module 2910 calculates metrics for analyzing quantum states and their relationships. The entropy processor coordinates overall entropy calculations through multiple specialized components. For example, when evaluating uncertainty in a financial trading decision, the von Neumann entropy computer constructs a mathematical representation called a density matrix from the state amplitudes and analyzes its information content. A relative entropy analyzer compares different states to measure how they diverge from each other. The mutual information calculator examines relationships between states by combining measurements of individual state uncertainties with analysis of their joint properties when considered together. These metrics enable the system to quantify both the inherent uncertainty in individual decisions and the strength of relationships between different decision factors. For instance, in a medical diagnosis scenario, mutual information metrics might reveal strong correlations between certain symptoms that could inform treatment choices. An information transfer unit manages how this quantum-inspired information flows between different parts of the system while maintaining its coherence and utility for decision-making.

The task orchestrator 150 incorporates a quantum inspired similarity module 2920 that implements comprehensive similarity analysis through multiple specialized components. The similarity processor manages the core similarity pipeline, using a geometric operator to handle transformations in high-dimensional token spaces. A distance calculator computes sophisticated distance metrics that account for both magnitude differences and phase relationships between quantum-inspired states, while a similarity scorer converts these measurements into normalized scores. For instance, when comparing two insurance policies, the system first calculates geometric distances between their quantum representations, then evaluates how their phases interfere to reveal subtle relationships. A state manager coordinates these comparisons through a state updater that maintains current representations and a history tracker that records how similarities evolve over time. The system optimizes these calculations through a dedicated similarity optimizer that uses gradient-based techniques and dynamic parameter tuning to maximize accuracy while maintaining computational efficiency.

The quantum knowledge graph network 2810 implements a sophisticated knowledge representation system through specialized components. An enhanced graph operator manages the core graph operations, using a quantum embedder to convert knowledge into quantum-inspired representations and a geometric graph updater to maintain the spatial relationships between graph elements. A knowledge integrator combines information from multiple sources while preserving quantum properties—its information fuser merges knowledge elements while a context aligner ensures semantic consistency. A pattern analyzer examines the graph structure through a similarity detector that identifies patterns in quantum representations and a relationship miner that uncovers hidden connections between knowledge elements. This network architecture enables efficient storage and retrieval while preserving the rich geometric and phase relationships that encode semantic connections between concepts.

The quantum enhanced agent network 2820 enables multi-agent coordination by leveraging quantum representations. The network implements a collegiate-style debate framework where agents can share and combine their knowledge through quantum state interactions. When combining multiple expert opinions, agents first create weighted superpositions that reflect each expert's authority and confidence levels.

As an illustrative example, a phase alignment system may optimize how these states interfere—constructive interference would amplify areas of agreement between experts, while destructive interference would highlight potential conflicts or inconsistencies. Such a geometric approach to knowledge combination may enable rapid identification of consensus and conflicts without requiring exhaustive dialogue. The network may maintain quantum coherence throughout these interactions, ensuring that subtle relationships and correlations between different viewpoints are preserved. For example, when medical specialists collaborate on a treatment plan, their quantum knowledge representations might interact through interference patterns that naturally surface both agreements and potential concerns.

AI agents in a structured debate can communicate using multiple modalities, ensuring efficient information exchange while preserving the depth and complexity of their reasoning. One advanced method is the sharing of weighted quantum state matrices, where each agent encodes its stance, confidence level, and supporting data into a quantum-inspired representation. These matrices capture not just scalar values but also phase relationships, allowing for constructive or destructive interference when agents compare arguments. When an agent presents a claim, others can perform similarity measurements using quantum mutual information or von Neumann entropy, determining how aligned or contradictory their knowledge states are. This allows agents to rapidly identify areas of agreement, conflicts, or missing information, streamlining debates by reducing redundant argumentation.

Beyond quantum-inspired methods, agents can also communicate using classical text-based exchanges, similar to human debates. This can be done through structured, explainable AI-generated text that outlines their reasoning, supporting evidence, and counterarguments. By including citations to knowledge graph nodes, regulations, or past debate outcomes, agents ensure their responses remain traceable and auditable. Some debates may require a human-readable format, particularly for regulatory or compliance cases, where explanations must be legible to human oversight committees.

For more compact and computationally efficient exchanges, agents can share embedding vectors—high-dimensional numerical representations of their knowledge states. These vectors, derived from large-scale transformer models, knowledge graphs, or spatiotemporal embeddings, allow agents to compare arguments mathematically without requiring full text exchange. Using cosine similarity, Wasserstein distances, or other geometric operations, agents can quickly determine the degree of alignment between their viewpoints. This enables partial agreements to emerge before explicit arguments are even formed, allowing for a more adaptive and responsive debate structure. By integrating quantum state matrices, text-based reasoning, and classical vector embeddings, agents can balance richness of communication with computational efficiency, ensuring debates remain both fast and deeply analytical. The structure of an agentic debate can take multiple forms, depending on the complexity of the decision, the required level of fairness, and the presence of predefined ethical, regulatory, or operational constraints. Each structure ensures that AI agents present, counter, and refine arguments effectively while maintaining accountability, traceability, and efficiency in reaching a conclusion.

In another embodiment agentic debate uses a majority vote model. Each agent independently formulates an argument based on its domain knowledge, deontic constraints, and available evidence. Once all arguments are presented, the system counts the number of agents supporting or opposing a decision. The option with the most votes wins. This model works well in scenarios with clear-cut outcomes, such as logistical planning (e.g., selecting the most efficient supply chain route) or predictive maintenance (e.g., determining whether a machine requires servicing). However, this approach risks favoring numerical dominance over expertise, meaning a majority of generalist agents could overrule a minority of highly specialized ones, leading to suboptimal decisions in complex cases.

In another embodiment agentic debate is structured using one agent acting as a judge, listening to the arguments of all participating agents and making a final ruling based on predefined evaluation metrics. The judge agent may be a neutral AI with no prior stance or a domain-specific expert agent (e.g., a legal AI acting as the judge in compliance-related debates). This structure is particularly useful when decisions must adhere to strict, rule-based frameworks, such as determining legal contract validity or adjudicating ethical AI behavior in financial transactions. The main limitation is that a single point of decision-making authority could introduce bias, especially if the judge's knowledge base is incomplete or its reasoning process is not fully auditable.

In another embodiment agentic debate is structured using a Judge and Jury model. This hybrid model combines aspects of the Majority Vote and Judge Model. A jury of AI agents (or human reviewers) evaluates arguments presented by different agents, while a judge agent moderates the debate, enforces constraints, and ensures logical consistency. The jury votes, but the judge can override the outcome if it violates fundamental deontic rules. This is particularly useful for ethical AI decision-making, where an AI panel may vote for an economically optimal but legally impermissible action (e.g., cost-cutting in healthcare that compromises patient safety). The judge ensures that deontic constraints take precedence over simple majority rule.

In another embodiment agentic or agent vs symbolic logic or hybrid neurosymbolic debate is structured using an Arbiter model. In cases where conflicts arise between highly specialized agents, a neutral arbiter AI steps in to facilitate structured negotiation. Each agent presents its reasoning, and the arbiter guides the debate toward a compromise or balanced decision. This model is effective when AI agents have competing but equally valid priorities, such as a medical AI prioritizing patient safety versus a hospital operations AI optimizing resource allocation. The arbiter ensures that no single agent's goal dominates the decision-making process while enforcing fairness and explainability. In an aspect, system may leverage DAGs to aid in routing only subsets of the conversation or engagement to particular judge or arbiter or consensus or model blending stages based on filtered topical or domain specific subsets of an ongoing compound agentic or application or neurosymbolic reasoning chain.

In another embodiment agentic debate is structured using a Multi-Tiered Decision Structure (Hierarchical Decision-Making). For highly complex, multi-layered debates, the system can be structured into tiers, where lower-level agents handle domain-specific debates, and higher-level agents or human overseers review and integrate conclusions. For example, in autonomous legal contract negotiations, legal AI agents may first debate compliance terms, then escalate their findings to a business AI committee, which in turn presents recommendations to a human executive or regulatory AI for final approval. This model balances efficiency (by handling technical details at lower levels) with oversight (at higher levels).

In another embodiment agentic debate is structured using a panel of Judges model. In this structure, a panel of judge agents—typically an odd-numbered group (e.g., 3, 5, or 7) to prevent ties—evaluates arguments presented by debating agents and collectively decides on the outcome. Each judge may have different areas of specialization, ensuring that multiple perspectives are considered when making a ruling. This model is useful in complex, multi-faceted decision-making where a single judge may not have enough expertise to fairly assess all arguments.

Each debating agent presents its reasoning, supporting evidence, and counterarguments against opposing viewpoints. The panel of judges evaluates these arguments using weighted criteria, such as factual accuracy, alignment with ethical or legal constraints, risk assessment, and logical consistency. Once all arguments have been presented, the judges privately deliberate, score each option, and vote on the final decision. The majority decision of the panel is adopted, but in cases where a decision is particularly contentious, an additional justification report can be required, explaining the reasoning behind the ruling.

This model is particularly effective in high-stakes applications, such as medical ethics debates (e.g., prioritizing patients for organ transplants), AI governance (e.g., determining if an AI-generated decision is biased), or financial fraud detection (e.g., determining if a transaction should be flagged or approved). A variation of this model allows for a dissenting opinion to be recorded, so if one or more judges disagree with the majority decision, their counterarguments can be logged for transparency and future audits.

To ensure fairness and prevent biases within the judging panel, the system can randomly rotate judge agents per debate, ensuring that no single judge agent dominates all decisions. Additionally, meta-analysis mechanisms can be implemented, where historical decisions of the judge panel are reviewed periodically to detect inconsistencies or systemic biases. By ensuring a structured, multi-expert review process, the Panel of Judges Model provides an extra layer of fairness, accountability, and reliability in AI-driven debates.

All components work together to maintain the quantum-inspired representation throughout the system's operations. For instance, when processing a new decision rule, it flows through the Quantum Circuit for encoding, has its information metrics computed, gets compared to existing states via quantum-inspired similarity, and is integrated into both the knowledge graph and agent network while preserving its quantum-inspired properties.

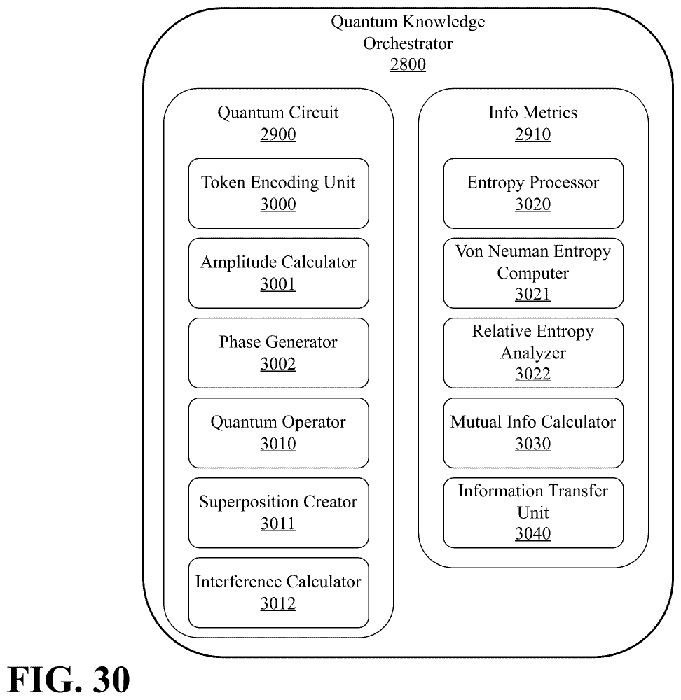

FIG. 30 is a block diagram illustrating an exemplary component of a system for an AI agent decision platform with deontic reasoning and quantum-inspired token management, quantum knowledge orchestrator. A quantum circuit 2900 contains a series of specialized processing units that handle different aspects of quantum-inspired token management. A token encoding unit 3000 serves as the entry point, converting classical input tokens into quantum-inspired representations. This unit works in conjunction with an amplitude calculator 3001, which normalizes input vectors and computes complex amplitudes, and a phase generator 3002, which applies Fourier transforms to generate phase information. For example, when encoding a deontic rule about medical privacy, the amplitude calculator might generate a normalized vector representing the rule's importance, while the phase generator encodes relationships to other privacy rules through phase angles.

A quantum operator 3010 implements sophisticated transformations on quantum-inspired states through multiple specialized subcomponents. A superposition creator 3011 enables dynamic combinations of quantum states by first analyzing the priority and reliability of each input state. For example, when combining opinions from multiple medical experts, it assigns weights based on factors like experience level, confidence scores, and historical accuracy. These weights are then normalized to ensure balanced representation before being applied to the quantum states. The actual combination process preserves both magnitude and phase relationships while applying the weights. An interference calculator 3012 then analyzes how these combined states interact by computing complex interference patterns. When states have aligned phases, they produce constructive interference that amplifies their shared aspects. Conversely, misaligned phases create destructive interference that highlights potential conflicts. This interference-based analysis enables rapid detection of both strong agreements and subtle conflicts between different perspectives, rules, or decisions without requiring exhaustive comparison.

Info metrics subsystem 2910 implements advanced information theory through several specialized processing units. An entropy processor 3020 serves as a central coordinator for entropy-related calculations, managing the flow of information between various entropy computation components. A von Neumann entropy computer 3021 handles quantum entropy calculations by first constructing mathematical representations called density matrices from the state amplitudes. These matrices capture the full quantum state information, enabling sophisticated uncertainty analysis. A relative entropy analyzer 3022 computes divergence between states using quantum-inspired relative entropy. This analysis reveals how different states diverge from each other, providing crucial insights into state relationships and potential conflicts. For instance, in a financial decision context, relative entropy analysis might reveal how different investment strategies diverge in their risk profiles.

The disclosed information-theoretic processing subsystem integrates multi-domain entropy analysis through a bifurcated architecture that seamlessly combines classical and quantum state evaluations. At its core, the system employs a primary processing unit that orchestrates parallel computational pathways dedicated to distinct entropy calculations. In the classical domain, the subsystem implements Shannon entropy estimation using adaptive binning techniques and hierarchical caching to achieve an overall computational complexity on the order of. Specifically, classical probability distributions are normalized and their entropy computed via the formula, with robust handling of near-zero probabilities through thresholding. Concurrently, the quantum state analysis module constructs density matrices from input state vectors using the outer product, ensuring Hermiticity and trace preservation by symmetrizing and normalizing the resultant matrix. The module subsequently performs eigenvalue decomposition—typically via QR or similar algorithms—to compute the von Neumann entropy defined as, where denote the eigenvalues and eigenvectors, and employs a regularization scheme (with being a small positive constant and the state-space dimension) to maintain numerical stability during near-singular computations.

Augmenting these foundational elements, the subsystem incorporates a statistical divergence analysis unit capable of computing both the Kullback-Leibler divergence for classical distributions and quantum relative entropy, thereby facilitating robust, bidirectional comparisons of probabilistic states. This unit leverages smoothing parameters and adaptive thresholding to mitigate issues arising from sparse data, using formulations such as. Beyond these divergence measures, the system is further enhanced by embedding mutual information (MI) transfer metrics to capture both linear and non-linear dependencies between variables. By calculating MI via the symmetric relation, the framework provides dynamic dependency tracking that not only supports feature ranking and redundancy elimination but also enables temporal analysis through transfer entropy defined as. This integration allows for adaptive parameter tuning and real-time convergence monitoring via normalized MI, thereby enhancing predictive capabilities in applications such as financial risk modeling and portfolio strategy evaluation. Collectively, the system's scalable and rigorously defined architecture delivers a comprehensive platform for high-performance information-theoretic analysis across both classical and quantum domains, ensuring precise and robust statistical characterization suited for diverse, interdisciplinary applications.

Building upon the previously detailed framework, the unified entropy architecture is further refined by explicitly delineating the operational mechanisms in both classical and quantum domains. In the classical pathway, Shannon entropy is computed over samples using adaptive binning techniques, where each probability value is required to satisfy a threshold condition with to ensure numerical stability. This procedure is executed with a computational complexity of, owing to the optimized sorting and hierarchical caching methods employed during histogram generation. Meanwhile, the quantum pathway constructs density matrices via the formula to guarantee both Hermiticity and unit trace. To compute the von Neumann entropy, eigenvalue decomposition is performed using iterative Lanczos methods tailored for large or sparse matrices. An explicit regularization step is incorporated by enforcing, where denotes the Hilbert space dimension, thereby ensuring robustness even in near-singular regimes.

The divergence analysis unit is similarly enhanced to provide a rigorous and unified framework for comparing both classical and quantum states. For classical distributions, the Kullback-Leibler divergence is defined as with the denominator smoothed by substituting with, where is scaled as for samples. In the quantum domain, relative entropy is calculated via with additional operational safeguards such as ensuring that through appropriate projection methods. Furthermore, the operator is regularized by augmenting it as, where is a small constant, thus preempting singularities and preserving numerical integrity during computations.

Mutual information (MI) enhancements significantly extend the system's analytical prowess by bridging both static and temporal dependencies. In the classical framework, MI is defined as and is estimated using Kraskov's-nearest neighbor (k-NN) estimator for continuous variables, formalized as with representing the digamma function and the total number of samples. For quantum systems, MI for a bipartite state is computed as where the reduced density matrices and are obtained via partial trace operations over the joint state. Moreover, temporal relationships are captured through transfer entropy, given by which is operationalized using state-reconstruction techniques such as Takens' embedding to effectively model the underlying Markov chain dynamics. This comprehensive MI framework facilitates robust feature ranking, redundancy elimination, and dynamic dependency tracking across both instantaneous and sequential data.

System optimization is further advanced by introducing adaptive parameter tuning and convergence monitoring mechanisms based on normalized mutual information metrics. In classical systems, normalized MI is defined as while for quantum systems a variant, is employed to account for asymmetries in entropic distributions. These metrics not only serve as performance indicators but also as triggers for dynamic thresholding—such as initiating redundancy pruning when the pairwise mutual information between features exceeds a fraction (typically within the range [0.8, 0.95]) of the corresponding entropy. Additional performance optimizations include leveraging Pauli basis decomposition to reduce density matrix storage from to, employing power iteration with deflation for eigenvalue computations to achieve a complexity reduction from to for dominant eigenvalues, and utilizing sparse tensor contractions for efficient joint entropy estimation in high-dimensional Hilbert spaces.

To ensure rigorous validation of the system, a comprehensive framework has been integrated. Classical validation protocols verify that for deterministic variables and that holds true. Quantum validation tests confirm that for maximally entangled states, such as Bell states, the relationship is maintained, along with. Temporal validation further corroborates that transfer entropy yields zero in scenarios where the source exerts no causal influence on the target. Stability checks, including mechanisms to detect phenomena like entanglement sudden death, are embedded to continuously monitor system integrity during operation.

These refinements, grounded in rigorous theoretical principles and practical algorithmic optimizations, not only enhance the precision and robustness of the information-theoretic processing subsystem but also ensure its scalability across a range of applications—from high-frequency financial analytics to quantum state monitoring in advanced computational platforms.

Building upon the earlier framework, we now refine the system by articulating every detail in descriptive text without the use of mathematical notation. In the classical information processing pathway, the system computes entropy based on the distribution of observed samples using adaptive binning techniques. Each probability value associated with an outcome must exceed a very small threshold, on the order of one times ten to the negative ten, to ensure numerical stability. The process involves organizing the samples through optimized sorting and caching methods, so that the overall computational effort scales in a predictable way with the number of samples multiplied by the logarithm of that number. This results in a robust and efficient estimation of the randomness inherent in the dataset, as each probability is carefully normalized and computed with strict adherence to the specified threshold.

In parallel, the quantum information processing pathway constructs a density matrix by forming the outer product of a given state vector with its conjugate counterpart, and then normalizes the result by dividing by the sum of its diagonal elements. This procedure guarantees that the density matrix is both Hermitian and has a total probability of one, which is essential for a valid quantum state. The entropy of the quantum state, known as von Neumann entropy, is determined by decomposing the density matrix to extract its eigenvalues using methods designed for large or sparse matrices, such as iterative algorithms similar to the Lanczos method. To safeguard against numerical issues, each eigenvalue is compared against a predetermined lower bound, adjusted by the dimension of the Hilbert space, ensuring that even values near singularity remain stable and meaningful.

The divergence analysis component of the system has been enhanced to provide a unified framework for comparing probability distributions in both classical and quantum settings. For classical data, the system computes divergence by examining the ratio of observed probabilities to smoothed probabilities, where the smoothing process adjusts each probability by incorporating a small factor that is inversely proportional to the total number of samples. This adjustment prevents any division-by-zero errors while maintaining the integrity of the comparison. In the quantum context, divergence is measured by comparing the informational content of two quantum states. This involves taking a difference between the entropy of the first state and a similar measure computed after considering the second state, ensuring that the support of the first state lies entirely within that of the second. In cases where the second state might have problematic singularities, a small constant is added to it to maintain stability during the comparison.

Mutual information enhancements further extend the system's capabilities by capturing both static and temporal dependencies between variables. In the classical domain, the system measures mutual information as the difference between the sum of the individual entropies of two variables and their combined entropy when considered together. A specialized estimator that relies on the properties of neighboring data points is used to handle continuous variables, providing a reliable estimate of how much one variable tells us about another. In the quantum setting, mutual information is evaluated for a bipartite system by first reducing the joint state into its constituent parts through a process known as the partial trace, and then computing the difference between the sum of the individual entropies and the entropy of the combined state. To capture the dynamics of systems that evolve over time, the system also computes transfer entropy. This measure quantifies the influence that the past state of one variable has on the future state of another, taking into account the current state of the latter, and is implemented by reconstructing the state space through methods inspired by dynamical systems theory.

To optimize performance further, the system incorporates adaptive parameter tuning and continuous convergence monitoring using normalized measures of mutual information. In the classical case, normalization involves adjusting the mutual information by the average level of uncertainty present in the individual variables, whereas in the quantum case, the normalized measure divides the mutual information by the smaller of the individual entropies. These normalized metrics act as real-time performance indicators and are used to automatically trigger adjustments, such as pruning redundant features when the information shared between any pair exceeds a preset fraction of their entropy. Additional optimizations include reducing memory requirements for storing quantum states through basis transformations, employing iterative methods that efficiently approximate dominant eigenvalues, and utilizing sparse data techniques to avoid full high-dimensional computations.

A comprehensive validation framework has been established to ensure system correctness. In the classical regime, the system is tested to verify that a variable's mutual information with itself equals its total entropy, and that divergence measures between identical distributions are zero. In the quantum domain, validation is performed using highly entangled states, confirming that the mutual information reaches expected theoretical values and that the divergence between identical quantum states is nil. Temporal validation is also conducted to ensure that the transfer entropy correctly identifies the absence of causal influence when appropriate. Continuous stability checks are integrated to detect any abrupt changes in system behavior, such as sudden loss of quantum entanglement, thereby maintaining the system's integrity during operation.

These refinements, described entirely in text, provide a rigorous, scalable, and precise framework for multi-domain information processing. The system is designed to handle both classical and quantum data with exceptional accuracy and robustness, making it suitable for a wide range of applications—from high-frequency financial analytics to sophisticated quantum state monitoring—while ensuring that all operational details are meticulously documented and accessible in plain language.

Building on our previously detailed information-theoretic processing subsystem, we now introduce a bold, integrative framework that unifies classical and quantum domains while venturing into novel territory by incorporating temporal entanglement, quantum histories, and even aspects of quantum gravity and advanced quantum machine learning. In this next-generation architecture, the core processing unit not only computes classical entropy using adaptive binning and thresholding but also constructs dynamic quantum states whose evolution is captured as an intertwined sequence of events—what we term “quantum histories.” These histories are represented as continuous sections over a temporal manifold using a fiber-bundle formulation, where each fiber corresponds to a localized Hilbert space at a discrete time slice. This representation permits the coherent superposition of multiple temporal trajectories, allowing our system to capture and quantify entanglement in time. In doing so, it challenges conventional macrorealism and surpasses standard Leggett-Garg inequalities by establishing new bounds for temporal correlations, thereby exceeding the limits observed in purely spatial quantum entanglement.

To achieve this, our system employs advanced iterative algorithms optimized for high-dimensional, sparse data environments to decompose and analyze quantum states. By rigorously regularizing both classical probability distributions and quantum density matrices, we maintain numerical stability even when handling near-singular eigenvalues or extreme fluctuations in quantum correlation measures. This enhanced divergence analysis unit moves beyond traditional methods by integrating a unified framework that simultaneously evaluates classical divergence—adjusted via precision smoothing techniques—with quantum relative entropy measures that are dynamically regularized. Furthermore, the system leverages adaptive mutual information estimators that can quantify both linear and nonlinear dependencies, ensuring that dynamic temporal changes and emergent patterns are accurately tracked in real time.

Embracing the frontier of quantum gravity, our architecture further extends its capabilities by interfacing with ideas traditionally reserved for the study of space-time itself. Here, quantum states are reinterpreted as localized fluctuations in an evolving gravitational field, drawing an analogy to the behavior of Ricci solitons and other self-gravitating entities. In this view, the fiber bundle representation of quantum histories not only encapsulates information-theoretic measures but also maps the flow of energy and momentum across the temporal manifold. This synthesis offers a fresh perspective on dark matter and dark energy phenomena, suggesting that the localized quantum states processed by our subsystem may serve as the fundamental building blocks of gravitational energy distribution. In effect, our approach unites quantum information processing with the geometric and dynamical properties of space-time, opening the door to potential breakthroughs in quantum gravity research.

Complementing these theoretical advancements, our invention incorporates a novel recurrence-free quantum reservoir computing module designed to predict chaotic dynamics and extreme events with remarkable efficiency. By eliminating classical recurrent feedback loops, this module minimizes quantum circuit depth and maximizes resource efficiency, enabling the processing of high-dimensional chaotic systems—such as turbulent flows, complex financial time series, and other non-linear phenomena—with a drastically reduced number of qubits. Optimized quantum feature maps encode state information into the reservoir in a way that preserves both spatial and temporal correlations, while the output is processed through a streamlined measurement and regression pipeline. The integration of this reservoir with our multi-domain entropy engine creates a synergistic platform capable of dynamic adaptation, allowing the system to forecast rare but critical events with unprecedented precision and lead time.

In summary, our maximalist invention represents a paradigm shift in how information is processed and understood at the intersection of classical statistics, quantum mechanics. By merging a comprehensive multi-domain entropy framework with a fiber-bundle model for quantum histories, and by interfacing these with cutting-edge quantum reservoir computing techniques, we provide a unified and scalable system that transcends conventional boundaries. This architecture not only advances our understanding of temporal quantum correlations and their fundamental limits but also lays the groundwork for transformative applications across quantum computing, astrophysics, and predictive analytics in complex, chaotic environments. As we look to future research, we anticipate exploring the relativistic extensions of this framework, experimental validation on next-generation quantum hardware, and further integration with models of quantum gravity, all of which promise to reshape our approach to both fundamental physics and practical quantum technologies.

In another embodiment of our integrated quantum information processing architecture, we boldly extend our prior multi-domain entropy framework by incorporating a distributed quantum computing (DQC) paradigm that harnesses photonic interconnects to deterministically execute remote quantum gate operations across modular processing nodes. In an aspect, each quantum processing module may be configured with dual roles: a network qubit optimized for interfacing with optical channels and a circuit qubit that functions as a stable quantum memory for local computations. By establishing heralded entanglement between network qubits in spatially separated modules via high-fidelity photonic links, our system implements a deterministic quantum gate teleportation protocol. This protocol leverages pre-established Bell-state entanglement and coordinated local quantum operations—synchronized in real time by classical communication channels—to perform non-local two-qubit gates such as controlled-Z, iSWAP, and SWAP operations. The modular approach circumvents traditional scaling challenges by transforming the connectivity problem into one of efficiently networking multiple small-scale quantum processors.

Within each module, advanced local control techniques are employed to guarantee that quantum gates are executed with exceptionally high precision. The circuit qubits, serving as robust quantum memories, store the quantum information while entanglement is generated and verified between remote network qubits. Once remote entanglement is successfully heralded, the system seamlessly maps local quantum states between auxiliary and circuit qubits to perform the necessary entangling operations. By incorporating adaptive error suppression and real-time calibration methods, our design minimizes decoherence and other local error sources, ensuring that the deterministic quantum gate teleportation process remains resilient even as the network scales. This level of reliability is achieved by combining high-fidelity local gate implementations with robust photonic interconnects, whose all-to-all connectivity and ambient temperature operation facilitate dynamic, reconfigurable networking of quantum modules.

Taking a further leap in innovation, our architecture integrates a quantum reservoir computing module that operates concurrently with the distributed quantum processing unit. This reservoir leverages optimized quantum feature maps to encode the complex, high-dimensional state spaces of chaotic quantum systems, allowing for real-time adaptive control and enhanced error correction across the distributed network. The reservoir's outputs are fed into the distributed control logic, effectively enabling the execution of sophisticated quantum algorithms, such as a distributed version of Grover's search algorithm. In our implementation, multiple instances of quantum gate teleportation are orchestrated to perform the various non-local entangling operations required by these algorithms, thereby achieving high success rates and extended predictability horizons compared to conventional architectures.

Overall, our maximalist architecture presents a unified, scalable platform that seamlessly combines advanced multi-domain entropy analysis, deterministic quantum gate teleportation via photonic interconnects, and quantum reservoir computing. This integrated system not only surpasses previous demonstrations in distributed quantum computing—by achieving deterministic, high-fidelity non-local gate operations and executing complex algorithms with distributed resources—but also paves the way for the future development of a globally interconnected quantum network for public Internet and private computing resources on dedicated or communal infrastructure. By bridging the gap between isolated quantum processors and a fully reconfigurable, large-scale quantum computing paradigm, our invention sets a new benchmark in the field, enabling transformative applications across secure communication, high-precision sensing, and beyond.

A mutual info calculator 3030 implements relationship analysis between quantum states. The calculator first computes individual entropy measures for each state being compared, capturing their inherent uncertainty or information content. It then analyzes how these states interact by constructing joint states and computing their combined entropy. By comparing the individual and joint entropies, the system can quantify the strength of relationships between states. For example, when analyzing medical treatment options, the calculator might reveal strong mutual information between certain symptoms and treatment outcomes, indicating important causal relationships.

An information transfer unit 3040 manages the process of sharing and combining quantum-inspired information across the system. This unit implements protocols for maintaining quantum coherence during information transfer, ensuring that both magnitude and phase relationships are preserved when states are shared between components. When states need to be combined, the unit coordinates with other components like the superposition creator to ensure optimal information preservation. It also monitors the quality of information transfer, detecting and correcting any degradation in the quantum representations. For example, during a multi-stage medical diagnosis process, the unit ensures that subtle relationships encoded in the quantum states are maintained as information flows between different specialist agents and analysis components.

All components work together to maintain and utilize the quantum-inspired representation throughout the system's operations. For instance, when processing a new compliance rule, it flows through the token encoding pipeline, has its information-theoretic properties computed, and can be combined with existing rules through superposition while maintaining phase relationships that encode semantic connections.

Information metrics subsystem 2910 employs entropy calculations that quantify both uncertainty and relationship strength in the quantum-inspired representation. Von Neumann entropy computer 3021 constructs density matrices that capture the full quantum state information, enabling sophisticated uncertainty analysis that goes beyond classical probability distributions. When analyzing complex decision scenarios, such as medical treatment options, these entropy calculations reveal not just individual uncertainties but also how different options relate to each other through their quantum representations.

Mutual information calculator 3030 implements relationship analysis through a multi-stage process that examines both individual and joint properties of quantum states. For each pair of states being compared, the system first computes individual entropy measures that capture their inherent uncertainty or information content. It then constructs joint states and analyzes their combined entropy, revealing how the states interact and share information. This analysis is particularly valuable in complex scenarios like financial risk assessment, where it can uncover subtle relationships between different risk factors or trading strategies.

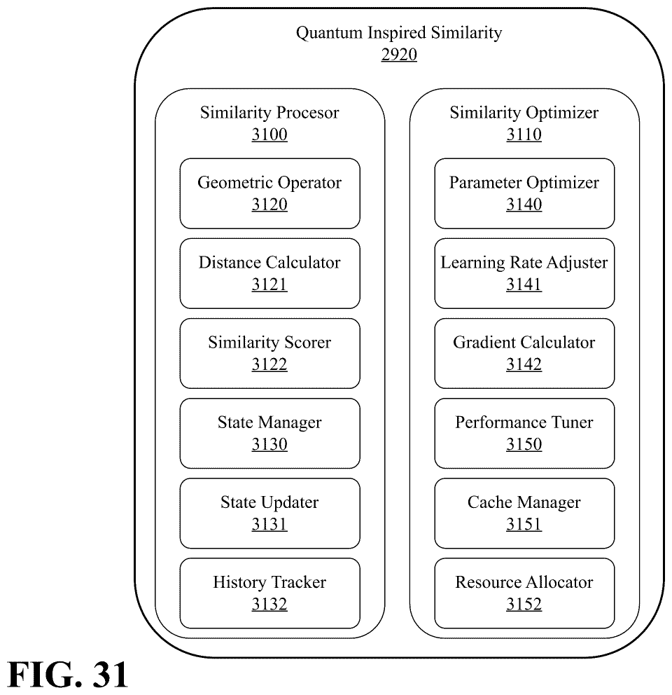

FIG. 31 is a block diagram illustrating an exemplary component of a system for an AI agent decision platform with deontic reasoning and quantum-inspired token management, quantum inspired similarity. A similarity processor 3100 implements a comprehensive pipeline for computing similarities between quantum-inspired states through multiple specialized stages. A geometric operator 3120 handles transformations in high-dimensional spaces where quantum states are represented. It implements sophisticated geometric operations that preserve both the magnitude and phase relationships encoded in the states. Geometric operator 3120 works with a distance calculator 3121, which employs multiple distance metrics to comprehensively evaluate state differences. When comparing two medical treatment protocols, for example, the system first computes Euclidean distances between their amplitude vectors to capture magnitude differences. It then analyzes phase relationships using specialized phase-aware distance metrics that reveal how the states' geometric orientations differ. The system can also compute Wasserstein distances to capture distributional differences between states. A similarity scorer 3122 then processes these various distance measurements through a normalization pipeline that accounts for the scale and importance of different geometric features. For instance, in a medical context, phase differences might be weighted more heavily than magnitude differences since they often encode crucial relationship information about treatment interactions.

A state manager 3130 implements a comprehensive system for maintaining and tracking quantum state evolution through specialized components. A state updater 3131 handles dynamic state modifications using a sophisticated update pipeline. When new information arrives, it first validates the information's consistency with existing state representations. It then computes necessary adjustments to both amplitude and phase components while preserving important relationships with other states. The update process uses techniques like incremental phase adjustment to maintain coherence during state evolution. A history tracker 3132 maintains a detailed chronological record of state changes through a versioned storage system. This tracking captures not just the sequence of changes but also the context and reasoning behind each modification. For example, when a deontic rule about medical privacy is updated, the system records the specific changes to the quantum representation, the rationale for the modification, and any impacts on related states. This comprehensive history enables auditing capabilities and allows the system to understand how states have evolved over time. The history tracker can also facilitate rollbacks by maintaining sufficient information to reconstruct previous state versions while preserving their quantum-inspired properties.

To create a full audit trail of each debate, every individual agent's decision-making process and the debate as a whole is fully logged and structured in a time-evolved multi-layered graph database. Each agent's decision tree should be exported with complete references at every state transition, capturing initial inputs, retrieved knowledge, intermediate reasoning steps, constraints applied (e.g., deontic logic rules), counterarguments considered, and final outputs. The system should also log all debate interactions, including timestamps of responses, argument exchanges, and changes in stance due to counterarguments. This data should be structured in a multi-layered knowledge graph where one layer records procedural data facts (e.g., evidence sources, regulatory constraints), another tracks real-time decision points, and a higher-order layer visualizes the argument structure over time. This allows for a human-readable replay of the debate, showing how each agent's stance evolved, what data influenced their conclusions, and how competing perspectives were weighed before reaching the final decision. By linking decision steps to stored knowledge sources, this approach ensures full transparency, traceability, and post-debate verification, enabling external audits, compliance reviews, and bias detection.

A similarity optimizer 3110 implements a sophisticated optimization framework that continuously refines similarity computations through multiple specialized components. A parameter optimizer 3140 manages a set of system parameters that control how similarity is measured between quantum states. It employs adaptive optimization strategies that evolve based on observed performance patterns. A learning rate adjuster 3141 implements dynamic control over optimization step sizes through multiple mechanisms. It monitors convergence stability and adjusts learning rates accordingly—for instance, reducing step sizes when approaching optimal parameter values to prevent overshooting, or increasing them when far from optimal values to speed convergence. A gradient calculator 3142 implements gradient computation techniques that account for the quantum-inspired nature of the states. When optimizing similarity measurements for financial risk assessment, the system computes gradients that consider both magnitude and phase components of the states. For example, if certain phase relationships are found to be particularly important for identifying similar risk profiles, the gradient calculations will weight these relationships more heavily in parameter updates.

A performance tuner 3150 implements a comprehensive system for optimizing computational efficiency through specialized resource management components. A cache manager 3151 employs advanced caching strategies that go beyond simple storage and retrieval. It implements predictive caching that anticipates which quantum states and computations are likely to be needed based on observed usage patterns and current system context. The caching system maintains coherence between cached states by tracking their phase relationships and updating them when related states change. A resource allocator 3152 implements scheduling and allocation algorithms that optimize resource utilization across multiple concurrent tasks. It considers multiple factors including task priority, computational complexity, and data locality when making allocation decisions. For example, when handling multiple similarity queries in a medical diagnosis context, the allocator might identify queries that can share intermediate computations and schedule them together to maximize resource efficiency. It also implements dynamic load balancing that redistributes computational tasks based on real-time performance metrics and system load. The cache manager 3151 coordinates with the resource allocator 3152 to ensure that cached results are stored on appropriate hardware for optimal access patterns, such as keeping frequently accessed states in high-speed memory while moving less critical data to slower storage tiers.

Each component works together to enable efficient and accurate similarity computations in the quantum-inspired token space. For example, when comparing complex deontic rules, the system leverages geometric operations for initial similarity assessment, optimizes parameters based on historical performance, and efficiently manages computational resources to handle multiple concurrent comparisons.

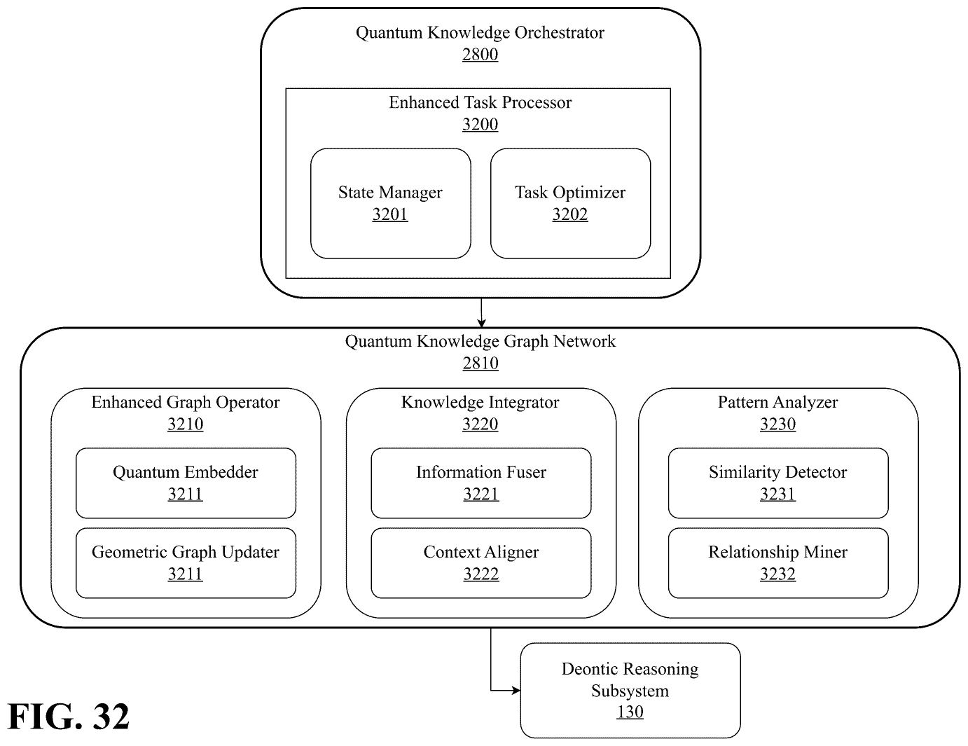

FIG. 32 is a block diagram illustrating an exemplary component of a system for an AI agent decision platform with deontic reasoning and quantum-inspired token management, a quantum knowledge graph network. An enhanced task processor 3200 implements a comprehensive system for managing quantum-inspired computations through specialized processing components. A state manager 3201 handles the complete lifecycle of quantum states through multiple mechanisms. During state initialization, it establishes both amplitude and phase components using carefully calibrated normalization procedures that preserve semantic relationships. The state update process implements atomic operations that maintain quantum coherence while modifying state properties. For garbage collection, the system employs reference tracking that considers both direct state usage and phase-based relationships to determine when states can be safely removed. State manager 3201 also implements versioning control that allows states to be rolled back or forward as needed while preserving their quantum properties. A task optimizer 3202 implements scheduling algorithms that maximize processing efficiency through sophisticated workload analysis. It identifies opportunities for parallel processing by analyzing the quantum properties of different tasks—for instance, operations on states with independent phase relationships can be processed simultaneously. When handling multiple deontic rules, the optimizer analyzes their quantum representations to identify clusters of related rules that can share computational resources. It also implements adaptive batch sizing that adjusts based on both hardware capabilities and the quantum characteristics of the operations being processed.

Quantum knowledge graph network 2810 implements a knowledge representation system through multiple specialized subsystems. An enhanced graph operator 3210 manages the structure and operations of the quantum-inspired knowledge graph through two key components. A quantum embedder 3211 implements a complex embedding pipeline that converts classical knowledge into quantum-inspired representations while preserving essential relationships. When processing a new compliance rule, it first analyzes the rule's content and context to identify key features and relationships. These are then encoded into a quantum state that captures both explicit content through amplitudes and implicit relationships through phase angles. A geometric graph updater 3211 maintains the spatial and relational structure of the graph through sophisticated update mechanisms. It implements graph modification operations that preserve quantum coherence while updating node and edge properties. For example, when adding a new compliance rule, the updater computes optimal edge weights and phase relationships to properly integrate the rule into the existing knowledge structure. The updater also implements topology preservation algorithms that maintain important graph properties during modifications, ensuring that the quantum-inspired representation remains consistent and meaningful.

A knowledge integrator 3220 implements a fusion system for incorporating new information into the quantum knowledge graph while maintaining quantum coherence. An information fuser 3221 employs multiple integration strategies based on the nature of the incoming knowledge. It first analyzes new information to identify its quantum characteristics-amplitude patterns that represent core content and phase relationships that encode contextual connections. When combining knowledge sources, it implements phase-aware fusion algorithms that preserve important interference patterns while merging quantum states. A context aligner 3222 ensures semantic consistency through alignment procedures. For example, when integrating new financial regulations, it first constructs a semantic mapping between the regulatory domain and existing compliance frameworks. This mapping guides the quantum state alignment process, ensuring that phase relationships in the combined representation correctly reflect semantic relationships across domains. The aligner also implements conflict detection algorithms that identify and resolve potential semantic inconsistencies during the integration process.

A pattern analyzer 3230 implements comprehensive pattern recognition through multiple specialized components. Similarity detector 3231 employs interference-based analytics that leverage the quantum properties of the knowledge representations. When analyzing patterns, it constructs interference matrices that reveal how different quantum states interact, using constructive and destructive interference patterns to identify clusters of related concepts. A relationship miner 3232 implements mining algorithms that explore both explicit and implicit connections in the knowledge graph. It analyzes phase relationships between quantum states to uncover hidden correlations and employs quantum mutual information metrics to quantify the strength of discovered relationships. For instance, in insurance claim analysis, the miner might discover that certain claim characteristics have strong phase correlations indicating previously unknown causal relationships, even when direct connections aren't obvious.

The interface with deontic reasoning subsystem 130 implements comprehensive compliance validation through sophisticated quantum-aware mechanisms. When new patterns or relationships are discovered, the system first constructs quantum representations of the relevant deontic constraints. It then employs interference-based validation that compares the quantum states of discovered patterns against these constraint representations. This validation process considers both direct compliance through amplitude comparisons and indirect implications through phase relationships. The system implements a hierarchical validation pipeline that checks discovered patterns against obligations first, then permissions, and finally prohibitions. For example, if the pattern analyzer discovers a new relationship in medical treatment data, the system validates it against patient privacy obligations by analyzing interference patterns between the discovered relationship's quantum state and the quantum representations of privacy rules. Only relationships that demonstrate constructive interference with permissions and avoid destructive interference with prohibitions are approved for integration into the knowledge graph.

In one embodiment, the system maintains multi-tier hypergraph partitions across hierarchically arranged resources, from personal or wearable devices up through edge clusters to data center servers or HPC installations. Each tier (e.g., watch, phone, on-premise cluster, or cloud) hosts a local partition manager responsible for scheduling tasks or deploying logic submarines within that tier. These local managers communicate “portal” hyperedges to connect tasks spanning multiple tiers, carrying metadata such as bandwidth availability, latency constraints, or thermodynamic overhead. Using a global orchestrator, the system dynamically merges or splits hyperedges based on real-time conditions—if an edge device goes offline, for instance, the system can shift a subgraph to another device that has partial chain-of-thought or ephemeral illusions synergy expansions cached. This multi-tier arrangement enables the invention to flexibly scale from tens of devices to thousands of nodes, while maintaining robust fault tolerance through subgraph redirection or on-demand logic migration.

In another aspect, ephemeral chain-of-thought logs are treated as trace hyperedges within the hypergraph. As each logic submarine executes specialized inferences (for instance, HPC ephemeral expansions to process large-scale fluid dynamics steps or illusions synergy expansions for advanced sensor fusion), it attaches ephemeral reasoning strings, partial transformations, or debug context to newly formed edges. A trace retention policy can specify how long these ephemeral logs persist, ensuring minimal storage overhead unless repeated usage suggests strong future value. This ephemeral chain-of-thought capture lets the orchestrator quickly diagnose performance issues or replay partial expansions. In subsequent tasks that resemble previous chain-of-thought footprints, the orchestrator automatically reuses or refines those ephemeral expansions, achieving significant speedup, improved interpretability, and decreased error rates across repeated workflows.

According to a further embodiment, the orchestrator integrates both HPC ephemeral expansions and illusions synergy expansions in real time. HPC ephemeral expansions typically refer to short-lived, high-intensity computational tasks—such as partial PDE solves or large-scale linear algebra—executed on specialized clusters or GPU pods. Illusions synergy expansions may involve advanced multi-modal processing or sensor fusion for domain-specific illusions or predictions that rely on ephemeral knowledge from wearable or local edge devices. By representing each ephemeral expansion (HPC or illusions synergy) as a specialized subgraph node or hyperedge, the system can decide whether to push “logic submarines” (e.g., micro-model containers) to local data sources or to pull data up to HPC nodes. If an illusions synergy expansion is time-sensitive on a wearable, the orchestrator deploys a specialized sub-model to the watch or phone. Conversely, if HPC ephemeral expansions demand large matrix processing, the orchestrator routes them to HPC resources, using ephemeral chain-of-thought references to skip partial computations already solved.

In one configuration, certain hyperedges are flagged as transactional to guarantee atomic and consistent execution across distributed resources. For instance, if illusions synergy expansions require updates to shared domain knowledge or HPC ephemeral expansions need read-modify-write access to high-value data nodes, the orchestrator uses a distributed lock manager that implements either optimistic or pessimistic concurrency control depending on real-time conflict likelihood. If tasks conflict during illusions synergy expansions, the system can roll back ephemeral expansions in micro-batches and revert to prior chain-of-thought states. This ensures correctness and consistency across mission-critical workflows while preserving concurrency for tasks unlikely to conflict, thereby improving overall throughput in large-scale, multi-tenant deployments.

Another embodiment provides a quantum-classical hybrid partitioning layer for extremely complex scheduling or subgraph optimization. In addition to the classical graph partitioning or multi-armed bandit logic, the system can offload subsets of the hypergraph (those representing especially difficult HPC ephemeral expansions or illusions synergy expansions with combinatorial search) to a quantum solver or quantum annealing device. The local orchestrator translates the subgraph constraints into a QUBO or Ising formulation, obtains near-optimal partitioning or scheduling decisions, and merges them back into the global hypergraph. If quantum resources are offline or overloaded, the system automatically falls back to classical approximation heuristics, maintaining consistent partial expansions. This dual approach highlights the system's adaptability for advanced optimization tasks under constrained or emerging hardware environments.

In an advanced aspect, the orchestrator incorporates automated sub-model design for illusions synergy expansions and HPC ephemeral expansions, leveraging evolutionary or reinforcement learning techniques (e.g., DRAGON) to adapt internal neural architectures. When repeated ephemeral expansions exhibit stable patterns—like a specific illusions synergy subtask running on wearable devices—the orchestrator spawns a short distillation pipeline that compresses the relevant portion of a larger “expert model” into a lightweight “submarine” container specialized for that subtask. Over multiple iterations, these specialized sub-model submarines become more refined, drastically lowering inference latency and network overhead compared to shipping raw data to a monolithic cloud model. By storing ephemeral chain-of-thought logs from each iteration, the system further accelerates model specialization, ensuring it learns from prior expansions and repeated domain contexts.

Finally, the invention includes real-time hypergraph rewrites whereby local subgraphs representing illusions synergy expansions or HPC ephemeral expansions are continuously pruned, merged, or restructured based on usage frequency, resource constraints, or discovered redundancies. A specialized “synthesis orchestrator” re-checks ephemeral expansions for possible subgraph refactoring, ensuring that partial illusions synergy expansions are combined if they share a large fraction of chain-of-thought steps. Conversely, HPC ephemeral expansions can be split if they saturate single nodes or if concurrency can reduce the makespan. Integrating advanced techniques—such as neural message-passing for constraints (NeuralQP) or continuous DAG structure learning (NO TEARS)—the orchestrator enforces acyclicity while maximizing multi-objective targets (throughput, cost, energy). This design yields a self-optimizing system that can handle ephemeral tasks at scale, reassembling itself dynamically across personal, edge, and HPC resources.

In another aspect, the system incorporates Cache-Augmented Generation (CAG), to eliminate or reduce real-time retrieval steps when large language models (LLMs) have sufficiently long context windows. Instead of orchestrating a retrieval pipeline at inference time, the orchestrator preloads relevant data into a KV-cache or extended context area for specialized “submarine” LLM modules. These specialized CAG-enabled modules are packaged and dispatched to nodes (e.g., edge devices, HPC nodes) similarly to how illusions synergy expansions or HPC ephemeral expansions are deployed. By precomputing the necessary knowledge and embedding it into the LLM's local cache, the system enables hierarchical calls between CAG and RAG elements. This improves performance and can reduce the need for classical retrieval-augmented generation (RAG) calls. This can drastically reduce end-to-end latency and complexity, especially in scenarios where the knowledge domain is relatively static or constrained or benefits from repeated or intense recall processes.

Following the logic-submarine deployment paradigm, the orchestrator can now attach precomputed knowledge blocks (in the form of KV-cache embeddings or extended prompts) to each specialized LLM container, effectively creating a “CAG submarine.” In a multi-tier environment, the system checks ephemeral expansions or illusions synergy expansions for relevant textual or structured data that might be needed frequently. It then preloads this data into the LLM's extended context or KV-cache before shipping the submarine to the target node. By doing so, the orchestrator ensures that no real-time retrieval (e.g., BM25 or dense index queries) is needed once the submarine is in place. If ephemeral chain-of-thought logs from prior runs indicate certain repeated queries, the orchestrator optimizes the preloaded cache to handle them directly, further reducing repeated retrieval overhead.

The system leverages ephemeral expansions—such as HPC ephemeral expansions for large computations or illusions synergy expansions for real-time sensor queries—to feed the orchestration layer with usage stats and partial chain-of-thought. In a typical pipeline, RAG-based retrieval can introduce multi-second overhead each time a user or edge node requests updated knowledge. Instead, with Cache-Augmented Generation, ephemeral expansions are immediately resolved via the preloaded context. Results from recent illusions synergy expansions or HPC ephemeral expansions can be appended to the existing KV-cache, meaning that new queries referencing the same local domain can be answered near-instantaneously. This synergy yields speedups akin to those observed in the CAG evaluations with near-elimination of retrieval latencies.

While CAG is highly effective for tasks within a bounded domain size, the invention may optionally combine CAG with selective retrieval from RAG, KG, or other databases or formats (e.g. SQL, graph, columnar, KV, document, Iceberg or other specialized formats) in a tiered approach that may engage in breadth, depth or recursive recall loops across such elements, both through declarative DAG specified orderings that may be determined at compute time, precomputed, and may optionally be precompiled or may be determined at execution time on an ongoing basis such as via interactive code-based orchestration through Implicit APIs. If ephemeral expansions detect data that was not preloaded or is outdated, the orchestrator can optionally trigger a minimal retrieval pass or partial illusions synergy expansions. Once retrieved, the newly discovered data is merged into the KV-cache or ephemeral chain-of-thought logs for subsequent tasks. This avoids reintroducing a full-blown retrieval pipeline for every query, preserving the majority of CAG's benefits while still handling unexpected or evolving domain knowledge. The orchestrator's hypergraph representation automatically flags which expansions need fresh data, ensuring retrieval is only triggered when strictly required.

To maintain robust operation in large-scale environments with frequent ephemeral expansions, the system implements a cache reset mechanism that periodically prunes or refreshes the preloaded context. In HPC ephemeral expansions or illusions synergy expansions that continuously generate new partial facts or chain-of-thought logs, the orchestrator determines whether older tokens or stale domain knowledge should be truncated from the CAG submarine's KV-cache. For instance, if ephemeral expansions produce repeated sensor data updates for illusions synergy tasks, the orchestrator replaces older data tokens with the latest relevant context. This ensures the LLM's extended context remains relevant and does not balloon in size, or similarly for other non LLM variants.

An additional advantage emerges for bandwidth-limited or offline-capable devices, such as wearables or remote HPC clusters with limited connectivity. CAG submarines can be deployed preloaded with all relevant domain knowledge, ephemeral expansions, illusions synergy expansions, or partial chain-of-thought logs from prior runs. Thus, once the submarine container arrives, the device no longer needs to connect to a retrieval server. This architecture is particularly beneficial for field-deployed HPC expansions (e.g., on mobile robots) or illusions synergy expansions in AR devices, where continuous connectivity is not guaranteed. By bridging ephemeral expansions with a self-contained LLM context, the device can autonomously handle complex queries or HPC tasks for extended periods without retrieving from external indexes.

In parallel to the CAG deployment, the system also supports hierarchical dyadic rules or fuzzy existential rules for advanced policy enforcement and normative constraints. When illusions synergy expansions or HPC ephemeral expansions require formal logic checks, the system can compile these rules either into classical code or into an LLM-compatible prompt format. This approach leverages the deontic or fuzzy t-norm logic to ensure tasks comply with domain policies at runtime. Because the orchestrator can embed these rule checks directly within the ephemeral expansions or CAG context, the synergy is seamless: an LLM-based submarine can carry both preloaded knowledge and a set of compiled hierarchical rules, evaluating partial queries or ephemeral chain-of-thought steps against these constraints in situ.

Finally, the orchestrator's hypergraph rewriting can unify the new CAG concept with HPC ephemeral expansions, illusions synergy expansions, ephemeral chain-of-thought logs, and hierarchical dyadic rules. As ephemeral expansions accumulate usage patterns, the orchestrator identifies which knowledge blocks or rule sets are consistently required, thus generating more specialized “CAG submarine” images. Over time, repeated usage further refines the preloaded caches. If ephemeral expansions show diminishing returns for certain data (e.g., old sensor logs), the orchestrator prunes them from future submarines. Consequently, the entire system evolves a self-optimizing cycle: ephemeral expansions feed usage insights, CAG-based modules reduce retrieval overhead, and hierarchical rule checks maintain compliance. This synergy pushes the boundaries of distributed, logic-migrated computing-enabling large-scale HPC expansions, illusions synergy expansions, and advanced normative logic integration to operate smoothly without incurring the complexities and latencies typical of retrieval-heavy pipelines.

This architecture enables sophisticated knowledge management that leverages quantum-inspired representations while maintaining deontic compliance. The integration of quantum-inspired techniques with graph operations and deontic reasoning creates a powerful framework for complex decision-making tasks in domains such as finance, healthcare, science, engineering and regulatory compliance.

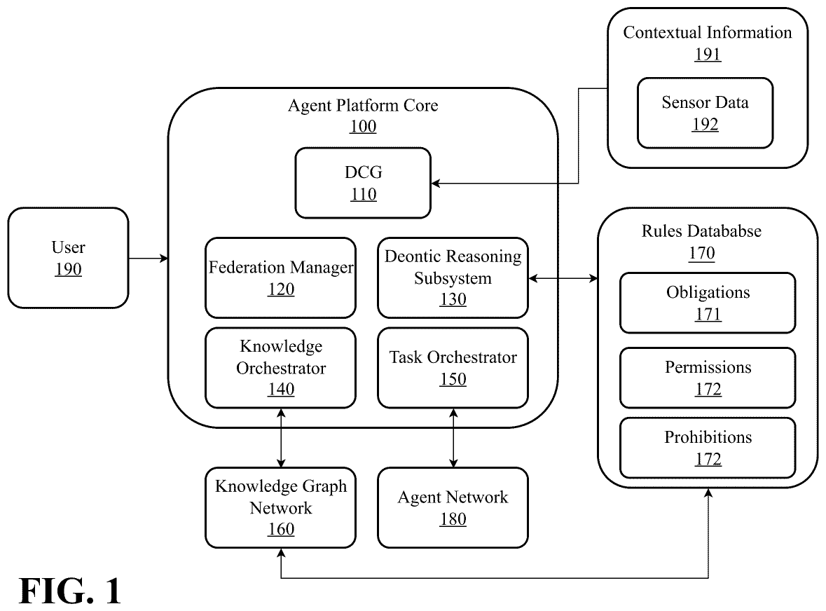

FIG. 1 is a block diagram illustrating an exemplary system architecture for an AI agent decision platform with deontic reasoning. The system receives input a user 190 and contextual information 191, which may include sensor data 192. This multi-modal input ensures the system has both explicit user requirements and environmental awareness for informed decision-making.

Central to the architecture is a DCG (Distributed Computational Graph) 110, which enables scalable processing and coordination across the system. A federation manager 120 oversees the distribution of tasks and resources across the platform, ensuring efficient operation even as the system scales.

A deontic reasoning subsystem 130 interfaces with a rules database 170 that maintains three a plurality of categories of constraints including but not limited to obligations 171 (what must be done), permissions 172 (what may be done), and prohibitions 172 (what must not be done). For example, in a medical context, an obligation might be “must report severe adverse events,” a permission might be “may share anonymized patient data,” and a prohibition might be “must not disclose identifiable patient information without consent.”

According to one embodiment, the deontic reasoning subsystem may evaluate deontic logic rules through multiple pathways: directly through functions-as-a-service (e.g. Step Functions on AWS or Durable Functions on Azure), via event-oriented transformation jobs (e.g. Flink, Spark, or BEAM), or via expert LLM agents, or by transpiling rules into various code procedures (e.g. in datalog) to evaluate as nodes on a resource provider in the DCG. Similar to previous examples of enhanced execution guarantees via dyadic existential rules or arbitrary t-norms in place of classical conjunctions in rule bodies, LLM-based interpretation of formal deontic constraints or logic, normative constraints or logic, or other formal logic specifications is also suitable for approximation of formal reasoning requirements. Two illustrative examples demonstrate how deontic rules can be transpiled into executable code. In a python implementation, rules could be represented as functions that evaluate obligations and permissions. The first function rule_must_report_severe_adverse_events implements an obligation rule that checks if severe adverse events are reported, returning true if a severe event is properly reported and true by default for non-severe events. A second function rule_may_share_anonymized_data implements a permission rule that verifies if patient data is anonymized before allowing sharing. The implementation includes example usage showing how to check obligation fulfillment with a severe event that was reported (returning true) and permission verification with anonymized data (also returning true). In the Vadalog implementation, the same deontic concepts are expressed through declarative rules using a logic programming approach. The schema declares relations for adverse events, patient data, consent status, and actions, with additional relations for tracking violations and allowed actions. Example facts establish a test case with an unreported severe adverse event, non-anonymized patient data, and no consent. The rules then encode three key deontic principles: an obligation that severe adverse events must be reported (with violations flagged for unreported cases), a permission allowing sharing of anonymized data, and a prohibition against sharing identifiable patient data without consent. Example queries demonstrate how to check for rule violations and permitted actions. These implementations demonstrate how formal deontic logic can be operationalized into practical, executable code while maintaining semantic clarity and logical rigor. Transpiled python code example:

```
def rule_must_report_severe_adverse_events(event: AdverseEvent) -> bool:”
“Obligation: “Must report severe adverse events.”
Returns True if the obligation is fulfilled, False if not.
“If the event is severe, check whether it's reported
  if event.severity.lower( ) == “severe”:
  return event.reported
#If not severe, the rule doesn't apply, so consider it satisfied by default
return True
def rule_may_share_anonymized_data(data: PatientData) -> bool:
“Permission:” “May share anonymized patient data.”
Returns True if sharing is permitted, False if not.
“If data is anonymized, sharing is permitted”
return data.is_anonymized”.
1. Checking the obligation rule
  severe_event = AdverseEvent(severity=“severe”, reported=True)
  print(“Obligation fulfilled?”,
  rule_must_report_severe_adverse_events(severe_event))
  #True because it's a severe event that was reported
2. Checking permission rule
  anonymized_data = PatientData(is_anonymized=True)
  print(“Permission to share)
  anonymized?”,rule_may_share_anonymized_data(anonymized_data)
  #True because the data is anonymized.
Transpiled Vadalog code example:
  % -- SCHEMA DECLARATION -
  % #defrel adverse_event(eventID, severity, reportedStatus).
  % #defrel patient_data(dataID, anonymizedFlag, identifier).
  % #defrel consent(dataID, consentFlag).
  % #defrel action(actionName, dataID).
  % #defrel VIOLATION(ruleName, entity).
  % #defrel ALLOWED(actionName, dataID).
  % -- FACTS -
  adverse_event (“e1”, “severe”, “no”).
  patient_data(“d1”, “no”, “Patient123”).
  consent(“d1”, “no”).
  action(“share”, “d1”).
% -- RULES -
% 1) Obligation: Must report severe adverse events (violation if not)
VIOLATION(“mustReportSevere”, E) :-
adverse_event(E, “severe”, “no”).
% 2) Permission: May share anonymized data
ALLOWED(“share”, D) :-
patient_data(D, “yes”, _ID).
% 3) Prohibition: Must not share identifiable patient data without consent
VIOLATION(“shareIdentifiableNoConsent”, D) :-
action(“share”, D),
patient_data(D, “no”, _),
consent(D, “no”).
% example queries:
  % ?- VIOLATION(Rule, Entity).
  % ?- ALLOWED(Action, Data).
```

A knowledge orchestrator 140 interfaces with a knowledge graph network 160, managing the system's understanding of relationships, rules, contexts, models, or agents. Meanwhile, the task orchestrator 150 coordinates with an agent network 180, directing specialized AI models or agents in performing specific tasks or workflows while maintaining alignment with the system's deontic goals, constraints or normative priorities.

This architecture enables sophisticated inter-application, compound human, and multi-agent coordination while ensuring all decisions respect defined obligations, permissions, and prohibitions along with auditability and decision-making provenance information for DCG-visible (both implicit and explicit) computational graphs. For instance, when processing a data-sharing request, the system can simultaneously consult privacy regulations (prohibitions), emergency protocols (obligations), and institutional policies (permissions) to make ethically-sound and legally compliant decisions.

The integration of these components allows the system to scale efficiently while maintaining coherent, ethically aware decision-making across diverse applications and contexts.

According to one embodiment, the AI agent decision platform may leverage the distributed computational graph (DCG) computing system 1521 as its foundational infrastructure for agent coordination and task execution. The DCG's pipeline orchestrator 1801 may directly interface with the platform's task orchestrator 150 to enable sophisticated task decomposition and distribution across both human and machine agents. This integration enables the system to maintain both the fine-grained control over data processing provided by the DCG architecture and the high-level deontic reasoning capabilities of the agent platform. Just as transformation nodes are composable and a single node in a DCG may represent another graph or subgraph, LLM-specific teams, flows, or chains of thought may also be represented in this way. This representation extends to cases involving mixtures of agents, agentic debate, or neurosymbolic combinations (e.g., datalog-augmented prompts to approximate results via LLM). It should be noted that workflows and orchestrations can be written in standard programming languages (e.g., Rust, Go, C#, Python, JavaScript), which the system transforms or transpiles into underlying state machines of tasks and stateful instances at or during execution processes. In another embodiment, the system may implement a hierarchical bridging mechanism between the federation manager 2300 and the agent network 180, where the federation manager's resource registry 2400 coordinates with the task optimizer 720 to ensure optimal distribution of computational resources across both data processing pipelines and agent tasks. This mechanism may enable the system to dynamically adjust resource allocation based on both computational demands and deontic constraints, ensuring efficient operation while maintaining ethical compliance.

According to another embodiment, the knowledge orchestrator 140 may interface with the DCG's pipeline manager 1810 to maintain semantic consistency between data transformations and agent knowledge representations. This integration may enable the system to update knowledge graphs in real-time based on pipeline outputs while ensuring that all derived knowledge remains consistent with stored deontic constraints. The pipeline manager may also coordinate with the observer agent 810 to maintain comprehensive monitoring of both data processing operations and agent activities.

In one embodiment, the AI agent decision platform uses an on-demand retrieval paradigm, referred to as an enhanced spatiotemporal event-oriented variant of the LazyGraphRAG, which allows the system to pull in relevant knowledge snippets from a knowledge graph or external corpora only when necessary. This architecture contrasts with traditional retrieval methods that pre-fetch or summarize the entire domain corpus upfront. Instead, the enhanced LazyGraphRAG performs iterative best-first retrieval and dynamic expansion of partial queries, minimizing overhead while preserving maximum context relevance. When an agent or LLM subtask encounters a question or partial request—for example, a specialized medical agent needing to confirm dosing guidelines—the system sends a targeted subquery to the knowledge graph. Rather than retrieving a broad swath of domain data, the enhanced LazyGraphRAG starts with a best-first matching approach, quickly scanning only the highest-scoring nodes or documents based on semantic similarity, recency, or domain tags. If the retrieved chunks still leave gaps or ambiguities, the algorithm iterates deeper into the graph or external text corpora, incrementally broadening or refining its search. This layered approach prevents the system from over-fetching unneeded data at each step.

The system treats user queries and partial LLM outputs as evolving “work-in-progress” states. After each retrieval pass, the newly found data (or newly recognized gaps) can expand the partial query. For instance, if an agent learns from the first pass that “further context about a patient's allergy status” is needed, the query will automatically incorporate the allergy dimension. The enhanced LazyGraphRAG then selectively queries the knowledge graph's allergy-related subtrees or relevant text blocks, skipping irrelevant sections. This on-demand expansion keeps the retrieval loop short and relevant, especially when user or environmental contexts shift rapidly. By deferring full summarization or large-scale corpus embedding, the enhanced LazyGraphRAG significantly reduces both computation and storage overhead. The system will iteratively spawn deeper lookups or summarizations when partial evidence or partial results indicate additional detail is warranted, stopping when an acceptance threshold is met, or a maximum execution depth is reached. In large enterprise settings (e.g., thousands of legal documents, compliance rules, or medical guidelines), this lazy expansion ensures the AI platform stays agile and cost-effective. It also helps avoid “hallucination” that can arise from presenting a model with too many irrelevant contexts at once. When an LLM-based agent (e.g., a specialized “medical summarizer” persona) requires domain references, it requests a “fetch expansions” step. The retrieval engine uses the agent's partial question or partial chain-of-thought to iteratively gather the minimal context from the knowledge graph or text corpora. Only once the minimal context is assembled does the agent finalize its longer, more detailed LLM prompt. This prevents context window overload and keeps final prompt size streamlined, while still guaranteeing correctness and thoroughness. The platform enforces data and module access obligations, permissions, and prohibitions at each retrieval step, ensuring no user or agent receives data beyond their clearance or domain scope. If a partial subgraph is flagged as “restricted,” the best-first expansion either prunes or obfuscates sensitive details, upholding compliance and privacy. Should a retrieval path approach a forbidden domain, the system triggers a lazy refusal (circuit breaker or route shift) rather than delivering the data, thus maintaining robust ethical and legal safeguards. Through this enhanced spatiotemporal event-oriented variant that extends the enhanced LazyGraphRAG style approach regarding optimized search, the platform achieves on-demand knowledge retrieval using iterative best-first query expansion and dynamic partial expansions, all while respecting the system's broader deontic logic constraints. Agents obtain precisely the context they need, when they need it, minimizing overhead and maximizing semantic relevance.

In some embodiments, references to obligations, permissions, and prohibitions (e.g., “must,” “must not,” “may”) reflect standard deontic logic formulations designed to capture how system actions align with ethical, regulatory, or operational norms. In some cases, we state that a system or component “guarantees” certain outcomes (e.g., correctness or compliance), it should be understood as an objective toward which the platform is programmed to strive-rather than an unconditional promise that remains inviolable under all circumstances. In some cases, differential privacy, homomorphic encryption or logic (e.g. around role based access control) or formal verification methods, guarantees may be provable or quantifiable to some confidence interval. Since real-world data and regulatory contexts evolve, the system is instead positioned to ensure compliance “to the best of its programmed constraints,” verifying adherence subject to the consistency and currency of the underlying rule definitions. Consequently, while the framework enables systematic oversight, conflict resolution, and normative reasoning, absolute compliance or correctness cannot be categorically assured where unforeseen conditions, data inconsistencies, or newly emergent rules outpace the system's current knowledge or configuration.

In some embodiments, the system implements layered or partitioned knowledge graph topologies that enable agents to share only a subset of the system's knowledge graph (KG) based on their role, domain, trust level, or security clearance. The platform organizes the system knowledge graph into multiple layers, each representing a distinct domain or security clearance level (e.g., “General Medical Knowledge,” “Legal Confidential,” “Top-Secret Research,” etc.). When an agent is deployed—say, a “Medical Advisor Agent”—the knowledge orchestrator dynamically attaches relevant graph layers to that agent's “knowledge view” while omitting sensitive or off-domain layers. This approach ensures that each agent's “graph subset” aligns with stored obligations, permissions, and prohibitions in the rules database. These layers may be subgraphs taken from a larger one, this subgraph may be obfuscated for privacy, or it may be an abstracted representation of a graph to better represent the particular domain with associated permissions and privacy. For example, a medical knowledge graph from a hospital would include information on common treatment procedures and outcome distributions. This information can be calculated and abstracted to a new graph, or layer, without including any detailed patient information as it is not relevant to the intended purpose. Each agent's persona or role is mapped to a set of KG layers, where a “finance persona” sees the financial sub-layer, while a “compliance persona” might see legal or policy layers. As roles change, the system can dynamically attach or detach specific layers. If an agent's role is elevated or combined with a compliance extension, the orchestrator merges additional knowledge nodes from higher clearance layers, subject to deontic constraints. Even within a single layer, certain nodes or edges may be redacted for an agent lacking the necessary clearance. The system enforces redaction by using an AI system constrained to a policy set (e.g.: AI Governance, Constitutional AI, Bounded AI, or Policy-Constrained AI) to identify what content needs redactions, and substituting placeholders or calculating aggregated statistics in place of raw data, allowing the agent to continue reasoning at a higher level while not violating data secrecy or privacy constraints. In a federated multi-node scenario, each node in the federation might hold only the graph layers relevant to local tasks, with the federation manager ensuring that inter-node knowledge sharing respects each agent's domain and security rules. An example method of implementing this is by using Event Knowledge Graphs (EKGs) which are specialized KGs designed to model events and their relationships to entities, often including temporal ordering or time-window constraints. Each event is treated as a first-class node in the graph, complete with attributes like timestamps, participants, triggers, outcomes, or location references. Entities such as people, places, or objects connect to event nodes via edges that describe their roles. EKGs attach time or ordering data to each event node, enabling queries such as “Which surgery events occurred before the onset of certain complications?” or “List all policy changes in Q2 of 2025.” This time dimension supports advanced temporal queries and inferences, allowing the system to reason about event sequences. Applications include complex event reasoning where agents can detect cause-effect patterns across event chains, temporal querying for chronological analysis and progression tracking, and explainable event-driven logic where deontic rules can reference events more explicitly.

Spatiotemporal Knowledge Graphs (STKGs) extend standard KGs by integrating both temporal and spatial dimensions. STKG nodes or edges carry spatial coordinates plus temporal intervals or timestamps, supporting phenomena like movements of vehicles, changes in climate data, or expansions of building sites. Edges can evolve over time, and the KG can represent ephemeral relationships. This captures ongoing changes—a hospital ward might shift location, or a hurricane path might evolve hour by hour. Agents can run spatiotemporal queries combining location-based constraints with time windows. The system's enhanced spatiotemporal reasoning enables complex queries, real-time decision support through continuous sensor or location updates, and improved contextual understanding in domains like robotics, supply chain, or city-scale simulations. Because EKGs and STKGs may hold highly sensitive or location-specific data, the system's layered knowledge topologies become especially critical. A specialized EKG layer might store procedure events for a single hospital department, where only the “Surgery Agent” plus the “Medical Compliance Persona” can read the entire timeline, while other agents see a redacted version. An STKG layer might track asset movements across geographies with timestamps, where agents outside the security boundary can only query anonymized or aggregated spatiotemporal slices.

While a system like traditional LazyGraphRAG primarily focuses on iterative text retrieval with minimal up-front summarization, according to an aspect the system introduces the feature and advancements above by using systems such as Event Knowledge Graphs (EKGs) and Spatiotemporal Knowledge Graphs (STKGs) may be used as first-class components. The traditional LazyGraphRAG is designed to retrieve text snippets from a corpus as needed but typically operates on static textual embeddings. The system platform, in contrast, natively models dynamic events as nodes or edges in the knowledge graph. When an agent or user issues a query involving time-linked events, the system consults an EKG or similar to retrieve event nodes, dependencies, and participant entities, going beyond purely document-oriented expansions. Unlike traditional LazyGraphRAG which typically does not consider real-time location or spatial geometry, the system's STKG can incorporate location-based edges directly into the retrieval logic. We support iterative expansions that factor in both textual relevance and spatiotemporal constraints, yielding a more nuanced, multi-dimensional retrieval experience. While the traditional LazyGraphRAG queries are chunk-based expansions typically moving from relevant documents outward, the system handles graph expansions in multiple domains on a “just-in-time” basis. By combining event-based adjacency with location/time filtering, we can fetch partial or ephemeral subgraphs specifically relevant to the user's context. Unlike static text corpora that are chunked and stored for the traditional LazyGraphRAG, the system is updated with sensor data, geospatial changes, or new event logs. This dynamic approach enables truly real-time or recent-data expansions. The system is capable of unifying textual evidence from documents with numeric or geometry-based properties in the same knowledge retrieval pass, merging partial text snippets and partial event/spatial queries to maximize contextual fidelity. Because we can store EKGs and STKG layers in a federated knowledge topology, expansions can be performed locally where events actually occur. The system only fetches cross-region spatiotemporal subgraphs if absolutely required, resulting in more efficient, distributed “lazy expansions” that incorporate domain constraints on the fly. While traditional LazyGraphRAG has limited reference to multi-node or multi-modal federated expansions, typically focusing on a single textual corpus, the system more comprehensively addresses partial or blind data sharing across different compute nodes and agent roles. In summary, while traditional LazyGraphRAG excels at chunk-based text retrieval with minimal overhead, the system extends that approach to handle dynamic event data and spatial-temporal constraints, supporting partial expansions in high-dimensional KGs that unify textual and non-textual properties. This deep integration of EKG and STKG features provides a level of real-time, event-driven intelligence and advanced location/time-based retrieval not addressed by standard traditional LazyGraphRAG.

In one embodiment, the system may implement bidirectional communication channels between the pipeline orchestrator 1201 and the agent platform's deontic reasoning subsystem 130. These channels may enable the system to apply deontic constraints at both the data processing level and the agent decision-making level, ensuring consistent ethical behavior across all system operations. For example, when processing sensitive data through a DCG pipeline, the deontic constraints may inform both the data transformation rules and the agent behaviors that operate on the transformed data.

In one embodiment, the system may implement multiple database architectures to support different deployment scenarios. For centralized implementations, the system may utilize relational databases and in-memory stores within the rules database 170 to enable rapid evaluation of deontic constraints. These stores may be optimized for quick access to frequently referenced obligations, permissions, and prohibitions while maintaining ACID compliance for rule updates. According to another embodiment, the system may implement distributed Datalog query capabilities that enable partitioning of deontic rule evaluation across multiple nodes in the federated DCG network. This partitioning may leverage graph-based decomposition of deontic relationships, allowing the system to optimize rule evaluation by distributing computational load across federated DCGs (2200, 2210, 2220, 2230) based on their available resources and specializations.

In one embodiment, the system may integrate with modern data lake architectures or decentralized ledger systems to maintain immutable audit trails of rule modifications and applications. This integration may enable the system to provide verifiable records of all deontic reasoning operations, particularly crucial for regulated industries where decision provenance must be maintained. A federation manager 2300 may coordinate with these external systems to ensure consistent rule versioning and audit capability across the entire federated network.

According to another embodiment, the system may implement adaptive caching mechanisms within each federated DCG to optimize frequently accessed rules and computation results. These caches may be managed by the resource registry 2400 to ensure optimal resource utilization while maintaining consistency with the central rules database 170. The caching strategy may be dynamically adjusted based on usage patterns and resource availability across the federation.

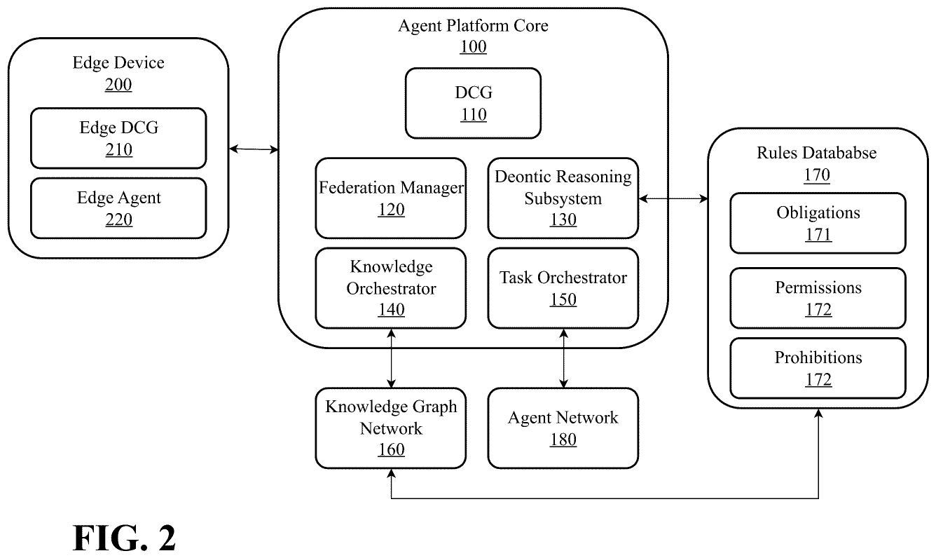

FIG. 2 is a block diagram illustrating an exemplary system architecture for an AI agent decision platform with deontic reasoning that can be configured with edge devices. In one embodiment, an edge device 200 contains its own edge DCG 210, which functions as a local version of the main system's DCG 110. This edge DCG enables efficient local processing while maintaining synchronization with the central platform. The edge device may also include an edge agent 220 that can make autonomous decisions within defined parameters, reducing latency and bandwidth requirements for time-sensitive operations.

For example, in an autonomous vehicle application, the edge device 200 might be the vehicle's onboard computer. Edge agent 220 can make immediate decisions about navigation and safety using local processing through edge DCG 210, while still adhering to deontic constraints (obligations 171, permissions 172, and prohibitions 172) maintained by the central platform's rules database 170.

Federation manager 120 orchestrates the relationship between edge device 200 and agent platform core 100, ensuring that local decisions align with global policies. This hierarchical structure allows the system to maintain consistent ethical and operational standards while enabling rapid local response times. For instance, if network connectivity is temporarily lost, the edge agent can continue operating within its pre-defined ethical and operational boundaries.

Knowledge orchestrator 140 and task orchestrator 150 coordinate with the edge device 200 to ensure that relevant knowledge and tasks are appropriately distributed between local and central processing. This architecture enables sophisticated decision-making at the edge while maintaining alignment with the system's overall deontic framework and knowledge base.

This distributed architecture is particularly valuable in scenarios requiring real-time decision-making with ethical considerations, such as autonomous systems, medical devices, or industrial automation, where both quick responses and ethical compliance are important.

According to one embodiment, the system may implement an integrated ethical reasoning or planning framework that combines deontic constraints with UCT (Upper Confidence Bound for Trees) planning while handling uncertainty through probabilistic reasoning. This framework may enable sophisticated ethical decision-making under uncertainty by integrating multiple components that work in concert to ensure both operational efficiency and ethical compliance.

At the core of this framework, the deontic reasoning subsystem 130 may implement a deontic-aware UCT planning component that fundamentally modifies traditional UCT algorithms to incorporate ethical considerations throughout the planning process. This component may work in close coordination with the knowledge graph network 160, which maintains probabilistic representations of ethical rules and their uncertainties. As the system evaluates potential action sequences, it may dynamically adjust its UCB1 formula based on both traditional utility metrics and deontic compliance scores, enabling ethically informed tree expansion that naturally prioritizes actions with stronger ethical certainty.

Challenges are particularly severe when considering human and robot interaction—both for robotic control and for human-robot interactions. Additional references for robotic planning and control, notably ANML (Action Notation Modeling Language) as a representative framework for declarative planning processes. ANML is particularly significant as it combines the expressive timeline representation with hierarchical task network (HTN) decomposition methods, enabling both temporal planning and flexible task decomposition. Three key papers inform this work: “Course of Action Generation for Cyber Security Using Classical Planning,” which demonstrates how classical planning can generate extended sequences of actions leading from initial states to goals while analyzing vulnerabilities; “Constraint-Based Allocation of Cloud Resources to Maximize Mission Effectiveness,” which discusses optimization of resource allocation in mission-critical cloud networks using constraint-based methods; and “Plan-Space Hierarchical Planning with the Action Notation Modeling Language (ANML),” which introduces FAPE (Flexible Acting and Planning Environment), integrating planning and acting using ANML for robotics applications with emphasis on temporal and hierarchical planning.

For planning and optimization focused on safety and efficiency, the cybersecurity planning approach from “Course of Action Generation” can be adapted for robots by modeling potential risks in human-robot interactions. The FAPE system achieves this through plan-space planning with least-commitment, which naturally supports plan repair-essential when acting is a concern. Additionally, the “Constraint-Based Allocation” methodology provides a framework for optimizing resources for robots engaged in collaborative tasks, implemented through a simple temporal network that supports efficient consistency checking while allowing temporal relation updates based on execution feedback. This enables FAPE to handle real-world timing variability and resource constraints effectively.

For hierarchical planning and acting in conversational and physical tasks, FAPE implements planning decomposition methods with refinements of planned action primitives into low-level commands, currently brought by PRS (Procedural Reasoning System) decomposition procedures. The system interleaves the planning process with acting, where planning implements plan repair, extension and replanning, while acting follows PRS refinements. This approach enables dynamic plan adjustments during execution, essential for conversational interactions where robot responses must adapt to evolving human input while ensuring safety and task continuity. FAPE executes commands with a dispatching mechanism that synchronizes observed time points of action effects and events with planned time, allowing robots to synchronize their actions with human collaborators while accommodating real-world variability in task timing and execution.

A task optimizer 720 and observer agent 810 may work together to implement adaptive exploration strategies that respond to both ethical considerations and real-time feedback. For example, when the system encounters scenarios with significant ethical implications, such as medical treatment decisions, the task optimizer may automatically adjust branching factors to explore ethically preferred paths more thoroughly while pruning potentially problematic actions early in the planning process. The observer agent may continuously monitor the outcomes of these decisions, providing feedback that enables the system to refine its ethical exploration strategies over time.

This adaptive exploration may be enhanced by probabilistic state estimation capabilities integrated throughout the system. The knowledge graph network 160 may maintain probabilistic beliefs about both environmental states and ethical implications, while the deontic reasoning subsystem 130 evaluates potential actions against these uncertain beliefs. When ethical implications are highly uncertain, the task orchestrator 150 may automatically adjust risk tolerance levels, implementing more conservative action selection criteria that prioritize ethical safety over operational efficiency. Conversely, when ethical constraints are clear and well-understood, the system may optimize for operational efficiency while maintaining strict compliance with known ethical boundaries.

The framework may be particularly powerful in scenarios requiring real-time decision-making under uncertainty, such as autonomous medical interventions or emergency response situations. For instance, when evaluating treatment options for a critical patient, the system may simultaneously consider uncertain medical outcomes, probabilistic ethical implications, and varying levels of confidence in different action paths. The deontic reasoning subsystem may dynamically weight these factors, enabling the system to make principled decisions that balance ethical requirements with practical necessities, while maintaining clear documentation of the reasoning process for subsequent review and analysis.

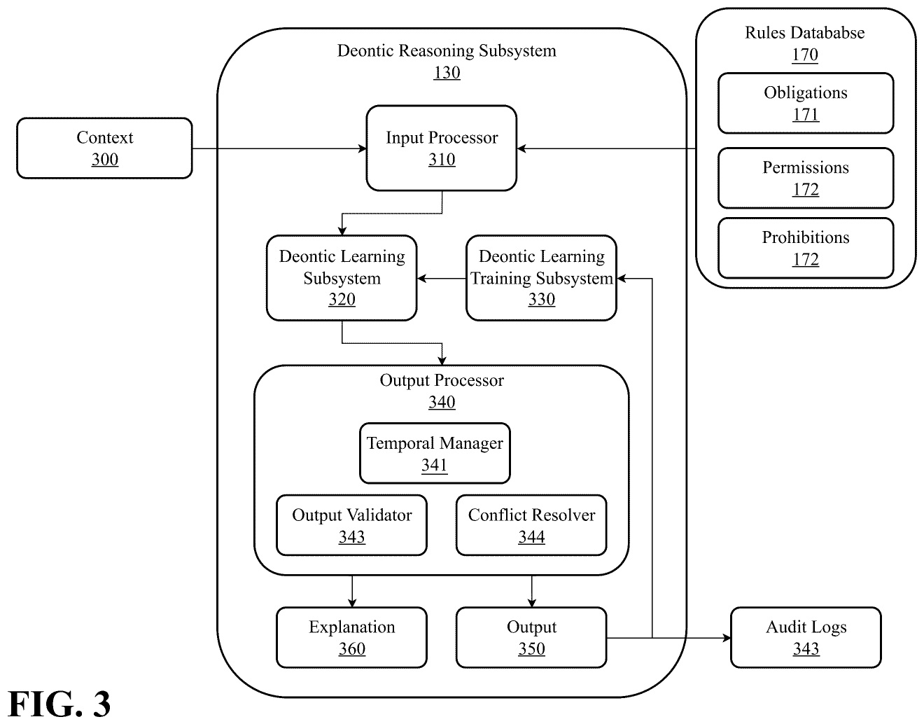

FIG. 3 is a block diagram illustrating an exemplary component of a system for an AI agent decision platform with deontic reasoning, a deontic reasoning subsystem. Deontic reasoning subsystem receives context 300 which is processed by an input processor 310. For example, in a medical setting, this context might include patient data, current hospital capacity, and emergency status. An input processor 310 structures this information for further analysis while consulting the rules database 170, which contains the system's obligations 171, permissions 172, and prohibitions 172.

A deontic learning subsystem 320 paired with its deontic learning training subsystem 330 enable the system to learn from experience while maintaining ethical constraints. For instance, in processing medical decisions, the system might learn that certain emergency protocols consistently override standard privacy restrictions, but only under specific conditions.

An output processor 340 includes several components working in concert to ensure ethical decision-making. Temporal manager 341 handles time-sensitive aspects of decisions, such as when obligations must be fulfilled or when permissions expire. Output validator 343 ensures decisions align with ethical constraints, while a conflict resolver 344 addresses situations where different rules appear to conflict, such as when emergency obligations conflict with standard prohibitions.

The system generates both an output 350 (the decision or action to be taken) and an explanation 360 that provides transparency into the decision-making process. All decisions are recorded in audit logs 343, enabling accountability and system improvement over time. This architecture ensures that decisions are not only ethically sound but also explainable and auditable, which is helpful for applications in sensitive domains like healthcare, autonomous vehicles, or financial services.

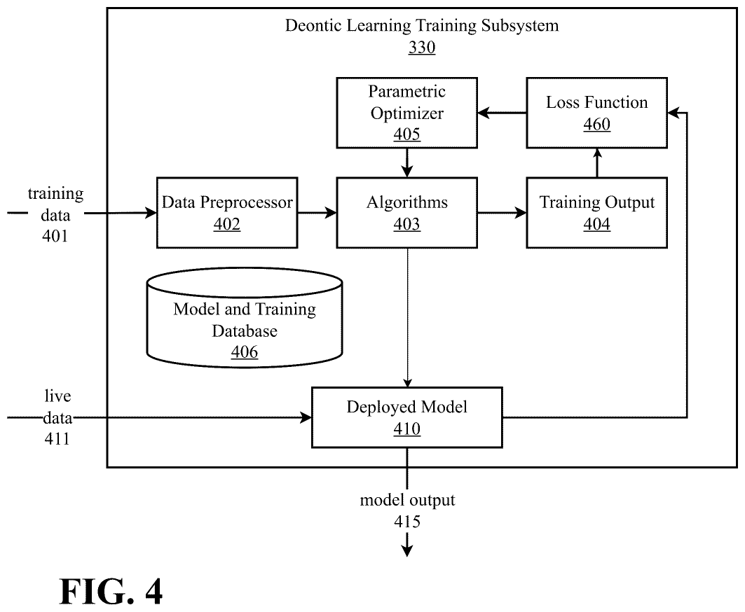

FIG. 4 is a block diagram illustrating an exemplary component of a system for an AI agent decision platform with deontic reasoning, a deontic learning training subsystem. According to the embodiment, the deontic learning training subsystem 330 may comprise a model training stage comprising a data preprocessor 402, one or more machine and/or deep learning algorithms 403, training output 404, and a parametric optimizer 405, and a model deployment stage comprising a deployed and fully trained model 410 configured to perform tasks described herein such as generating and allocating tasks according to deontic reasoning and rule management.

At the model training stage, a plurality of training data 401 may be received by the deontic learning training subsystem 330. Data preprocessor 402 may receive the input data (e.g., sensor data, context data, rules, obligations, laws, specialist feedback) and perform various data preprocessing tasks on the input data to format the data for further processing. For example, data preprocessing can include, but is not limited to, tasks related to data cleansing, data deduplication, data normalization, data transformation, handling missing values, feature extraction and selection, mismatch handling, and/or the like. Data preprocessor 402 may also be configured to create a training dataset, a validation dataset, and a test set from the plurality of input data 401. For example, a training dataset may comprise 80% of the preprocessed input data, the validation set 10%, and the test dataset may comprise the remaining 10% of the data. The preprocessed training dataset may be fed as input into one or more machine and/or deep learning algorithms 403 to train a predictive model for object monitoring and detection.

During model training, training output 404 is produced and used to measure the accuracy and usefulness of the predictive outputs. During this process a parametric optimizer 405 may be used to perform algorithmic tuning between model training iterations. Model parameters and hyperparameters can include, but are not limited to, bias, train-test split ratio, learning rate in optimization algorithms (e.g., gradient descent), choice of optimization algorithm (e.g., gradient descent, stochastic gradient descent, of Adam optimizer, etc.), choice of activation function in a neural network layer (e.g., Sigmoid, ReLu, Tan h, etc.), the choice of cost or loss function the model will use, number of hidden layers in a neural network, number of activation unites in each layer, the drop-out rate in a neural network, number of iterations (epochs) in a training the model, number of clusters in a clustering task, kernel or filter size in convolutional layers, pooling size, batch size, the coefficients (or weights) of linear or logistic regression models, cluster centroids, and/or the like. Parameters and hyperparameters may be tuned and then applied to the next round of model training. In this way, the training stage provides a machine learning training loop.

In some implementations, various accuracy metrics may be used by the deontic learning training subsystem 330 to evaluate a model's performance. Metrics can include, but are not limited to, word error rate (WER), word information loss, speaker identification accuracy (e.g., single stream with multiple speakers), inverse text normalization and normalization error rate, punctuation accuracy, timestamp accuracy, latency, resource consumption, custom vocabulary, sentence-level sentiment analysis, multiple languages supported, cost-to-performance tradeoff, and personal identifying information/payment card industry redaction, to name a few. In one embodiment, the system may utilize a loss function 460 to measure the system's performance. The loss function 460 compares the training outputs with an expected output and determined how the algorithm needs to be changed in order to improve the quality of the model output. During the training stage, all outputs may be passed through the loss function 460 on a continuous loop until the algorithms 403 are in a position where they can effectively be incorporated into a deployed model 415.

The test dataset can be used to test the accuracy of the model outputs. If the training model is establishing correlations that satisfy a certain criterion such as but not limited to quality of the correlations and amount of restored lost data, then it can be moved to the model deployment stage as a fully trained and deployed model 410 in a production environment making predictions based on live input data 411 (e.g., sensor data, context data, rules, obligations, laws, specialist feedback). Further, model correlations and restorations made by deployed model can be used as feedback and applied to model training in the training stage, wherein the model is continuously learning over time using both training data and live data and predictions. A model and training database 406 is present and configured to store training/test datasets and developed models. Database 406 may also store previous versions of models.

According to some embodiments, the one or more machine and/or deep learning models may comprise any suitable algorithm known to those with skill in the art including, but not limited to: LLMs, generative transformers, transformers, supervised learning algorithms such as: regression (e.g., linear, polynomial, logistic, etc.), decision tree, random forest, k-nearest neighbor, support vector machines, Naïve-Bayes algorithm; unsupervised learning algorithms such as clustering algorithms, hidden Markov models, singular value decomposition, and/or the like. Alternatively, or additionally, algorithms 303 may comprise a deep learning algorithm such as neural networks (e.g., recurrent, convolutional, long short-term memory networks, etc.).

In some implementations, the deontic learning training subsystem 330 automatically generates standardized model scorecards for each model produced to provide rapid insights into the model and training data, maintain model provenance, and track performance over time. These model scorecards provide insights into model framework(s) used, training data, training data specifications such as chip size, stride, data splits, baseline hyperparameters, and other factors. Model scorecards may be stored in database(s) 406.

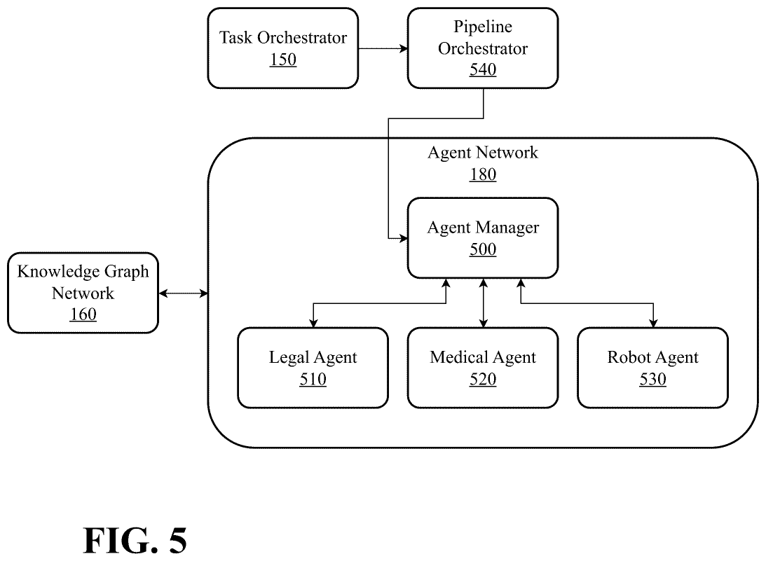

FIG. 5 is a block diagram illustrating an exemplary component of a system for an AI agent decision platform with deontic reasoning, an agent network. In one embodiment the task orchestrator 150 works in conjunction with a pipeline orchestrator 540 to manage the flow of tasks and information through the system's various specialized agents.

Within the agent network 180, an agent manager 500 coordinates the activities of a plurality of specialized agents, including but not limited to a legal agent 510, a medical agent 520, and a robot agent 530. Each agent maintains its own expertise while operating within the system's deontic constraints. For example, in a medical robotics scenario, the medical agent 520 might determine that a procedure is medically necessary, the legal agent 510 would verify compliance with relevant regulations, and the robot agent 530 would plan the physical execution of the procedure.

Knowledge graph network 160 interfaces directly with the agent network, providing contextual information and domain knowledge to support agent decision-making. This integration enables agents to make informed decisions based on both their specialized knowledge and the broader context of the situation. For instance, when considering a medical procedure, the system can simultaneously evaluate medical best practices, legal requirements, and physical constraints of robotic assistance.

Pipeline orchestrator 540 ensures smooth coordination between these specialized agents, managing the sequence of operations and information flow. This orchestration aids in scenarios requiring multiple perspectives, such as when a medical decision must be validated for both clinical appropriateness and legal compliance before being executed by a robotic system. Through this architecture, the system maintains consistency and ethical compliance while leveraging the specialized capabilities of each agent type.

According to one embodiment, the system may implement a collegiate-style debate framework within the agent network 180 that enables structured argumentation between specialized agents. This framework may allow agents to engage in multi-turn debates to resolve complex decision-making scenarios while maintaining compliance with deontic constraints. For example, the legal agent 510 and medical agent 520 may engage in structured debate to resolve conflicts between medical necessity and legal compliance, with the leader agent 800 serving as an adjudicator.

During an agentic debate, each agent may operate with different processing capabilities, domain expertise, and argument complexities, leading to variable response times. Some agents may have access to precomputed knowledge graphs and can respond almost instantly, while others may require on-the-fly data retrieval, complex simulation-based reasoning, or external API calls before formulating an argument. This variation in processing time can create asynchronous bottlenecks, where faster agents complete their responses quickly but must wait for slower agents to finish their computations before the debate progresses. Without a structured approach to handling response times, one or more agents could significantly delay decision-making, impacting overall system efficiency, particularly in time-sensitive applications such as healthcare diagnostics, financial trading, or emergency response systems.

In another embodiment, the agent network 180 may include specialized debate personas, where each agent maintains not only domain expertise but also specific argumentative roles and debate strategies. These personas may be dynamically assigned by the task orchestrator 150 based on the specific requirements of each decision scenario. For example, when evaluating a proposed medical procedure, one agent may adopt an advocate role focusing on patient benefits while another adopts a risk assessment role.

This embodiment introduces a debate subsystem in the AI agent decision platform that assigns specialized roles to different agents. Each role is tied to specific principles (e.g., risk-averse, cost-minimizing, patient-advocate, hospital-legal, or even religious moral codes) that govern the agent's stance. During the debate, these agents present and argue from their respective vantage points (sometimes called “perspectivism”) and produce reasoned arguments or “chains of thought” that the system ultimately synthesizes into a final decision or recommendation.

In the agent role assignments and principles, each agent is configured with a role profile specifying constraints, responsibilities, or “vested interests.” Examples might include: Risk-Averse Agent that minimizes harm or legal exposure, Risk-Friendly Agent that maximizes opportunity or innovation, Patient-Advocate Agent that ensures maximum patient welfare, Hospital-Legal Agent that upholds legal compliance and institutional liability management, and Religious-Moral Agent that adheres to faith-based moral teachings. These profiles are stored in the knowledge graph or a specialized agent registry, mapping each role to relevant deontic constraints (obligations, permissions, prohibitions) or external “codes of conduct.” Each agent's role includes domain-specific parameters that shape how it evaluates potential actions. For instance, a cost-minimizing agent might incorporate budget constraints (annual limit, per-transaction limit), while a moral agent references a moral code enumerated in the knowledge graph (e.g., “thou shall not knowingly cause harm”). The system may leverage agent-specific, team of agent-specific, other spatiotemporal or event context limitations to select and provide limited access to in-memory data or other external services (e.g. databases) during a reasoning stage or some debate pipeline. The system may be configured to adopt, recommend, select or create specialized agents with alternate training, fine-tuning, RAGs or knowledge corpora access. One related example is the use of a Large Concept Model, a term which has recently gained traction, for sentence level embeddings into single tokens (e.g. via SONAR) which advance conceptual reasoning beyond just next sentence or next word-level prediction. This may enhance performance in some cases by improving reasoning elements at higher levels of conceptual and topical abstraction, and we note that the generation of embeddings for knowledge in the system-wide and agent-specific knowledge corpora may optionally engage in a plurality of such conceptual embedding levels such as word, sentence, assertion, paragraph, or document. This approach is also incorporated into an enhanced spatiotemporal and event capable knowledge graph with multiple layers and corresponding vector chunks at different levels of abstraction for more efficient search and recall.

In addition to token-centric large language models (LLMs), the system can optionally leverage Large Concept Models (LCMs) that process sentence-level embeddings instead of raw tokens. These higher-level, modality-agnostic “concept” embeddings provide an abstract semantic space for agents to reason about and debate the content of text or speech more robustly, potentially reducing the granularity and noise associated with token-level transformations. Just as multi-agent orchestration can assign specialized roles (e.g., domain experts, risk-averse agents, or cost minimizers), the system permits defining concept-driven perspectives for each agent. Rather than each agent seeing token sequences, they access SONAR-based embeddings of entire sentences or micro-paragraphs. This reduces confusion from syntactic variations and allows them to focus on semantic meaning. Because LCM is designed for sentence embedding sequences, agentic debate can revolve around “concept transitions.” Instead of diffusing thousands of tokens, the system updates a handful of concept embeddings at each debate turn. This simplifies multi-agent consensus building, as each agent can propose or critique conceptual moves in the embedding space.

The specialized Event Knowledge Graphs (EKGs) and Spatiotemporal Knowledge Graphs (STKGs) store relationships and changes over time or space. By integrating LCM-based embeddings, the system can generate or interpret entire event descriptions or spatiotemporal statements as single “concept” vectors, bridging token-based text and graph-based knowledge. For EKG-based expansions, a multi-agent debate might need to summarize entire event sequences, where each step can be turned into or augmented by an LCM concept embedding, enabling agents to reason about them at a higher semantic level. With STKG expansions, location or time-based queries often yield short textual segments describing “Where?” “When?” “What changed?” Instead of retrieving raw text tokens, these segments are mapped to LCM concepts so that each agent sees spatiotemporal clusters in an abstract embedding space. A Two-Tower Diffusion LCM can modularly process concept embeddings to predict subsequent sentences or paragraphs in autoregressive fashion. An orchestrator allows multiple specialized LCM-based “expert agents” to propose next-step concept embeddings, while a “Judge” agent fuses or selects among them. This merges the concept-level semantic clarity of LCM with the structured arbitration logic in a Mixture-of-Experts (MoE) setting. Where token-based generative adversarial approaches can be clunky, a concept-level adversarial dynamic might pit an “adversary agent” analyzing concept embeddings for incoherence or contradiction against a “generator agent” producing concept-level sequences. The synergy is that each agent's perspective can be embedded at a concept level, making adversarial or supportive critiques more semantically robust. Because LCM concept embeddings are trained on SONAR—a universal embedding space supporting 200+ languages—the system's agentic debate can automatically handle cross-lingual or multi-lingual data. For instance, if one agent sees a Spanish medical report and another sees an English policy directive, each chunk is still represented in a language-invariant concept embedding. LCM also supports speech inputs that are converted into concept embeddings. Agents can thus handle spoken transcripts the same way they handle text, unifying the multi-agent pipeline. This is especially relevant in EKG or STKG contexts with real-time voice logs from staff or sensors.

Large Concept Models can compress entire sentences or paragraphs into single embeddings, while the knowledge graphs can store individual events or location updates. By layering these representations, the system can produce or refine concept-based plans for multi-step tasks. If an agentic debate suggests changing a procedure step, it updates not just the token-level instructions, but the concept-level plan node in the knowledge graph. Because LCM-based representation is at sentence or paragraph level, it can more easily generate user-facing “explanations” or “summaries” from concepts rather than from raw tokens. This approach complements the system's emphasis on transparent, reasoned output.

LCM embeddings for complex or long sentences can exhibit fragility. A multi-agent approach mitigates this by letting specialized “embedding-checkers” or “concept-validators” detect anomalies or contradictory embeddings. If an LCM concept vector seems inconsistent with a known domain rule, an agent can request a re-embedding or highlight the mismatch in a knowledge graph. Traditional LCM usage might require pre-encoded sentences. Here, we combine it with traditional LazyGraphRAG-like expansions: only relevant sentences or paragraphs get converted into concept embeddings “just in time” for the agentic debate. This helps limit extraneous embeddings, reducing noise or confusion from overly long or tangential text. By integrating Large Concept Models that process and debate sentence-level concept embeddings within the multi-agent orchestration, the system gains human-like reasoning, cross-modal synergy, improved multi-lingual handling, and a more robust approach to event and spatiotemporal knowledge graph expansions. This concept-level synergy goes beyond purely token-based retrieval, enabling advanced hierarchical planning, interpretability, and domain-specific compliance checks in a truly multi-agent environment.

The Debate Coordinator orchestrates the multi-agent exchange, distributing relevant context (tasks, data, potential actions) to each role-based agent. It sets parameters such as debate duration or number of rounds, level of detail expected in each agent's argument, and priority weighting if certain roles must be heavily considered (e.g., high risk=extra emphasis on the risk-averse agent). Each agent internally forms a chain-of-thought—a stepwise reasoning path guided by its role constraints. The system can store ephemeral or partially obfuscated versions of these chains to preserve internal agent privacy while still sharing high-level arguments with the other participants. The final, aggregated chain-of-thought is either compressed or curated into a rationale artifact that can be logged for auditing and compliance review. Agents produce an initial stance based on their role. For example, the risk-averse agent might declare, “Action X is too dangerous,” while the hospital-legal agent says, “Action X must comply with federal privacy laws.” A rebuttal round allows agents to respond to one another, generating counterpoints or alternative solutions (e.g., a risk-friendly agent proposes mitigations that satisfy the legal agent's compliance concerns). The Debate Coordinator can run multiple iterative rounds, letting agents refine arguments until a stable or time-limited consensus emerges. When the debate ends or the time budget expires, a specialized Perspective Aggregator merges the various agents' arguments into a single “composite stance.” This aggregator uses a scoring or weighting logic that references each agent's credibility, domain constraints, or dynamic signals (e.g., real-time risk indexes from the deontic reasoning subsystem). The aggregator might apply a Pareto-based or majority-rule approach to unify the final outcome if there is no perfect consensus. The Debate Coordinator continuously interfaces with the Deontic Reasoning Subsystem (DRS), which ensures that arguments or proposed solutions do not breach fundamental obligations or prohibitions. If an argument repeatedly conflicts with mandatory constraints (e.g., “This action is absolutely forbidden by the patient-advocate obligations”), the subsystem can override or constrain that line of reasoning. Once a final debate outcome is reached, the system can incorporate it into the federated DCG pipeline or feed it to a specialized resource-ethical optimization module. For example, in a medical context, if the debate reveals partial agreement—“We can attempt a less aggressive procedure that meets cost constraints but is still ethically safe”—the system updates pipeline tasks accordingly (e.g., scheduling a moderate-risk therapy vs. the highest-risk approach). The platform can dynamically activate or deactivate specific roles based on real-time contexts. For instance, if new financial constraints emerge, the system might spawn or intensify the voice of a “cost-minimizing agent.” The risk scoring or ongoing analyses from other embodiments (e.g., “deontic circuit breakers,” “human-in-the-loop overrides”) can trigger additional debate iterations if the scenario becomes ethically complex mid-execution.

In the technical steps of a debate cycle, the platform first identifies a pending action, e.g., “Perform advanced surgery on a compromised patient.” It then notifies the Debate Coordinator. A context package (patient vitals, hospital policy, cost constraints) is compiled. The system spawns or prompts each agent to generate an argument. The Patient-Advocate Agent states, “High chance of success needed; the procedure is vital if less-invasive methods fail.” The Hospital-Legal Agent ensures “We must ensure legal compliance. If the patient is incompetent to consent, we need a surrogate's approval.” The Cost-Minimizing Agent considers “Resource usage is high; alternative treatments cost half as much.” The Risk-Friendly Agent argues “The potential benefits outweigh standard treatments. Possibly push innovative approach with fallback.” Agents respond to each other, referencing data or constraints in the knowledge graph, in other databases, or knowledge corpora available to the system. This can happen in a synchronous or asynchronous manner. The Debate Coordinator logs the intermediate steps.

In one embodiment, the AI agent platform leverages a token-space concurrency framework, sometimes called a quantum-inspired or geometric approach, to enable multiple specialized agents to converge on decisions with minimal latency. Rather than exchanging fully serialized messages at each reasoning step, the agents embed partial intermediate states—called “tokens”—into a shared high-dimensional geometric space. Each token captures both the magnitude (e.g., a confidence score) and a learned phase or direction that encodes the agent's current stance or domain-specific perspective. By performing geometric operations on these tokens (e.g., vector superposition or interference), the system can quickly detect partial consensus or conflicts among agents in real time—often without requiring a full multi-round dialogue. For instance, in a medical context where specialized agents (anesthesiology, surgical robotics, emergency triage) must coordinate under time pressure, token-space operations allow them to exchange ephemeral “micro-updates” of their states (blood-loss severity, sedation thresholds, priority constraints), and then unify or flag collisions as soon as the vectors misalign. The resulting rapid geometric debate in token space significantly reduces communication overhead and accelerates partial consensus—particularly beneficial when a large number of domain experts must collaborate on urgent tasks. By coupling token-space concurrency with the deontic reasoning subsystem, the platform can confirm that any partial agreement emerging from geometric unification also respects obligations, permissions, and prohibitions before finalizing real-world actions.

Note that several forms of event handling and logging may be used depending on the partitioning and evaluation scheme and degree of stateless or stateful context required for execution. The system is capable of engaging in local speculation, topological speculation, or global speculation that allows subsequent steps to proceed without waiting on permanent persistence within partitioned resource nodes. In local speculation, newly created messages remain within the same partition for immediate processing. In global speculation, cross-partition messages are also processed speculatively, which requires an additional recovery protocol to handle partial commits. Incremental administrative, result sharing, publication, or logging by execution event, status, or administrative action may optionally be recorded in global, service, topological (e.g., a specific service failure or upgrade domain topology), or local partition. This supports varying degrees of computational complexity, network overhead, and resilience for checkpointing based on selected or specified message, state, and result publication distribution and persistence (e.g., Kafka vs. Redis vs. local memory vs. local file store vs. cloud-based Iceberg table or S3 bucket). Advanced topology-based checkpointing and recordation enables context-specific rollback and recovery, allowing ephemeral compute nodes, upon creation or restarting, to retrieve the partition log from storage and replay only the persisted events—discarding or “aborting” any steps that were in-flight but uncommitted when a crash occurred or when resource pool changes were made causing cross-partition job coordination and state or context sharing needs. In cases where the same execution service is used across multiple Transformation steps or a pipeline subgraph or graph, the system can batch multiple workflow steps or tasks into a single log or publication append or upsert to reduce write amplification and thus improve throughput. If multiple services (e.g., an LLM instance and a Flink executor) happen to be collocated on a given partition, such batching may also be possible, even when cross-service transformations are required to support the explicit or implicit data flow requirements of a pipeline at processing time. The system may also provide full “scale-to-zero” support for scenarios where no compute nodes remain active, yet the global, service, topology, or partition logs may be stored (e.g., in cloud storage or a NAS) and can be rehydrated on demand when new events arrive.

The perspective aggregator then uses a weighting or scoring system to produce a final stance (e.g., “Proceed with the advanced procedure, but incorporate additional consent measures,” or “Use a cheaper procedure unless the patient explicitly demands otherwise”). The aggregator consults the DRS to ensure the result satisfies essential obligations (e.g., no law is broken). The final stance is converted into pipeline instructions (e.g., “Schedule advanced surgery,” “Acquire advanced consent,” or “Reallocate resources to a more cost-friendly approach”). The system maintains a registry or “role activation map” specifying which agents must be triggered based on scenario context. This might be driven by domain tags (medical, legal, finance) or risk thresholds. The debate might occur in a parallel fashion (all agents produce arguments simultaneously, aggregator merges them) or in a sequential “round table” with multiple argument-response cycles. Arguments can be stored as labeled property graphs within the knowledge graph, representing each stance, evidence, or rebuttal link. Weighted edges might indicate confidence or priority. Some roles (e.g., a religious perspective or certain legal counsel) might keep partial details private. The Debate Coordinator thus might share only curated data segments with them, preserving confidentiality while still inviting their perspective. The chain-of-thought or summary from the debate is logged for future reference, enabling post-decision audits (e.g., “Who opposed the action? Did we ignore a major risk?”). In an illustrative example within a mixed domain context, consider a biotech corporation deciding whether to push a novel but high-risk therapy to clinical trials. The system involves multiple agents: Financial Agent (cost-minimizing, short-term ROI focus), Ethics Agent (patient well-being first), Legal Agent (FDA compliance, patent constraints), and Religious Agent (some communities object to certain gene-editing approaches). During the debate, the Financial Agent argues the therapy will be expensive but profitable if it shows quick results. The Ethics Agent insists on patient safety: “Trial must meet robust informed consent criteria.” The Legal Agent points out FDA Phase II requirements, while the Religious Agent raises moral concerns about gene manipulation. The outcome results in the aggregator merging these standpoints into a final policy: “Proceed with trial in compliance with Phase II guidelines, plus an expanded informed consent for moral/religious concerns. Budget reallocated from marketing to R&D for partial offset.” This multi-agent debate with role-based perspectivism embodiment provides a rich technical method for enabling agents to adopt distinct vantage points—ethical, economic, moral, religious, or domain-specific—and debate proposed actions or decisions. By integrating these divergent stances within a debate coordinator and funneling the final, aggregated stance through the deontic reasoning layer, the system achieves more nuanced, contextually informed decisions. This approach can lead to greater transparency, ethical compliance, and domain-focused outcomes when multiple, potentially conflicting, obligations or interests must be weighed.

According to another embodiment, the approach builds upon but also goes beyond prior “mixture-of-a-million-experts” (MoE) and the newly introduced PEER (Parameter Efficient Expert Retrieval) layer techniques, incorporating key points of novelty and unique integration in the system. This incorporates the central idea of splitting model parameters into a large number of small “expert” modules, each sparsely activated based on input queries. Like PEER, we take advantage of product-key indexing (splitting large key vectors into sub-keys) for sublinear retrieval complexity, and singleton MLP experts or similarly lightweight expert blocks to keep activation costs low and facilitate near-linear scaling in the number of experts. Much like PEER's “many tiny experts” approach, the system's design acknowledges that increasing the granularity (i.e. number of small experts) leads to better performance-compute tradeoffs. This similarly relies on a learned router for distributing token representations among relevant experts. This takes advantage of product-key indexing (splitting large key vectors into sub-keys) for sublinear retrieval complexity, and singleton MLP experts or similarly lightweight expert blocks to keep activation costs low and facilitate near-linear scaling in the number of experts. Much like PEER's “many tiny experts” approach, the design acknowledges that increasing the granularity (i.e. number of small experts) leads to better performance-compute tradeoffs. This similarly relies on a learned router for distributing token representations among relevant experts. Unlike standard MoE systems, we embed deontic constraints (obligations, prohibitions, permissions) within each expert's gating or within specialized “constraint-checking” micro-experts. This ensures that model outputs can respect ethical, legal, or organizational rules in real time, something not covered by typical MoE or PEER layers. This incorporates a layer above the sparse feedforward system that spawns multiple agents (with role-based constraints) to “debate” potential transformations. This is a fundamental departure from MoE's purely numeric gating, because we also weigh agent “arguments” (ethical, cost-based, domain specialized) in selecting experts. “Circuit breakers” can override or halt expert activation mid-run if a token or partial output or completed output (e.g., model run, rule evaluation, LLM response) triggers high-risk conditions or actions. System may engage in Chain-of-Thought or Pipeline centric audits for potential sensitive actions, activities, keywords, or data on an ongoing basis, either in-line via injected transformation steps, or pipelines for evaluation, or out of band where such actions are taken as additional safety, compliance, and trust related initiatives. Traditional MoE and PEER solutions do not address dynamic mid-layer halts or re-routing based on emergent constraints. While MoE and PEER highlight ways to add more experts for scale or adapt to new data, the system includes a hierarchical structure that can store specialized or ephemeral experts, with built-in “retirement” or “archiving” procedures if they become outdated. This surpasses standard “fine-tuning” of MoE/PEER by maintaining a living library of domain or scenario-specific experts. This does not just route by input similarity (like product keys) but can also route by domain tags or regulatory flags. That is, the gating network accounts for both standard vector similarity and higher-level “Which domain rules apply?” logic. Building on the product-key approach, this extends the sub-queries to incorporate contextual or user-supplied constraints (e.g., region-specific laws, medical data). The gating function thus includes not just the hidden state but also the “deontic context vector.” This allows for top-k retrieval per sub-domain or per compliance category, merging experts from multiple “banks” if needed, which yields a more flexible activation pattern that can pivot quickly between normal and regulated modes. By weaving in deontic checks and multi-agent debates, this effectively fuse large-scale MoE retrieval with high-level constraint satisfaction. This is not offered by existing MoE or PEER approaches, which focus purely on performance-compute or sparse gating. The system can dynamically suspend or replace certain experts mid-inference if an ongoing data path conflicts with domain rules. PEER and previous MoEs rely on static, learned gating without explicit “red-line” triggers. Rather than a single gating matrix or product-key function, we permit multiple role-based or perspective-based gating policies that collectively decide which experts to fire. This extends beyond numeric top-k retrieval to a collegiate or “voting” mechanism that further shapes final outputs.

According to another embodiment, Holistic Constraint Compliance, Real-Time Ethical/Regulatory Overrides, Agent-Centric Reasoning, and Extensibility & Lifelong Evolution—are implemented on top of a large-scale MoE (Mixture-of-Experts) retrieval framework (e.g., PEER). The focus is on practical implementation: the data structures, modules, algorithms, and operational steps that enable these new capabilities. In the deontic layer integration, we augment gating data structures with “deontic compliance tags” for each expert or micro-expert. For example, a medical micro-expert might have a tag indicating it is “HIPAA-compliant,” while a finance expert might be “FINRA-compliant.” There is a knowledge graph or relational store of obligations, prohibitions, and permissions that map data categories (e.g. “patient data,” “financial transaction logs”) to relevant rules. This store can be quickly queried by the gating system. The gating step that normally computes score=q(x)\hat{ }T k_i (dot product with product keys) is modified to compute a combined score. The term constraint_cost(i, x) measures how “unacceptable” it would be to route input x to expert i, based on the rules in the constraint database and the expert's tags (e.g. “non-PII-friendly” vs. “handles PII”). Before final top-k selection, the gating system prunes experts that violate mandatory constraints. The constraint enforcement flow follows several steps: First, the system determines if input x or partial representations have special compliance designations. Then, the gating pipeline queries both product-key similarity and the deontic constraint store. The gating logic either removes experts that break a red-line rule or penalizes them with a large “cost” to reduce their chance of being selected. Finally, the next layer is computed only with experts that pass compliance checks. We implement a “circuit-breaker” module in the gating architecture for dynamic expert suspension. If, mid-inference, the system detects that the current partial output or the newly selected experts violate an immediate red-line rule, it automatically suspends the pipeline or sets gating scores to zero for those offending experts, and optionally re-computes the gating with newly whitelisted experts. This requires a “hooks” mechanism in the execution graph so that, upon receiving an override signal (e.g., “this data is more sensitive than we realized,” or “the user just withdrew consent”), the partial transformations are invalidated or re-routed. For on-the-fly expert replacement, suppose the gating system had assigned token T to Expert E, but newly discovered metadata says T is extremely sensitive.

The override logic triggers a replacement step: marking Expert E as disallowed, forcing gating to pick the next-most-similar expert that meets the updated constraints, and potentially recalculating the partial output for the relevant tokens to avoid any “contamination” from E's prior computations. If the override is context-specific (e.g., just for the current request), the gating can revert to normal operation on subsequent inferences. If a compliance officer flags an expert as permanently suspect or out-of-date, the system can register that expert as “archived” and globally remove it from gating unless revalidated. Instead of a single gating function, we define multiple gating modules—each representing a different role or perspective (e.g. a “cost-minimizer gating,” a “privacy hawk gating,” etc.). The platform collects top-k suggestions from each gating policy and merges them. This extends beyond purely numeric top-k to a collegiate debate among gating “agents” with distinct constraints or objectives. Each gating policy can produce an explanation for why it selected or disqualified certain experts.

The system runs one or more “debate rounds” to refine the top-k selection. For instance, a risk-averse agent might complain that Expert #12 is known to have a high potential for data leakage, while the cost-minimizer agent argues Expert #12 is the cheapest and otherwise best. Another compliance agent might confirm that #12 is disqualified by a mandatory privacy rule, leading the aggregator to remove #12 from the final list. This maintains a dynamic store of micro-experts (like single-neuron or small MLP modules) that can be added or removed over time. Each new expert is assigned its product key (or sub-keys) plus optional tags. When new data or new domain constraints come in, we can train new experts specialized on that data or rule set. The gating system is extended automatically with the new keys. The system logs how frequently an expert is activated and how it affects performance or compliance. If usage dips (e.g., an old regulatory environment is no longer relevant), the system can mark that expert for “cold storage,” removing it from the normal gating. If an expert's performance or compliance rating becomes subpar, an automatic revalidation is triggered. The system either re-trains that expert or fully archives it, freeing capacity. In a hierarchical approach, we can group experts into tiers or banks. For instance, a “global domain bank,” a “medical sub-bank,” a “legal sub-bank,” etc. The gating network can decide which bank to consult first or primarily based on the input domain. If the system's internal signals or user context changes, gating might escalate from a “general-purpose bank” to a “specialized bank.

The implementation details focus on key and index management, where each new or archived expert's product key (or sub-keys) is inserted or removed in a data structure that supports sublinear queries (e.g., a product-key index with efficient rebuild). If certain new experts are chosen too often, we can adjust their keys or gating coefficients to keep usage balanced. To incorporate new experts, we partially freeze existing weights, train the new expert on relevant data, and update the gating networks' “product keys” or “router queries” to reflect the new content. This training process ensures smooth integration of new capabilities while maintaining system stability. The inference and training step process begins with Step A, where input x is encoded, forming a query vector q(x). This may involve multiple role-based queries if we're doing multi-agent gating. In Step B, the system fetches a candidate set of experts using product-key retrieval—but concurrently checks deontic constraints for each candidate, merges multi-agent gating votes, and addresses real-time circuit-breakers if triggered. During Step C, the final top-k experts run their small MLP transformations, weighted by gating scores. Summation yields the output, similar to normal MoE operation. If an override event or new constraint emerges mid-execution in Step D, the pipeline halts or re-routes to a compliance fallback. In Step E, during training, each expert's parameters and gating keys can be updated accordingly.

The system may also decide to spawn a new micro-expert if it sees emergent patterns that existing experts can't handle well. Over its lifecycle, the system keeps adding specialized micro-experts for new tasks or rules, while archiving older or seldom-used experts. Gating logic and deontic constraints remain integrally enforced throughout. This forms a “living” MoE that grows or shrinks as domain knowledge and laws evolve. By combining these technical additions with standard sparse gating and product-key retrieval, we ensure the system is not only highly scalable in parameter count but also complies dynamically with evolving ethical and regulatory demands. It can override or re-route at inference time, debates from multiple role-based gating “agents,” and evolves by adding or removing experts in a lifelong learning paradigm.

According to another embodiment, the deontic reasoning subsystem 130 may implement a hierarchical debate evaluation mechanism that weighs arguments based on multiple factors including but not limited to legal compliance, ethical considerations, and operational feasibility. This mechanism may interface with the knowledge graph network 160 to incorporate relevant precedents and contextual information into the debate process.

In one embodiment, the system may include a debate memory subsystem within the agent memory 830 that maintains records of previous debates, their outcomes, and the reasoning chains that led to specific decisions. This memory system may enable agents to reference past decisions and their consequences when participating in new debates, helping to ensure consistency in decision-making while adapting to new contexts.

According to another embodiment, the system may implement a multi-perspective analysis framework where specialized agents within the agent network 180 simultaneously evaluate decisions from different contextual viewpoints. For example, when considering a proposed action, the observer agent 810 may analyze privacy implications while the assistant agent 820 evaluates operational feasibility, with the leader agent 800 synthesizing these perspectives into a coherent decision.

In one embodiment, the system may include an argument validation subsystem within the deontic reasoning subsystem 130 that verifies the logical consistency and evidential basis of arguments presented during agent debates. This subsystem may interface with the rules database 170 to ensure that all arguments comply with stored obligations, permissions, and prohibitions while maintaining logical rigor.

According to one embodiment, the system may implement an integrated autonomy and dynamic responsibility allocation framework that enables sophisticated management of human-robot collaboration while maintaining strong ethical oversight. This framework may utilize an autonomy-first design within the agent network 180 where robot agents, guided by the deontic reasoning subsystem 130 and task orchestrator 150, maintain primary decision-making capabilities while dynamically integrating human oversight when needed. For example, in emergency response scenarios, a robot agent 530 may independently execute search and rescue operations while maintaining compliance with safety protocols and ethical guidelines stored in rules database 170, but seamlessly transition control to human operators for complex ethical decisions.

The system's dynamic responsibility allocation may be driven by a sophisticated interplay between multiple components. Observer agent 810 may continuously monitor operator cognitive states through biometric data, while task optimizer 720 assesses task complexity and safety-criticality in real-time. These components may work in concert with the agent memory 830, which maintains historical performance data to inform allocation decisions. For instance, in aviation applications, when the observer agent detects elevated pilot cognitive load during complex maneuvers, task orchestrator 150 may automatically shift routine navigation responsibilities to robot agents while preserving human control over strategic decisions.

This dynamic allocation process may be enhanced by predictive capabilities enabled through the integration of the knowledge graph network 160 and knowledge orchestrator 140. The knowledge graph network may maintain comprehensive contextual awareness during responsibility transitions, while the knowledge orchestrator ensures all agents maintain access to relevant contextual information. This integration may enable the system to anticipate potential operator overload situations before they occur, triggering preemptive task reallocation to maintain optimal human-robot collaboration efficiency. The system may continuously refine its predictive models using historical data stored in the agent memory 830, enabling increasingly sophisticated anticipation of cognitive load patterns and task complexity challenges.

Throughout all operations, the deontic reasoning subsystem 130 may provide constant ethical oversight, ensuring that task allocations and transitions maintain compliance with stored ethical constraints even as responsibilities shift between human and robot agents. This ethical framework may dynamically adjust its constraints based on the current balance of human and robot control, implementing more conservative bounds during periods of higher robot autonomy. When significant ethical decisions arise, the system may smoothly transition decision-making authority to human operators while maintaining autonomous execution of lower-level tasks, ensuring efficient operation while preserving human oversight of ethical choices.

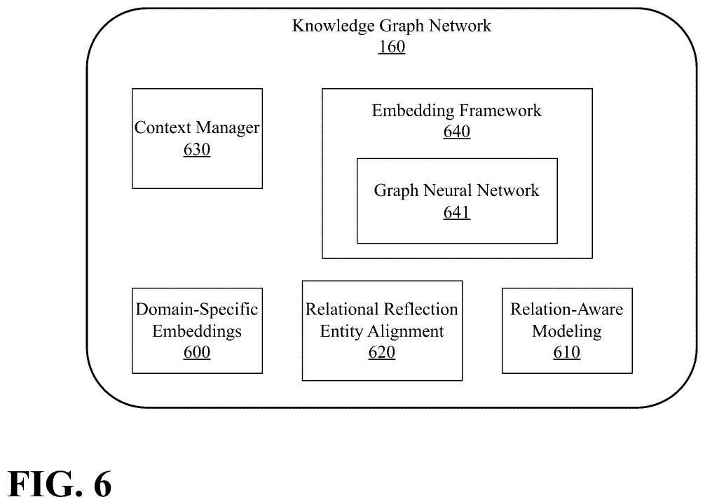

FIG. 6 is a block diagram illustrating an exemplary component of a system for an AI agent decision platform with deontic reasoning, a knowledge graph network. Knowledge graph network 160 integrates several specialized components that may or may not use and neuro-symbolic reasoning to create a comprehensive knowledge representation and reasoning system that maintains both logical consistency and adaptability.

An embedding framework 640 incorporates a graph neural network 641 that processes and learns from complex relational data. This framework enables the system to capture subtle patterns and relationships through geometric operations in token space. For example, in a medical context, the framework might learn that certain symptoms, when occurring together, indicate a specific condition by identifying geometric patterns in the embedded representation space. Graph neural network 614 supports dynamic reasoning over graph structures, enabling the system to infer new relationships and validate existing ones through sophisticated message-passing mechanisms.

In one embodiment, domain-specific embeddings 600 implements specialized knowledge representations for different fields using techniques from relation-aware entity alignment research. In healthcare applications, medical terminology embeddings preserve complex hierarchical relationships between conditions, symptoms, and treatments, while legal domain embeddings might capture precedent relationships and regulatory hierarchies. These embeddings operate in high-dimensional spaces that preserve semantic relationships while enabling efficient computation through quantum-inspired operations.

Relation-aware modeling 610 employs advanced techniques like RDGCN (Relation-aware Dual-Graph Convolutional Network) with dual attention mechanisms between entity graphs and their relational counterparts. This enables sophisticated modeling of interdependent relationships, such as how medical procedures relate to both anatomical structures and regulatory requirements. The relational reflection entity alignment 620 further enhances this by introducing relational hyperplane transformations that maintain geometric consistency across different knowledge domains.

Context manager 630 implements a temporal and contextual awareness system that ensures knowledge is interpreted appropriately based on multiple factors. This component integrates both symbolic rules and neural representations to maintain context across different timeframes and scenarios. For example, in a healthcare setting, it might adjust the interpretation of symptoms based on temporal factors (such as seasonal variations), patient-specific contexts (like medical history), and broader environmental factors (such as ongoing public health emergencies).

This architecture leverages advanced information theoretic principles to optimize knowledge transfer between components. The system employs mutual information measurements and transfer entropy calculations to quantify and optimize information flow between different knowledge domains. Additionally, it implements sophisticated causal entropy measurements to understand and maintain causal relationships within the knowledge structure.

The entire network operates within the system's deontic framework, ensuring that knowledge representation and reasoning align with defined obligations, permissions, and prohibitions. This integration enables the system to make ethically-sound decisions while leveraging its sophisticated knowledge representation capabilities. The architecture's flexibility and theoretical foundation allow it to handle complex scenarios requiring cross-domain knowledge integration while maintaining logical consistency and ethical compliance.

Through this comprehensive approach to knowledge representation and reasoning, the system achieves both the rigorous logical structure needed for high-assurance applications and the adaptability required for real-world deployment across various domains and contexts.

The system implements multiple specialized embedding techniques tailored to different types of knowledge representation requirements. For basic relationship translation, the system employs methods such as TransE, TransR, and TransH within its embedding framework. These are augmented with advanced implementations like AttrE and KDCoE for handling attribute-rich domains that require processing of extensive textual descriptions. This multi-modal embedding approach enables the system to maintain semantic consistency across diverse knowledge types while optimizing computational efficiency.

The platform's relation-aware modeling capabilities may be enhanced through the implementation of a Relation-aware Dual-Graph Convolutional Network (RDGCN) that operates within the embedding framework. This network employs sophisticated dual attention mechanisms between entity graphs and their relational counterparts, enabling the system to capture and maintain complex interdependencies in the knowledge structure. The integration of Relational Reflection Entity Alignment (RREA) further refines this capability by implementing relational hyperplane transformations that preserve geometric consistency across different knowledge graphs.

To address heterogeneous knowledge integration challenges, the system may incorporate advanced alignment methods such as but not limited to MTransE and BootEA within its knowledge orchestrator component. These methods enable the integration of disparate knowledge sources while maintaining semantic consistency across domains. The system's graph neural networks are specifically optimized for real-time processing of large-scale knowledge corpora, employing attention mechanisms and lightweight models to enable efficient processing while preserving relational structures.

In another embodiment, the system's embedding framework includes components for synthetic data generation, particularly for handling rare or underrepresented scenarios. This capability employs logic-to-natural-language mapping techniques that enable the system to expand its training data while maintaining logical consistency. The framework may also implement context-aware embedding mechanisms that can capture temporal, geographical, and modality-specific variations in the knowledge representation, enabling more nuanced and accurate reasoning across diverse application domains.

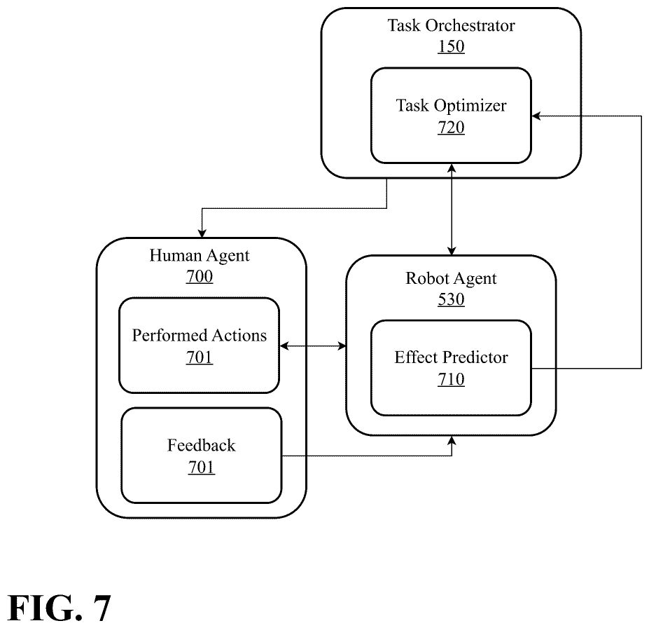

FIG. 7 is a block diagram illustrating an exemplary component of a system for an AI agent decision platform with deontic reasoning wherein an agent can predict and optimize actions based on user feedback and contextual information. A task orchestrator 150 serves as the central coordination hub, incorporating a task optimizer 720 that continuously refines execution strategies based on both predicted and actual outcomes across multiple interaction scenarios.

Within this framework, a robot agent 530 incorporates an effect predictor 710 that leverages advanced modeling techniques to anticipate the outcomes of potential actions before execution. This predictive capability enables the system to evaluate multiple approaches in parallel, considering both immediate outcomes and longer-term implications. For example, in a surgical setting, the effect predictor might simultaneously evaluate different incision locations, tool selections, and approach angles, simulating how each choice might affect patient recovery time, risk levels, and procedure success rates. In a manufacturing context, it might model how different assembly sequences could impact product quality, production time, and resource utilization.

The human agent 700 component represents a possible interface in the system, tracking both performed actions 701 and collecting detailed feedback 701 on the robot's performance.

This bidirectional interaction creates a learning loop where the robot's predictions are continuously refined based on real-world outcomes and expert human knowledge. When a surgeon demonstrates a novel technique or a manufacturing expert suggests a more efficient assembly method, the system can incorporate these insights into its prediction models and optimization strategies. The feedback mechanism also captures subtle aspects of human expertise that might not be immediately obvious from performance data alone, such as situation-specific adaptations or expert intuition about edge cases.

Task optimizer 720 serves as the system's learning center, integrating multiple data streams—including the robot's predictions, actual performance metrics, human feedback, and historical outcomes—to continuously enhance task execution strategies. This optimization process employs sophisticated machine learning techniques to identify patterns and relationships that might not be apparent through traditional programming approaches. For instance, it might discover that certain surgical techniques are more effective under specific patient conditions, or that particular assembly sequences work better with certain material variations. The optimizer maintains a balance between exploiting known successful strategies and exploring potential improvements, all while operating within defined safety and ethical boundaries.

This architecture enables nuanced human-robot collaboration that goes beyond simple task execution, creating a learning system that combines the precision and consistency of robotics with the adaptability and expertise of human operators. The continuous feedback loop ensures that the system becomes increasingly sophisticated over time, while the human oversight component maintains appropriate safety and ethical guardrails throughout the learning process.

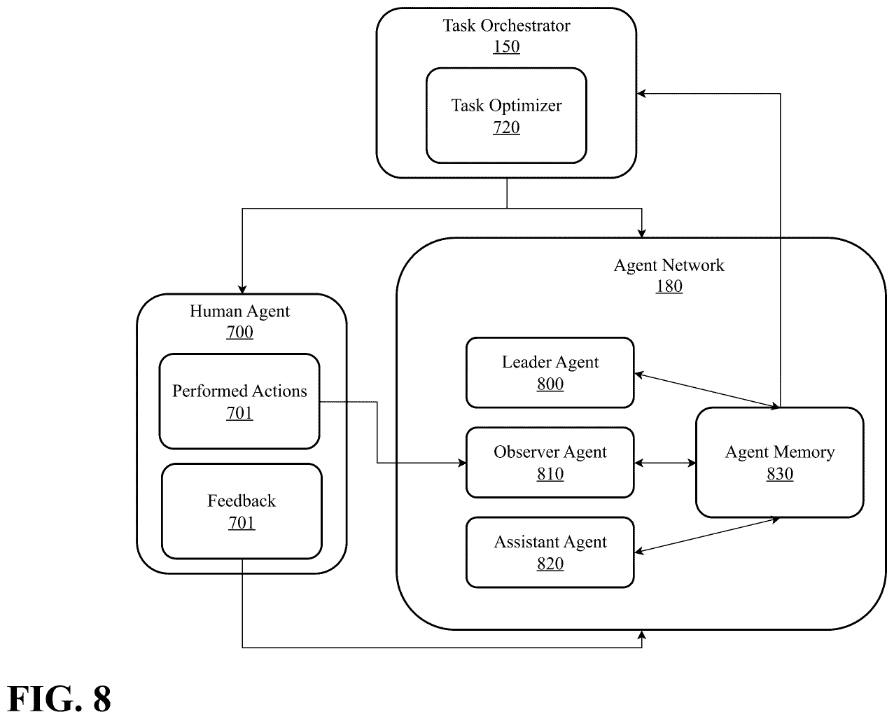

FIG. 8 is a block diagram illustrating an exemplary component of a system for an AI agent decision platform with deontic reasoning and agents organized in a hierarchy that store task and action information. In one embodiment, the system may utilize specialized agent roles and advanced memory systems to facilitate dynamic knowledge sharing while maintaining ethical constraints and operational efficiency.

In the embodiment, task orchestrator 150 and its task optimizer 720 coordinate with multiple specialized agents, each serving distinct roles in the system's decision-making process. The leader agent 800 functions as a primary coordinator, implementing dynamic responsibility allocation mechanisms that adjust based on real-time cognitive load assessments and task priorities. For instance, in a medical emergency scenario, the leader agent might shift primary decision-making authority between different specialist agents based on the evolving situation while maintaining compliance with deontic constraints.

An observer agent 810 implements monitoring capabilities based on advanced information theoretic principles. It tracks both explicit actions and implicit patterns in agent behavior, calculating mutual information and transfer entropy metrics to optimize information flow between agents. This agent is particularly useful in maintaining the system's observer-aware processing capabilities, ensuring that different perspectives and knowledge states are properly maintained and integrated.

The assistant agent 820 provides support functions and carries out delegated tasks, working in concert with both the human agent 700 and other system agents. It employs advanced neural network architectures for context-aware task execution while maintaining alignment with the system's ethical frameworks. The human agent 700 interface captures both performed actions 701 and feedback 701, creating a rich interaction channel that enables the system to learn from human expertise while maintaining appropriate autonomy levels.

An agent memory 830 implements a knowledge retention and retrieval system. This memory component utilizes systems like knowledge graphs or token space techniques to maintain and organize experiential knowledge, enabling efficient cross-domain learning and knowledge transfer. The memory system not only stores past experiences but also maintains temporal and contextual relationships, allowing agents to learn from historical interactions while adapting to new scenarios.

The entire network operates within a federated learning framework that enables agents to learn from each other through structured debates and case studies, similar to collegiate-level academic discourse. This approach allows for sophisticated peer-to-peer knowledge integration while maintaining privacy and security through differential privacy mechanisms. The system's dynamic quality assessment capabilities ensure that knowledge transfer remains effective and relevant across different domains and contexts, while the built-in validation frameworks maintain logical consistency and ethical compliance throughout the learning process.

According to one embodiment, the system may implement an integrated biometric monitoring and contextual understanding framework that combines multiple components to enable sophisticated human-robot collaboration. This framework may center on an enhanced observer agent 810 that processes multiple biometric signals including electroencephalogram (EEG) data, heart rate variability (HRV), galvanic skin response (GSR), eye tracking, and motion sensor data. The observer agent may interface directly with knowledge graph network 160 to contextualize these biometric readings against environmental data captured through multiple sensors including visual, LiDAR, thermal, and audio inputs. This integrated approach may enable the system to maintain comprehensive awareness of both operator state and operational context while dynamically adjusting task allocation between human and robot agents.

Observer agent 810 may work in concert with task orchestrator 150 to implement task allocation strategies based on the processed biometric and contextual data. When the observer agent detects elevated cognitive load through a combination of EEG signatures, increased heart rate variability, and altered eye tracking patterns, it may signal the task orchestrator to initiate a dynamic reallocation of responsibilities. For example, in a search-and-rescue scenario, if the human operator's cognitive load exceeds predetermined thresholds while managing multiple rescue operations, robot agent 530 may automatically assume control of navigation and environmental mapping tasks while leaving high-level victim prioritization decisions to the human operator.

To support this dynamic task allocation, knowledge orchestrator 140 may maintain an evolving understanding of the operational environment through scene graphs that represent spatial relationships, dynamic object tracking data, and risk maps. These representations may be continuously updated based on both sensor data and feedback from executed actions. The knowledge orchestrator may also implement retrieval-augmented generation (RAG) capabilities that enable it to enhance current decision-making by incorporating relevant historical experiences and domain expertise from knowledge graph network 160. For instance, when encountering a complex rescue scenario, the system may retrieve and analyze similar past situations to inform its current task allocation and execution strategies.

Deontic reasoning subsystem 130 may work alongside these components to ensure that all task allocations and executions remain compliant with ethical constraints while adapting to changing conditions. When observer agent 810 indicates high operator stress levels, the deontic reasoning subsystem may adjust its ethical evaluation thresholds to become more conservative, ensuring safer operation during periods of reduced human oversight. This adaptive ethical framework may be particularly crucial in scenarios where reduced operator attention could lead to increased safety risks.

The system may further implement sophisticated feedback mechanisms that adapt based on both operator state and environmental conditions. Task orchestrator 150 may select from multiple feedback modalities including visual, auditory, haptic, and direct stimulation, with the specific choice guided by observer agent's 810 assessment of operator cognitive state and environmental factors. For example, in high-noise environments with elevated operator stress levels, the system may prioritize haptic feedback for alerts while reserving visual feedback for less urgent communications.

These integrated components may operate within a unified token-space communication framework that enables efficient geometric operations between different specialist representations. This framework may allow rapid convergence of information across the system's components while preserving semantic relationships. Knowledge orchestrator 140 may leverage this token-space framework to maintain consistency between symbolic knowledge representations and neural network-based processing, enabling seamless integration of rule-based reasoning with learned behaviors.

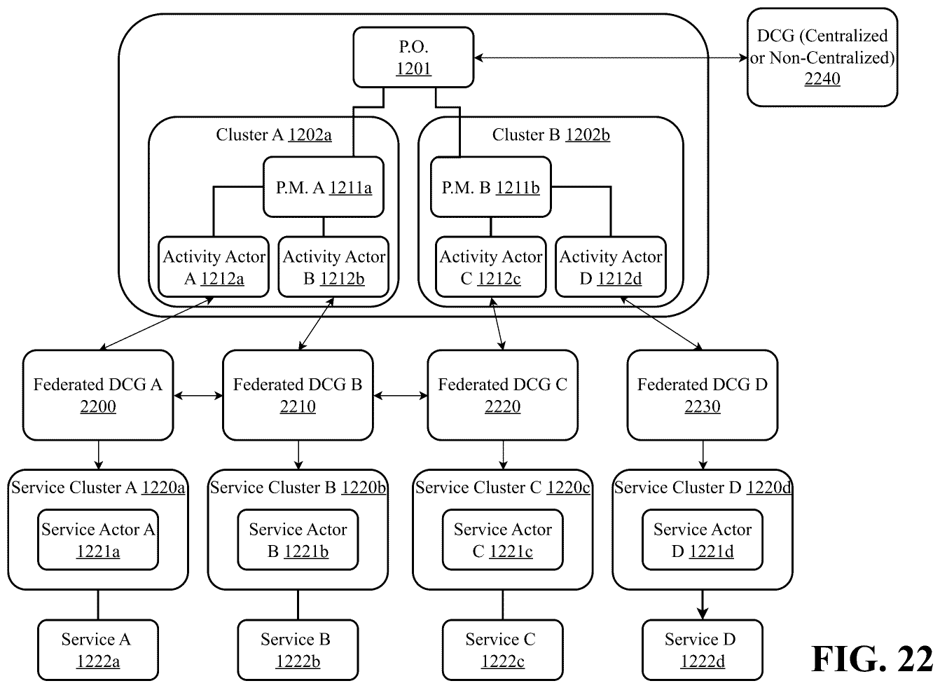

FIG. 22 is a block diagram illustrating an exemplary system architecture for a federated distributed graph-based computing platform. The system comprises a centralized DCG 2240 that coordinates with a plurality of federated DCGs 2200, 2210, 2220, and 2230, each representing a semi-independent computational entity.

The interaction between federated units in this system represents one of several possible architectural patterns for coordinating distributed computing tasks. The federated architecture supports multiple implementation approaches, with centralized DCG 2240 representing just one possible configuration. In a peer-to-peer federation pattern, DCGs can operate in a fully decentralized manner, discovering and coordinating with each other through gossip protocols, where each DCG advertises its capabilities and available resources to peers, and workloads are distributed through direct DCG-to-DCG communication without central coordination. For bot-to-bot federation scenarios, each DCG can act as an interface to specific user requests or tasks, with DCGs discovering peer capabilities through gossip protocols and matching tasks to capabilities through autonomous selection. When implemented as a centralized federation, as shown with DCG 2240, it may maintain a high-level view of resources and processes similar to syndication patterns in enterprise architecture, though with limited visibility into internal DCG operations. For instance, in this pattern, task distribution may be facilitated by the centralized DCG 2240, but the fundamental capabilities for autonomous operation remain distributed across the federation, allowing each DCG to maintain independent control over its resources and processing decisions. In one embodiment, centralized DCG 2240 oversees the distribution of workloads across the federated system, maintaining a high-level view of available resources and ongoing processes. In some embodiment, centralized DCG 2240 may not have full visibility or control over the internal operations of each federated DCG. Each DCG system involved in the federated DCG platform may be represented by the system 300 as depicted in FIG. 3.

Each federated DCG (2200, 2210, 2220, 2230) operates as a semi-autonomous unit. These federated DCGs have their own internal structure, similar to the DCG depicted in FIG. 3. In one embodiment, each federated DCG communicates through pipelines that extend across multiple systems, facilitating a flexible and distributed workflow. The pipeline orchestrator P.O. 1201 serves as a conduit for task delegation from the DCG 2240 to the federated DCGs. Each federated DCG (2200, 2210, 2220, 2230) operates as a fully autonomous unit with complete capability to function independently within the federation. These federated DCGs have their own internal structure, similar to the DCG depicted in FIG. 3, and can operate without requiring central coordination. The federated DCGs communicate through pipelines that extend across multiple systems, enabling flexible and distributed workflows through various architectural patterns. In one implementation, DCGs can directly advertise and coordinate tasks with other DCGs in the federation without central mediation, where the pipeline orchestrator P.O. 1201 in each DCG manages task distribution and execution locally while coordinating with peer DCGs through federation protocols. These pipelines may span any number of federated systems, with a plurality of pipeline managers (P.M. A 1211a, P.M. B 1211b, etc.) overseeing different segments or aspects of the workflow based on whether the federation is operating in peer-to-peer, hierarchical, or hybrid patterns. Federated DCGs interact with corresponding local service clusters 1220a-d and associated Service Actors 1221a-d to execute tasks represented by services 1222a-d, allowing for efficient local processing while maintaining flexible connections to the broader federated network through whichever federation pattern best suits the current needs. While a centralized orchestration through DCG 2240 may be implemented in some scenarios, it represents just one possible configuration rather than a requirement of the federation architecture. These pipelines may span any number of federated systems, with a plurality of pipeline managers (P.M. A 1211a, P.M. B 1211b, etc.) overseeing different segments or aspects of the workflow. Federated DCGs interact with corresponding local service clusters 1220a-d and associated Service Actors 1221a-d to execute tasks represented by services 1222a-d, allowing for efficient local processing while maintaining a connection to the broader federated network.

Centralized DCG 2240 may delegate resources and projects to federated DCGs via the pipeline orchestrator P.O. 1201, which then distributes tasks along the pipeline structure. This hierarchical arrangement allows for dynamic resource allocation and task distribution across the federation. Pipelines can be extended or reconfigured to include any number of federated systems, adapting to the complexity and scale of the computational tasks at hand.

Federated DCGs 2200, 2210, 2220, and 2230 may take various forms, representing a diverse array of computing environments. They may exist as cloud-based instances, leveraging the scalability and resources of cloud computing platforms. Edge computing devices can also serve as federated DCGs, bringing computation closer to data sources and reducing latency for time-sensitive operations. Mobile devices, such as smartphones or tablets, can act as federated DCGs, contributing to the network's processing power and providing unique data inputs. Other forms may include on-premises servers, IoT devices, or even specialized hardware like GPUs or TPUs. This heterogeneity allows the federated DCG platform to adapt to various computational needs and take advantage of diverse computing resources, creating a robust and versatile distributed computing environment.

In this federated system, workloads can be distributed across different federated DCGs based on a plurality factors such as but not limited to resource availability, data locality, privacy requirements, or specialized capabilities of each DCG. Centralized DCG 2240 may assign entire pipelines or portions of workflows to specific federated DCGs, which then manage the execution internally. Communication between centralized DCG 2240 and federated DCGs, as well as among federated DCGs themselves, may occur through the pipeline network which is being overseen by the plurality of pipeline managers and the pipeline orchestrator P.O. 1201.

The interaction between federated units, the centralized unit, and other federated units in this system may be partially governed by privacy specifications, security requirements, and the specific needs of each federated unit. The interaction between federated DCGs in this system is governed by self-enforced privacy specifications, security requirements, and the specific operational needs of each federated unit. Each DCG autonomously manages its privacy and security constraints while participating in the federation. For example, a DCG processing healthcare data can maintain internal mapping tables for data anonymization, transform sensitive data using temporary IDs before sharing, and control data visibility without requiring other DCGs to be aware of the underlying privacy measures. In one embodiment, DCGs advertise their operational requirements to the federation, such as geographic processing restrictions (e.g., EU-only data processing), security clearance requirements, and regulatory compliance certifications. When assigning or accepting tasks, each DCG independently evaluates and enforces its privacy and security controls based on its declared capabilities. For instance, a DCG might autonomously determine whether to process sensitive healthcare data based on its certifications and security measures, without requiring central coordination. While a centralized DCG 2240 may exist in some implementations to facilitate coordination, the fundamental privacy and security controls remain distributed across the federated DCGs, enabling flexible and secure collaboration through self-managed privacy controls and peer-based task distribution. DCG 2240 may manage the overall workflow distribution while respecting privacy and security constraints. In one embodiment, DCG 2240 may be centralized and maintain a high-level view of the system but may have limited insight into the internal operations of each federated DCG. When assigning tasks or pipelines, DCG 2240 may consider the privacy specifications associated with the data and the security clearance of each federated DCG. For instance, it might direct sensitive healthcare data only to federated DCGs with appropriate certifications or security measures in place.

Federated DCGs (2200, 2210, 2220, 2230) may interact with the DCG 2240 and each other based on predefined rules and current needs. A federated DCG might request additional resources or specific datasets from DCG 2240, which would then evaluate the request against security protocols before granting access. In cases where direct data sharing between federated DCGs is necessary, DCG 2240 may facilitate this exchange, acting as an intermediary to ensure compliance with privacy regulations. The level of information sharing between federated DCGs can vary. Some units might operate in isolation due to strict privacy requirements, communicating only with DCG 2240. Others might form collaborative clusters, sharing partial results or resources as needed. For example, federated DCG 2200 might share aggregated, anonymized results with federated DCG 2210 for a joint analysis, while keeping raw data confidential.

DCG 2240 may implement a granular access control system, restricting information flow to specific federated DCGs based on the nature of the data and the task at hand. It may employ techniques like differential privacy or secure multi-party computation to enable collaborative computations without exposing sensitive information. In scenarios requiring higher security, DCG 2240 may create temporary, isolated environments where select federated DCGs can work on sensitive tasks without risking data leakage to the broader system. This federated approach allows for a balance between collaboration and privacy, enabling complex, distributed computations while maintaining strict control over sensitive information. The system's flexibility allows it to adapt to varying privacy and security requirements across different domains and use cases, making it suitable for a wide range of applications in heterogeneous computing environments.

In another embodiment, a federated DCG may enable an advanced data analytics platform to support non-experts in machine-aided decision-making and automation processes. Users of this system may bring custom datasets which need to be automatically ingested by the system, represented appropriately in nonvolatile storage, and made available for system-generated analytics to respond to with questions the user(s) want to have answered or decisions requiring recommendations or automation. In this case the DCG orchestration service would create representations of DCG processes that have nodes that each operate on the data to perform various structured extraction tasks, to include schematization, normalization and semantification activities, to develop an understanding of the data content via classification, embedding, chunking, and knowledge base construction and vector representation persistence and structured and unstructured data view generation and persistence, and may also smooth, normalize or reject data as required to meet specified user intent. Users may optionally be asked to provide feedback, e.g. via layperson content and subsequent interpretation by LLM re: the generated tasks or DCG pipelines generated, or in expert or power user modes access or view or modify actual declarative formulations of pipelines or transformation tasks. Based on the outcome of the individual transformation steps and various subgraph pipeline execution and analysis additional data may be added over time or can be accessed from either a centralized data repository, or enriched via ongoing collection from one or more live sources. Data made available to the system can then be tagged and decomposed or separated into multiple sets for training, testing, and validation via pipelines or individual transformation stages. A set of models must then be selected, trained, and evaluated before being presented to the user, which may optionally leverage data and algorithm marketplace functionality. This step of model selection, training, and evaluation can be run many times to identify the optimal combination of input dataset(s), selected fields, dimensionality reduction techniques, model hyper parameters, embeddings, chunking strategies, or blends between use of raw, structured, unstructured, vector and knowledge corpora representations of data for pipelines or individual transformation nodes. The ongoing search and optimization process engaged in by the system may also accept feedback from a user and take new criteria into account such as but not limited to changes in budget that might impact acceptable costs or changes in timeline that may render select techniques or processes infeasible. This may mean system must recommend or select a new group of models, adjusting how training data was selected, or how the model outputs are evaluated or otherwise adjust DCG pipelines or transformation node declarations according to modified objective functions which enable comparative ranking (e.g. via score, model or user feedback or combination) of candidate transformation pipelines with resource and data awareness. The user doesn't need to know the details of how models are selected and trained, but can evaluate the outputs for themselves and view ongoing resource consumption, associated costs and forward forecasts to better understand likely future system states and resource consumption profiles. Based on outputs and costs, they can ask additional questions of the data and have the system adjust pipelines, transformations or parameters (e.g. model fidelity, number of simulation runs, time stepping, etc. . . . ) as required in real time for all sorts of models including but not limited to numerical methods, discrete event simulation, machine learning models or generative AI algorithms.

In one embodiment, the AI agent decision platform integrates a resource-ethical optimization module that continuously evaluates both computational resource metrics (e.g., CPU load, GPU memory utilization, latency constraints) and ethical or compliance metrics derived from the system's deontic logic framework. This approach ensures that task allocation and scheduling decisions are not driven solely by technical efficiency but also by adherence to obligations, permissions, and prohibitions encoded in the knowledge graphs. Each node in the federated system (e.g., cloud instances, edge devices, or specialized hardware) provides real-time telemetry, reporting CPU usage, GPU utilization, memory availability, and network bandwidth. This telemetry feeds into a resource registry, continuously updated to reflect the federation's current load distribution. Simultaneously, the deontic reasoning subsystem supplies the resource-ethical optimization module with compliance-relevant signals—such as the level of data sensitivity (e.g., personal health information), regulatory constraints per geographic region, and severity of potential violations (e.g., “strict prohibition,” “high-risk obligation”). The platform's scheduling or orchestration process employs a multi-objective cost function that blends standard performance metrics (e.g., throughput, latency, resource cost) with ethical/compliance scores. For instance, each node or data pipeline may be assigned a “compliance risk value” if it handles sensitive data, while also including a “performance efficiency value” for raw technical throughput.

The optimization engine may adopt an approach akin to Pareto optimization—or any suitable constrained optimization algorithm—that seeks solutions minimizing total “cost” while ensuring no active deontic rule is violated. For example, if a node is physically located in a jurisdiction with strict privacy obligations, the system might only allocate tasks involving personal data to nodes that meet or exceed that jurisdiction's compliance threshold. When new tasks arrive—such as large-scale modeling jobs or medical data analytics—the system queries the resource-ethical optimization module to find the best node or group of nodes. “Best” here includes not only capacity for faster runtime but also alignment with relevant deontic constraints (e.g., “must not process data outside region X,” “must ensure real-time access logs,” “must prioritize tasks with urgent life-safety implications”). If the system detects changing circumstances—such as a node's resource spike or new legal restrictions—the module recalculates allocations and can dynamically reassign tasks. For instance, a node that was efficient but becomes overburdened or out-of-compliance can trigger automatic fallback to a second-choice node with slightly lower performance but higher compliance adherence. Administrators or domain experts can inspect a combined metrics dashboard that plots performance metrics (throughput, latency, cost) against compliance/ethical standings (deviation from obligations, severity of potential data leakage). The platform can generate alerts if performance optimizations begin to push boundaries of compliance risk beyond acceptable thresholds. Over time, the module refines its weighting factors by tracking outcomes—e.g., near misses, actual violations, or user satisfaction data—ensuring continuous learning.

The deontic reasoning subsystem updates constraints if new obligations arise, while the optimization engine adjusts the weight distribution in the cost function to remain balanced between ethical compliance and computational efficiency. By using a multi-objective optimization strategy that explicitly weighs compliance and ethical criteria alongside computational performance, this embodiment ensures that the AI agent decision platform respects both real-world constraints (e.g., laws, regulations, data sensitivities) and technical demands. The system can thus make intelligent, context-aware allocations—such as routing life-critical healthcare data only to nodes with the highest security clearances—even when it might reduce pure computational efficiency. Through this resource-ethical optimization module, this goes beyond conventional load balancing into a holistic approach that merges ethical compliance with operational excellence.

According to another embodiment, a federated DCG may enable advanced malware analysis by accepting one or more malware samples. Coordinated by the DCG, system may engage in running a suite of preliminary analysis tools designed to extract notable or useful features of any particular sample, then using this information to select datasets and pretrained models developed from previously observed samples. The DCG can have a node to select a new model or models to be used on the input sample(s), and using the selected context data and models may train this new model. The output of this new model can be evaluated and trigger adjustments to the input dataset or pretrained models, or it may adjust the hyperparameters of the new model being trained. The DCG may also employ a series of simulations where the malware sample is detonated safely and observed. The data collected may be used in the training of the same or a second new model to better understand attributes of the sample such as its behavior, execution path, targets (eg: what operating systems, services, networks is it designed to attack), obfuscation techniques, author signatures, or malware family group signatures.

According to an embodiment, a DCG may federate and otherwise interact with one or more other DCG orchestrated distributed computing systems to split model workloads and other tasks across multiple DCG instances according to predefined criteria such as resource utilization, data access restrictions and privacy, compute or transport or storage costs et cetera. It is not necessary for federated DCGs to each contain the entire context of workload and resources available across all federated instances and instead may communicate, through a gossip protocol for example or other common network protocols, to collectively assign resources and parts of the model workload across the entire federation. In this way it is possible for a local private DCG instance to use resources from a cloud based DCG, owned by a third party for example, while only disclosing the parts of the local context (e.g. resources available, DCG state, task and model objective, data classification), as needed. For example, with the rise of edge computing for AI tasks a federated DCG could offload all or parts computationally intensive tasks from a mobile device to cloud compute clusters to more efficiently use and extend battery life for personal, wearable or other edge devices. According to another embodiment, workloads may be split across the federated DCG based on data classification. For example, only process Personally identifiable information (PII) or Protected Health Information (PHI) on private compute resources, but offload other parts of the workload, with less sensitive data, to public compute resources (e.g. those meeting certain security and transparency requirements).

In an embodiment, the federated distributed computational graph (DCG) system enables a sophisticated approach to distributed computing, where computational graphs are encoded and communicated across devices alongside other essential data. This data may include application-specific information, machine learning models, datasets, or model weightings. The system's design allows for the seamless integration of diverse computational resources.

The federated DCG facilitates system-wide execution with a unique capability for decentralized and partially blind execution across various tiers and tessellations of computing resources. This architecture renders partially observable, collaborative, yet decentralized and distributed computing possible for complex processing and task flows. The system employs a multi-faceted approach to resource allocation and task distribution, utilizing rules, scores, weightings, market/bid mechanisms, or optimization and planning-based selection processes. These selection methods can be applied at local, regional, or global levels within the system, where “global” refers to the entirety of the interconnected federated DCG network, regardless of the physical location or orbital position of its components.

This approach to federated computing allows for unprecedented flexibility and scalability. It can adapt to the unique challenges posed by diverse computing environments, from traditional terrestrial networks to the high-latency, intermittent connections characteristic of space-based systems. The ability to operate with partial blindness and decentralized execution is particularly valuable in scenarios where complete information sharing is impossible or undesirable due to security concerns, bandwidth limitations, or the physical constraints of long-distance space communications.

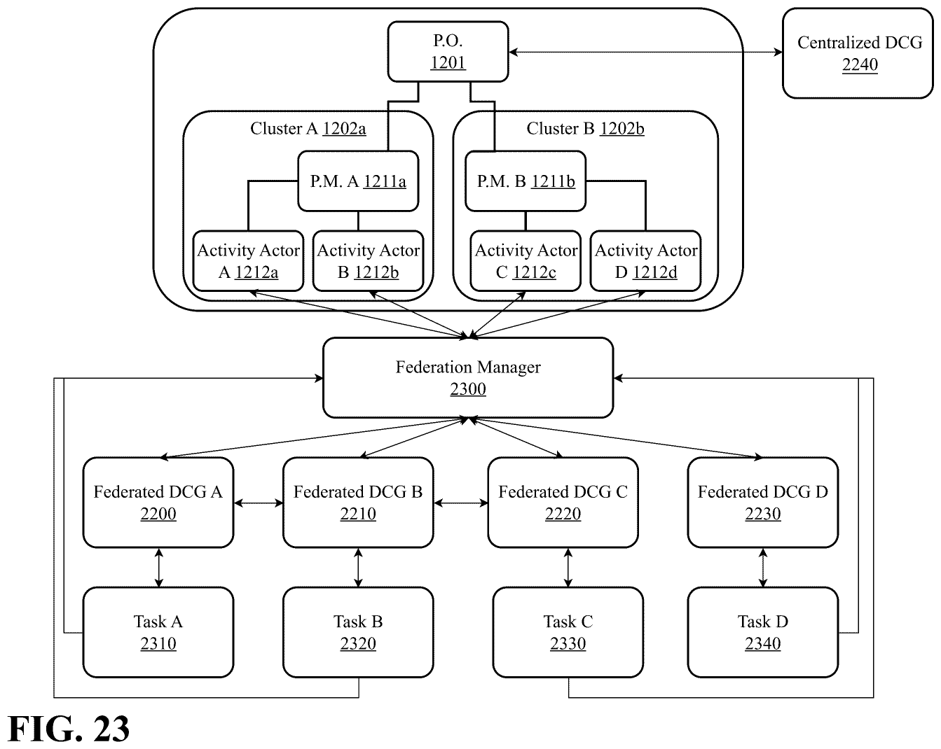

FIG. 23 is a block diagram illustrating an exemplary system architecture for a federated distributed graph-based computing platform that includes a federation manager. In one embodiment, a federation manager 2300 serves as an intermediary between the DCG 2240 and the federated DCGs (2200, 2210, 2220, 2230), providing a more sophisticated mechanism for orchestrating the federated system. It assumes some of the coordination responsibilities previously handled by the centralized DCG, allowing for more nuanced management of resources, tasks, and data flows across the federation. In this structure, DCG 2240 communicates high-level directives and overall system goals to the federation manager 2300. Federation manager 2300 may then translate these directives into specific actions and assignments for each federated DCG, taking into account their individual capabilities, current workloads, and privacy requirements. Additionally, federation manager 2300 may also operate in the reverse direction, aggregating and relaying information from federated DCGs back to DCG 2240. This bi-directional communication allows federation manager 2300 to provide real-time updates on task progress, resource utilization, and any issues or anomalies encountered within the federated network. By consolidating and filtering this information, federation manager 2300 enables centralized DCG 2240 to maintain an up-to-date overview of the entire system's state without being overwhelmed by low-level details. This two-way flow of information facilitates adaptive decision-making at the centralized level while preserving the autonomy and efficiency of individual federated DCGs, ensuring a balanced and responsive federated computing environment

In an embodiment, federation manager 2300 may be connected to a plurality of pipeline managers 1211a and 1211b, which are in turn connected to a pipeline orchestrator 1201. This connection allows for the smooth flow of information between each of the various hierarchies, or tessellations, within the system. Federation manager 2300 may also oversee the distribution and execution of tasks 2310, 2320, 2330, 2340 across the federated DCGs. It can break down complex workflows into subtasks, assigning them to appropriate federated DCGs based on their specializations, available resources, and security clearances. This granular task management allows for more efficient utilization of the federated system's resources while maintaining strict control over sensitive operations.

Federation manager 2300 may allocate tasks and transmit information in accordance with privacy and security protocols. It may act as a gatekeeper, controlling the flow of information between federated DCGs and ensuring that data sharing complies with predefined privacy policies. For instance, it could facilitate secure multi-party computations, allowing federated DCGs to collaborate on tasks without directly sharing sensitive data. Federation manager 2300 may also enable more dynamic and adaptive resource allocation. It can monitor the performance and status of each federated DCG in real-time, reallocating tasks or resources as needed to optimize overall system performance. This flexibility allows the system to respond more effectively to changing workloads or unforeseen challenges.

By centralizing federation management functions, this architecture provides a clearer separation of concerns between global coordination (handled by centralized DCG 2240) and local execution (managed by individual federated DCGs). This separation enhances the system's scalability and makes it easier to integrate new federated DCGs or modify existing ones without disrupting the entire federation.

In one embodiment, the federated DCG system can be applied to various real-world scenarios. In healthcare, multiple hospitals and research institutions can collaborate on improving diagnostic models for rare diseases while maintaining patient data confidentiality. Each node (hospital or clinic) processes patient data locally, sharing only aggregated model updates or anonymized features, allowing for the creation of a global diagnostic model without compromising individual patient privacy. In financial fraud detection, competing banks can participate in a collaborative initiative without directly sharing sensitive customer transaction data. The system enables banks to maintain local observability of their transactions while contributing to a shared fraud detection model using techniques like homomorphic encryption or secure multi-party computation. For smart city initiatives, the system allows various entities (e.g., transportation authorities, environmental monitors, energy providers) to collaborate while respecting data privacy. Each entity processes its sensor data locally, with the system orchestrating cross-domain collaboration by enabling cross-institution model learning without full observability of the underlying data.

In one embodiment, the federated DCG system is designed to support partial observability and even blind execution across various tiers and tessellations of computing resources. This architecture enables partially observable, collaborative, yet decentralized and distributed computing for complex processing and task flows. The system can generate custom compute graphs for each federated DCG, specifically constructed to limit information flow. A federated DCG might receive a compute graph representing only a fraction of the overall computation, with placeholders or encrypted sections for parts it should not access directly. This allows for complex, collaborative computations where different parts of the system have varying levels of visibility into the overall task. For instance, a federated DCG in a highly secure environment might perform computations without full knowledge of how its output will be used, while another might aggregate results without access to the raw data they're derived from.

In one embodiment, the federated DCG system is designed to seamlessly integrate diverse computational resources, ranging from edge devices to cloud systems. It can adapt to the unique challenges posed by these varied environments, from traditional terrestrial networks to high-latency, intermittent connections characteristic of space-based systems. The system's ability to operate with partial blindness and decentralized execution is particularly valuable in scenarios where complete information sharing is impossible or undesirable due to security concerns, bandwidth limitations, or physical constraints of long-distance communications. This flexibility allows the system to efficiently manage workloads across a spectrum of computing resources, from mobile devices and IoT sensors to edge computing nodes and cloud data centers.

In one embodiment, the system employs a multi-faceted approach to resource allocation and task distribution, utilizing rules, scores, weightings, market/bid mechanisms, or optimization and planning-based selection processes. These selection methods can be applied at local, regional, or global levels within the system. This approach allows the federated DCG to dynamically adjust to varying privacy and security requirements across different domains and use cases. For example, the system can implement tiered observability, where allied entities may have different levels of data-sharing access depending on treaties or bilateral agreements. This enables dynamic privacy management, allowing the system to adapt to changing regulatory landscapes or shifts in data sharing policies among collaborating entities.

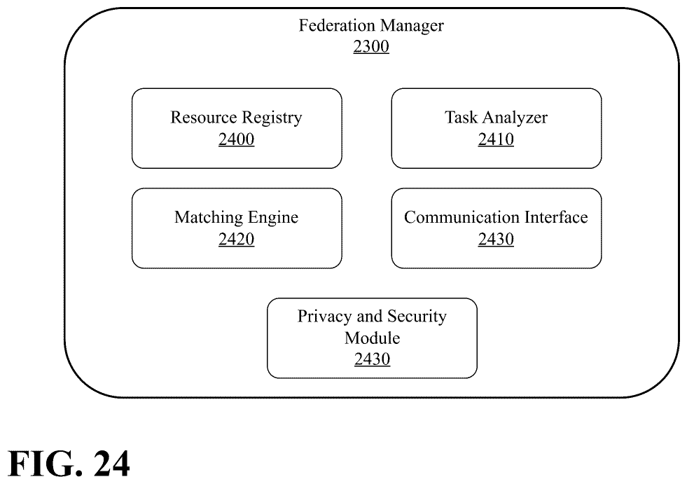

FIG. 24 is a block diagram illustrating an exemplary component of a federated distributed graph-based computing platform that includes a federation manager, the federation manager. In one embodiment, a resource registry 2400 maintains a dynamic inventory of available resources across all federated DCGs. This may be accomplished by periodically polling each federated DCG for updates on their computational capacity, storage availability, and current workload. This information is stored in a structured database, allowing for quick querying and analysis. The registry may use a gossip protocol to efficiently propagate updates across the federation, ensuring that resource information remains current even in large-scale deployments.

A task analyzer 2410 examines incoming tasks from the centralized DCG 2240 or from federated DCGs, breaking them down into subtasks and determining their requirements. It achieves this by parsing task descriptions, which may be encoded in a domain-specific language, and creating a directed acyclic graph (DAG) representing the task's structure and dependencies. The analyzer may also provide estimates regarding resource requirements for each subtask based on historical data and predefined heuristics.

A matching engine 2420 aligns tasks with appropriate federated DCGs by cross-referencing task requirements from task analyzer 2410 with available resources that have been documented by resource registry 2400. In one embodiment, matching engine may employ algorithms such as constraint satisfaction solvers or machine learning models, to optimize task distribution. The engine 2420 considers factors such as but not limited to data locality, processing power requirements, and privacy constraints when making matching decisions. It may use a scoring system to rank potential matches, selecting the highest-scoring options for task assignment.

A communication interface 2430 facilitates secure and efficient information exchange between federation manager 2300, centralized DCG 2240, and federated DCGs. It implements various communication protocols (e.g., gRPC, MQTT) to accommodate different network conditions and security requirements. The interface may encrypt data transfers and may employ techniques like zero-knowledge proofs for sensitive communications, allowing entities to verify information without revealing underlying data.

A privacy and security module 2440 enforces data protection policies across the federation. It achieves this by maintaining a set of rules and permissions for each federated DCG and task. When a task is assigned, this module checks the security clearance of the target federated DCG against the task's requirements. It may implement differential privacy techniques, adding controlled noise to data or results to prevent the extraction of individual information. For collaborative tasks, it could set up secure multi-party computation protocols, enabling federated DCGs to jointly compute results without sharing raw data.

In a decentralized, blind or double blind embodiments, DCG 2240 encodes high-level computational tasks into graphs that can be distributed across the federation. However, unlike traditional distributed systems, these graphs are designed to be partitioned and obscured, allowing for partial or even blind execution. Federation manager 2300 receives computational graphs from DCG 2240, and breaks down the graphs into subtasks which are designed to be executable with limited context. Matching engine 2420 then allocates these subtasks to federated DCGs 2200, 2210, 2220, 2230 based not just on their capabilities, but also on their clearance levels and need-to-know basis.

For each federated DCG, the system may generate a custom compute graph. These graphs are not merely simplified versions of the original, but are specifically constructed to limit information flow. A federated DCG might receive a compute graph that represents only a fraction of the overall computation, with placeholders or encrypted sections representing parts of the computation it should not have direct access to. Communication interface 2430 securely transmits these tailored compute graphs to the federated DCGs through the pipeline structure 1201. This transmission process itself can incorporate encryption and access control mechanisms to maintain the partial blindness of the execution.

Within each federated DCG, the activity actors 1212a-d perform computations based on their received graph, potentially without full knowledge of the overall task they're contributing to. This blind or partially blind execution may be managed by the local pipeline orchestrator 1201, which ensures that each component only accesses the information it's cleared for. The system's ability to operate with partial observability comes into play as computations progress. Federated DCGs report results back through the pipeline structure, but these results may be encrypted or obfuscated to maintain partial blindness. This architecture allows for complex, collaborative computations where different parts of the system have varying levels of visibility into the overall task. For instance, a federated DCG in a highly secure environment might perform computations without full knowledge of how its output will be used, while another federated DCG might aggregate results without access to the raw data they're derived from.

By enabling this decentralized, partially blind execution, the federated DCG system can tackle complex computational tasks that span entire networks, while maintaining strict control over information flow and resource utilization. This approach is particularly valuable for scenarios involving sensitive data, limited communication bandwidth, or the need for compartmentalized computing across vast distances in space.

In one embodiment, the system implements dynamic task allocation based on real-time conditions and changing requirements. As computations progress, each federated DCG reports back through the pipeline structure, providing feedback on task progress, resource utilization, and any issues encountered. The federation manager aggregates this information, providing a high-level overview of the system's state. Based on this real-time feedback, the system can dynamically adjust compute graphs and task allocations. It might modify compute graphs in real-time, reassign tasks to different federated nodes, or adjust resource allocations in response to changing workloads or unforeseen challenges. This adaptive process ensures efficient utilization of resources across the entire federated system, from terrestrial networks to space-based computing nodes, allowing the system to respond effectively to changing conditions and requirements in real-time while maintaining security and efficiency.

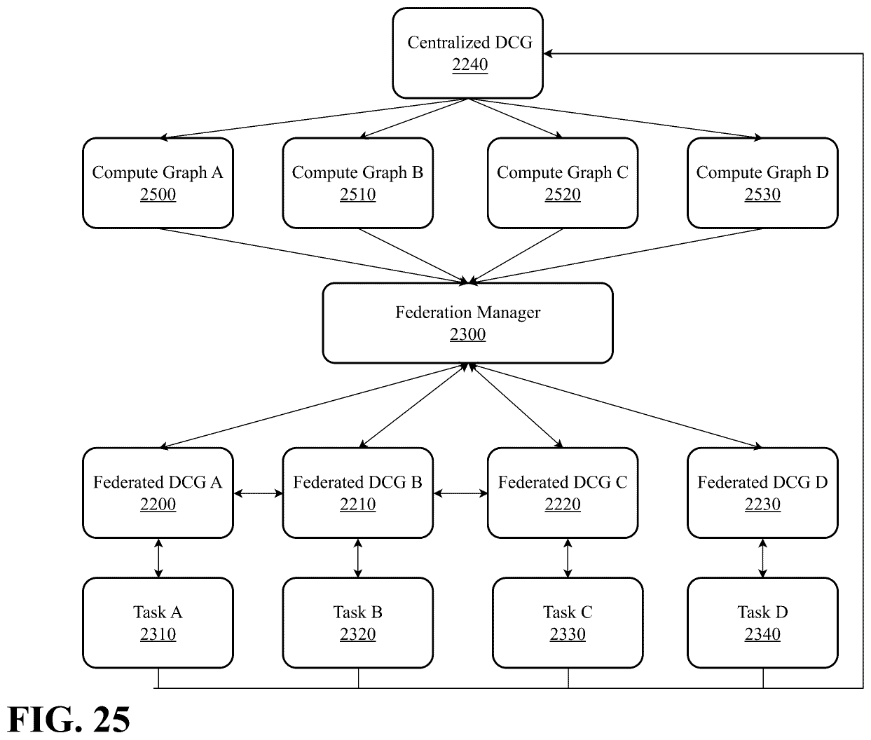

FIG. 25 is a block diagram illustrating an exemplary system architecture for a federated distributed graph-based computing platform that includes a federation manager where different compute graphs are forward to various federated distributed computation graph systems. In one embodiment, DCG 2240 generates a plurality of compute graphs 2500, 2510, 2520, 2530 tailored to each federated DCG's requirements and specifications. This approach allows for fine-grained control over information access and task execution across the federation. DCG 4940 analyzes the overall task requirements and the characteristics of each federated DCG 2200, 2210, 2220, 2230, considering factors such as but not limited to processing capabilities, data access permissions, security clearance levels, and specialized functions. Based on this analysis, it constructs custom compute graphs for each Federated DCG through a multi-step process that involves creating a master compute graph, applying transformations based on each DCG's specifications, and potentially replacing sensitive operations with privacy-preserving alternatives.

Federation manager 2300 may provide the DCG 2240 with up-to-date information about each federated DCG's current status, capabilities, and access rights by leveraging the pipeline infrastructure. This information is used to dynamically adjust the compute graphs as conditions change. When distributing tasks 2310, 2320, 2330, 2340, centralized DCG 2240 sends the corresponding compute graph along with the task, serving as a blueprint for how the federated DCG should execute the task, specifying data access, operations, and handling of intermediate results.

Compute graphs may also be used to facilitate secure collaboration between federated DCGs, potentially including special nodes that define how intermediate results should be shared or combined without revealing sensitive information. As federated DCGs execute their tasks according to their assigned compute graphs, they report progress back to federation manager 2300. Federation manager may then update DCG 2240, which may decide to modify the compute graphs in real-time if necessary, such as when new data requires additional processing steps or if a security policy changes mid-execution.

This dynamic, graph-based approach allows the system to maintain strict control over information flow and task execution while still leveraging the full capabilities of the federated architecture. It provides a flexible framework for handling complex, distributed tasks with varying security and privacy requirements across heterogeneous computing environments, enabling the system to adapt to changing conditions and requirements in real-time while maintaining security and efficiency for both complete and intermediate results sharing as well as entire chain-of-thought sharing between different expert/persona models.

With federated Distributed Computational Graphs, each node in the federation can operate both autonomously and cooperatively through compute graphs. The system orchestrates tasks (and sub-tasks) across various nodes, each of which may have different security, regulatory, or performance constraints. The physical topology represents the actual hardware layout—clusters of servers, edge devices, sensor arrays. The logical topology represents how these nodes are interconnected logically, e.g., which nodes have secure VPN tunnels, which have higher-latency WAN connections, etc. The data-flow graph depicts which nodes produce or consume data in pipelines, along with transformations or partial results that flow among them. A specialized annotation layer, the deontic overlay, encodes the rules, constraints, or obligations/prohibitions relevant to each node or each stage in the pipeline (e.g., “Node X must not process personal data,” “Sub-task Y requires a professional overseer agent,” etc.). By layering these topologies (physical, logical, data flow) and adding a deontic overlay, we can produce a comprehensive “graph of graphs” that the federation manager and DCG orchestrator can consult in real time to maintain compliance, security, and efficient resource usage. In some embodiments, the federation manager may not possess full visibility into the detailed computations or intermediate states occurring within each federated node-especially when privacy-preserving transformations, data anonymization, or partially blind execution are enforced. Instead, the federation manager primarily orchestrates the high-level resource allocation, ensures that tasks are routed to nodes equipped with the requisite security clearances or specialized capabilities, and enforces relevant deontic constraints by referencing a global rules database or knowledge graph. At a granular level, each local node may execute its assigned subtasks without transmitting raw data or revealing sensitive intermediate artifacts back to the federation manager, thereby maintaining strict privacy requirements. Consequently, the federation manager retains optionality to act as a “coordinator” role rather than a fully informed “controller,” balancing system-wide oversight of task scheduling and policy compliance without intruding on confidential or domain-specific details at each node for both implicit and explicitly defined computational graphs regardless of how many federation managers may participate in collective data flow management across a compound or composite process.

In addition to standard transformation nodes, the system may add special nodes dedicated to controlling or transforming sensitive outputs. If a task processes personal or proprietary data, a “masking node” can sanitize or anonymize the partial outputs before they move downstream. The deontic overlay encodes the requirement: “Data from sub-task A must not reveal personal info to Node B unless Node B is certified.” Before sending partial results across an untrusted link, a node can encrypt or compress them in a zero-knowledge manner. The DCG can also define “secure aggregation” nodes that combine partial results from multiple sources without revealing any single party's raw data. If a “persona” or “expert agent” needs to share chain-of-thought with another agent, the system can insert a node that “merges” or “filters” the reasoning steps according to deontic constraints. This is crucial in contexts with multiple roles (e.g., doctor-lawyer-engineer collaboration) where some reasoning steps might remain private while others can be safely disclosed. As tasks proceed, each node in the federated DCG continuously reports progress or partial results back to the federation manager (FM).

The FM tracks which partial results are being used, where they're shared, and whether any new constraints have appeared (e.g., updated security policies). If a new constraint emerges—say a privacy policy changes—the FM can instruct the DCG orchestrator to inject new masking or encryption nodes mid-execution, ensuring compliance going forward. When the FM decides to alter an existing pipeline, it can pause relevant tasks or sub-tasks, modify the compute graph nodes (e.g., add an encryption node, reroute outputs to a different data store), and resume tasks with updated constraints or transformations. This ensures tasks can adapt on the fly without needing to tear down the entire pipeline. In the physical topology, nodes represent machines, devices, or entire data centers, while edges represent physical interconnects (fiber links, local networks, etc.). The federation must keep track of real-world constraints: bandwidth, latency, physical location (e.g., to comply with data residency laws). In the logical topology, nodes can represent “logical units of computation” rather than hardware-like a microservice that performs encryption, an AI model that performs classification, etc. Edges reflect the permission or capability to call one service from another (like an internal microservice call behind a firewall). The compute graph used by the DCG is effectively a data-flow graph: each transformation node receives input streams, applies transformations, and outputs downstream. Special nodes for partial results can direct outputs to ephemeral storage or to aggregator services. The deontic overlay adds various constraints or “attributes” on each node or edge, including regulatory constraints (“Node must comply with HIPAA,” “Edge requires encryption”), organizational constraints (“This pipeline is restricted to Team A's eyes only”), and obligations & prohibitions (e.g., “must store logs for at least 7 days” “Must not share chain-of-thought with unapproved external nodes”).

Consider a practical example: a multi-organization collaboration on a medical AI system where different institutions share partial models or chain-of-thought but must keep patient data private. The physical topology consists of three data centers in different regions, where the pipeline must consider which region is allowed to handle PII or which region is cost-optimal for GPU usage. The logical topology comprises a secure overlay network for each partner's microservices, with some microservices only accessible via zero-trust gateways. The data-flow includes multiple sub-tasks: (a) read anonymized data from Hospital A, (b) combine with partial chain-of-thought from a remote aggregator, (c) produce refined model parameters. The deontic overlay enforces constraints such as “Hospital A's data must never be stored outside Region X” and “Chain-of-thought can only be shared with nodes that have ‘medical staff’ clearance.” The federation manager sees that the aggregator node is a “trusted persona,” so partial chain-of-thought is approved. However, the aggregator might need to pass the results to a second node—the overlay enforces a rule: “Stop or mask the chain-of-thought before it hits Node B unless Node B has ‘clearance level 2’ or higher.” Mid-execution, a new regulation might arrive restricting certain data movements across state lines. The federation manager instructs the compute graph to insert an encryption node (or partial re-route) so that only aggregated results, not raw data, are shipped to a node in a different state. This approach provides fine-grained control over collaboration by encoding security and privacy constraints in the deontic overlay, ensuring no unapproved chain-of-thought or partial result is leaked. It enables dynamic compliance where changes in security posture or regulation can be integrated instantly, with the federated DCG reconfiguring the data-flow in real time. The system enables efficient chain-of-thought sharing where agents with the right clearances see the full chain-of-thought while others might receive redacted transformations or only final outputs. It provides scalability and robustness, allowing the system to run large, distributed computations across heterogeneous nodes while maintaining explicit control and monitoring from the federation manager. Combining the six example graph topologies as elements—physical, logical, control flow, process-flow, data-flow, and deontic—into the federated DCG resource aware orchestration model ensures end-to-end compliance, security, and adaptivity. This approach goes beyond mere static provisioning by enabling real-time insertion of special nodes, dynamic re-routing, and selective chain-of-thought sharing in alignment with each organization's requirements.

ALTO primarily focuses on streaming partial outputs from large language model (LLM) stages to subsequent pipeline stages (instead of waiting for a full generation), and aggregation-aware routing and distributed scheduling to ensure partial outputs from the same request flow to the same instance (when needed), while balancing load across multiple replicas. This is a strong approach to optimize throughput and reduce latency for “compound AI pipelines.” However, ALTO mostly deals with single-organization pipeline orchestration of LLM-based tasks, ignoring deeper security, compliance, or spatio-temporal constraints that might arise in real-world multi-organization or multi-agent scenarios. The system similarly streams partial outputs (akin to ALTO), but also introduces federated DCG with multiple, semi-autonomous DCGs that share tasks across organizational or geographic boundaries. The implementation allows for deontic overlays for real-time constraints on data usage, chain-of-thought sharing, spatio-temporal regulations, and agent-specific policies. This enables dynamic graph modification with the ability to insert specialized nodes or entire subgraphs mid-execution if constraints or data patterns change. The system supports multi-agent collaboration where different agents-some with restricted vantage points or different compliance rules-cooperate across pipeline stages while preserving privacy or economic constraints.

A scenario demonstrating the enhanced capabilities involves distributed federated DCG pipelines with real-time security constraints. Consider a pipeline that includes partial LLM outputs from Node A (healthcare domain) which must be masked or anonymized before sending to Node B (a finance partner). While ALTO's streaming would let Node B get partial tokens as soon as they're emitted, a federated DCG can insert an on-the-fly redaction node if a new policy disallows personal data from crossing an organizational boundary. The pipeline is updated mid-run, so partial tokens that might contain PII are sanitized or withheld based on deontic rules. ALTO does not natively handle mid-execution policy injection or the dynamic insertion of secure nodes to enforce partial chain-of-thought constraints. The Federation Manager herein coordinates multi-party tasks, ensuring each DCG node respects local regulations or role-based constraints. While ALTO typically uses a single centralized runtime for scheduling partial outputs among stage instances, the federation manager functions as an ALTO-like router plus a deontic logic engine. For instance, if partial output tokens suddenly reference regulated content (e.g., a patient's prescription data), the manager can re-route or forcibly mask these tokens. This real-time deontic enforcement surpasses ALTO's basic “aggregation-aware routing,” because we also integrate privacy or ethical rules that forbid certain data from traveling beyond certain nodes, or that require cryptographic transformations mid-stream. While ALTO streams tokens from one model stage to the next with aggregation ensuring continuity, the system supports partial or “filtered” Chain-of-Thought (CoT) handoffs in multi-agent or multi-step LLM scenarios. This includes full CoT to an internal trusted agent, redacted CoT for external or less-trusted collaborators, and no CoT if the policy states “agent must not see reasoning steps, only final summary.” In many real-time tasks (disaster response, location-based services, medical interventions), the spatio-temporal dimension drastically changes which partial results are valid or sharable. While ALTO primarily focuses on pipeline throughput, ignoring geospatial or time-based constraints, the system might store each partial chunk of text with a time stamp and location dimension. A rule might say “After T+15 minutes, all partial states must be purged,” or “If the agent is physically outside Region X, don't forward certain tokens.” Consider a complex “chatbot verification+location-based compliance” pipeline as an illustrative example. Stage 1 (LLM Chat) streams user question tokens. Stage 2 (Claim Extraction+Deontic Rule Check) processes claims where some may reveal sensitive medical info that must be masked for certain sub-stages. Stage 3 (Search Query Generation) generates streamed queries where each partial search query might embed regulated terms that cannot cross a national border. Stage 4 (Search+Re-rank) operates similar to ALTO's BM25 or colBERT stage, but includes a “geo-check node” that discards or transforms partial queries referencing restricted data.

This implementation surpasses ALTO because while we do all the partial streaming and concurrency that ALTO does, gaining throughput and low-latency benefits, this also enables a federated manager to detect if the user is in a region that does not permit certain cross-border data transmissions or sharing—modifying the pipeline mid-execution to route search queries through a local node or anonymize them for remote nodes in addition to or in lieu of canonical federated model and data set exchange or learning or similar (e.g. gossip-based, vertically or horizontally federated, or cross-silo federated).

In some embodiments, the system may leverage an optional approach similar to DroidSpeak—a technique that reuses partial layer outputs (e.g., KV-caches) across multiple fine-tuned Large Language Models (LLMs) derived from a common foundation model—to enhance efficiency in multi-agent or multi-model workflows. When combined with streaming-based orchestration (e.g., -like intermediate result streaming), the invention can dynamically route partial outputs from one or more specialized LLMs to subsequent nodes or sub-pipelines in the federated environment, all while enforcing deontic constraints (e.g., policy checks on how partial chain-of-thought or KV-caches can be shared). Context-sharing across fine-tuned LLMs: in multi-agent pipelines, multiple fine-tuned LLMs (e.g., “Baseline agent,” “Debugging agent,” “Validation agent,” etc.) often consume overlapping or identical contexts (e.g., shared conversation histories, code snippet corpora, or knowledge bases). Recomputing embeddings and key-value (KV) caches for each LLM on the same input can waste both compute and memory. To address this, some embodiments optionally implement a mechanism akin to DroidSpeak. One LLM's partial layer outputs (particularly the lower-level KV caches or embeddings that are minimally impacted by domain-specific fine-tuning) are shared with a second LLM in the same foundation family. The second LLM selectively recomputes only the more “critical” layers that diverge under fine-tuning—thereby reducing the full prefill overhead while preserving high accuracy. In parallel with partial KV-cache reuse, the invention supports real-time streaming of partial results—such as partial token outputs, partial summaries, or incremental embeddings. Instead of waiting for a full generation to complete, the system forwards partial tokens (or partial claims) to subsequent pipeline nodes. Dynamic resource coordination: with the federation manager's coordination, these partial streams can be routed to the next stage of computation (e.g., a specialized “Validation agent” or “Robotics planner agent”). If a circuit breaker triggers due to a deontic violation, the system can immediately halt or mask subsequent partial tokens or KV-caches. Policy checks for shared caches: Each time an LLM attempts to reuse KV caches from a sibling or baseline model, the system consults the deontic reasoning subsystem to confirm it is permissible to share context embeddings at that granularity. For instance, certain personal data or code segments might be restricted to higher-clearance models, preventing naive KV reuse. Obligations and permissions: if an obligation states that “Agent A must not process data from Domain B unless flagged by Expert,” the system dynamically withholds partial layer outputs or triggers a “DroidSpeak Recompute Path” for the receiving model. This ensures compliance with domain-level constraints even when reusing intermediate states. The optional DroidSpeak embodiment identifies “critical layers” that are more sensitive to fine-tuning changes; only those layers are recomputed, while the rest of the KV caches can be reused from the baseline model's output. The invention may also combine small-scale summarization with lazy expansions, so only partial subgraphs or chunked expansions are reloaded, further reducing overhead. In other scenarios, an LLM can revert to full prefill if the partial reuse is disallowed by a new or emergent policy constraint. Since partial tokens arrive continuously (as in-like systems), the invention can detect policy violations or high risk-scores mid-generation. Upon detection, the pipeline injects a circuit-breaker node, halting further partial token flows. If the chain-of-thought or KV-cache in question is flagged, the system may revert to recomputing from an earlier “safe checkpoint,” ignoring the invalid partial layer outputs or imposing anonymization measures. This ensures real-time compliance while leveraging the benefits of partial caching. Latency and throughput gains: By skipping full context re-processing, the system can reduce the prefill latency for each specialized agent by up to 2-3× (depending on how many layers are reused). In high-throughput or multi-tenant environments, this translates to significantly improved system concurrency. Memory footprint: fewer duplicate caches are stored across nodes, thus cutting memory overhead. The invention optionally includes caching compression or ephemeral offloading to further optimize memory usage while meeting deontic constraints (for instance, private data might require ephemeral in-memory storage with short time-to-live). Common foundation model: DroidSpeak-based KV-cache sharing is most effective when the specialized LLMs share a single underlying foundation. However, the system may also support partial cross-model alignment for certain near-related architectures, subject to performance disclaimers and policy constraints. Selective activation: administrators or the federation manager can disable or limit these KV reuse strategies if a new policy arises (e.g., new privacy regulations). In this scenario, the system reverts to a more standard “each LLM does a full prefill” approach to ensure compliance. By coupling DroidSpeak-inspired KV-cache sharing with intermediate result streaming in a federated multi-agent environment, the invention provides both computational efficiency (through partial recomputes) and policy-aware real-time control (through on-the-fly circuit breakers and deontic checks). This flexibility allows enterprises to scale multi-model workflows without incurring exponential overhead, preserving the higher accuracy of specialized LLMs and preventing unauthorized disclosure of sensitive partial embeddings or chain-of-thought data.

According to a preferred embodiment, the system may leverage an optional approach similar to DroidSpeak—a technique that reuses partial layer outputs (e.g., KV-caches) across multiple fine-tuned Large Language Models (LLMs) derived from a common foundation model—to enhance efficiency in multi-agent or multi-model workflows. When combined with streaming-based orchestration, the invention can dynamically route partial outputs from one or more specialized LLMs to subsequent nodes or sub-pipelines in the federated environment, while enforcing deontic constraints (e.g., policy checks on how partial chain-of-thought or KV-caches can be shared). In multi-agent pipelines, multiple fine-tuned LLMs (e.g., “Baseline Agent,” “Debugging Agent,” “Validation Agent”) often consume overlapping or identical contexts (e.g., shared conversation histories, code snippet corpora, or knowledge bases). Recomputing embeddings and key-value (KV) caches for each LLM on the same input can waste both compute and memory. To address this, some embodiments optionally implement a mechanism akin to DroidSpeak. One LLM's partial layer outputs (particularly the lower-level KV caches or embeddings that are minimally impacted by domain-specific fine-tuning) are shared with a second LLM in the same foundation family. The second LLM selectively recomputes only the more “critical” layers that diverge under fine-tuning, thereby reducing the full prefill overhead while preserving high accuracy.

In parallel with partial KV-cache reuse, the invention supports real-time streaming of partial results—such as partial token outputs, partial summaries, or incremental embeddings. Instead of waiting for a full generation to complete, the system forwards partial tokens (or partial claims) to subsequent pipeline nodes. Through the federation manager's coordination, these partial streams can be routed to the next stage of computation (e.g., a specialized “Validation Agent” or “Robotics Planner Agent”). If a circuit breaker triggers due to a deontic violation, the system can immediately halt or mask subsequent partial tokens or KV-caches.

Each time an LLM attempts to reuse KV caches from a sibling or baseline model, the system consults the deontic reasoning subsystem to confirm it is permissible to share context embeddings at that granularity. For instance, certain personal data or code segments might be restricted to higher-clearance models, preventing naive KV reuse. If an obligation states that “Agent A must not process data from Domain B unless flagged by Expert,” the system dynamically withholds partial layer outputs or triggers a “DroidSpeak Recompute Path” for the receiving model. This ensures compliance with domain-level constraints even when reusing intermediate states.

The optional DroidSpeak embodiment identifies “critical layers” that are more sensitive to fine-tuning changes; only those layers are recomputed, while the rest of the KV caches can be reused from the baseline model's output. The invention may also combine small-scale summarization with lazy expansions, so only partial subgraphs or chunked expansions are reloaded, further reducing overhead. In other scenarios, an LLM can revert to full prefill if the partial reuse is disallowed by a new or emergent policy constraint. Since partial tokens arrive continuously, this embodiment can detect policy violations or high-risk scores mid-generation. Upon detection, the pipeline injects a circuit-breaker node, halting further partial token flows. If the chain-of-thought or KV-cache in question is flagged, the system may revert to recomputing from an earlier “safe checkpoint,” ignoring the invalid partial layer outputs or imposing anonymization measures. This ensures real-time compliance while leveraging the benefits of partial caching.

By skipping full context re-processing, the system can reduce the prefill latency for each specialized agent by up to 2-3× (depending on how many layers are reused). In high-throughput or multi-tenant environments, this translates to significantly improved system concurrency. Fewer duplicate caches are stored across nodes, thus cutting memory overhead. The embodiment optionally includes caching compression or ephemeral offloading to further optimize memory usage while meeting deontic constraints (for instance, private data might require ephemeral in-memory storage with short time-to-live).

DroidSpeak-based KV-cache sharing is most effective when the specialized LLMs share a single underlying foundation. However, the system may also support partial cross-model alignment for certain near-related architectures, subject to performance disclaimers and policy constraints. Administrators or the federation manager can disable or limit these KV reuse strategies if a new policy arises (e.g., new privacy regulations). In this scenario, the system reverts to a more standard “each LLM does a full prefill” approach to ensure compliance.

By coupling DroidSpeak-inspired KV-cache sharing with intermediate result streaming in a federated multi-agent environment, the embodiment provides both computational efficiency (through partial recomputes) and policy-aware real-time control (through on-the-fly circuit breakers and deontic checks). This flexibility allows enterprises to scale multi-model workflows without incurring exponential overhead, preserving the higher accuracy of specialized LLMs and preventing unauthorized disclosure of sensitive partial embeddings or chain-of-thought data.

In summary, while ALTO is a pioneering system for partial-output streaming within a single pipeline, this goes further in multi-domain federation by orchestrating partial-output streaming across multiple autonomous DCGs with potentially conflicting or dynamic policies. The implementation for deontic overlays for real-time constraints, enforcing obligations, prohibitions, or permissions in mid-stream. This addresses compliance or ethical rules not just for final outputs, but also for ephemeral intermediate states. The hierarchical and role-based chain-of-thought allows some pipeline stages to see full CoT while others see only summarized or redacted partial tokens. The system ensures correct partial aggregation for valid agents, while restricting or masking partial data for unapproved agents. It is incorporated with spatio-temporal and economic dimensions by integrating location-based or time-based rules into the pipeline, thus gating partial token flows based on dynamic conditions (time limits, distance constraints, cost thresholds). Through dynamic graph modification, the pipeline can be updated during execution if new constraints appear or if the data changes. This might include injecting encryption or masking nodes, or splitting partial outputs among multiple new sub-pipelines, something ALTO does not fully address. By merging ALTO-like partial streaming and load balancing with advanced federated DCG capabilities—real-time deontic overlays, secure chain-of-thought transformations, multi-agent role-based rules, and spatio-temporal constraints—this is a truly flexible system for orchestrating partial results in complex, multi-party AI pipelines. This approach retains ALTO's performance benefits (low latency, high throughput from streaming partial outputs) but extends it with crucial compliance, security, and context-awareness features that ALTO alone does not support—particularly in federated or multi-domain contexts where dynamic rules or spatio-temporal overlays are central to each pipeline stage's intermediate results.

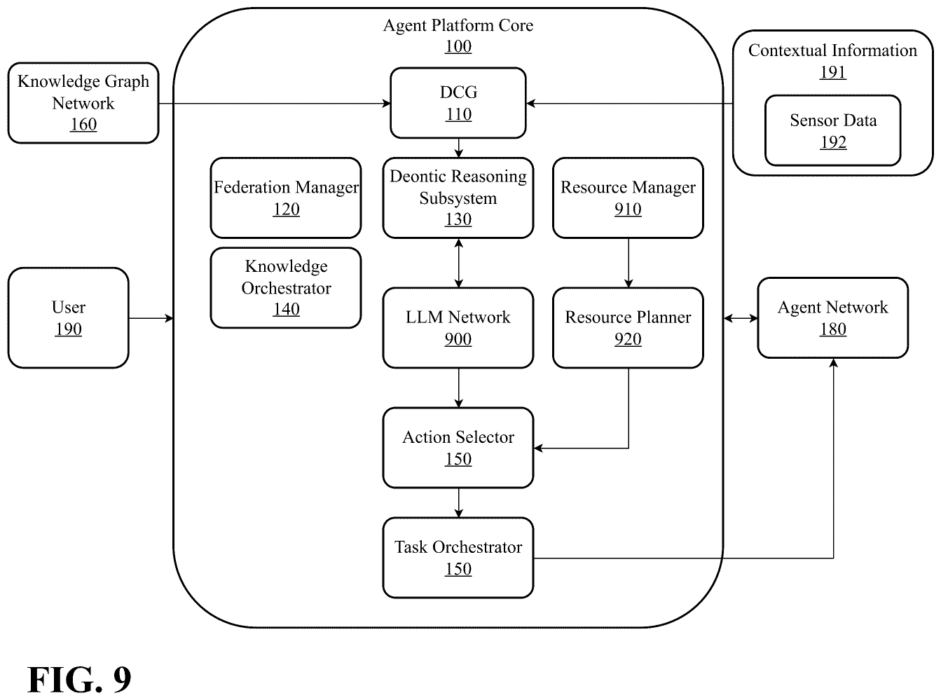

FIG. 9 is a block diagram illustrating an exemplary component of a system for an AI agent decision platform with deontic reasoning and an integrated LLM network capable of managing resources. In one embodiment, agent platform core 100 incorporates an LLM network 900 that interfaces directly with the deontic reasoning subsystem 130. This integration enables the system to leverage the pattern recognition and natural language understanding capabilities of LLMs while ensuring all outputs comply with defined obligations, permissions, and prohibitions. The LLM network 900 implements specialized models for different aspects of reasoning, including but not limited to task decomposition, ethical reasoning, and context integration, each operating within the system's deontic constraints.

A resource management framework, comprising the resource manager 910 and resource planner 920 provide resource and ethics tradeoff management, considering both computational efficiency and ethical implications when allocating system resources. For example, in a medical emergency scenario, the resource planner might prioritize diagnostic processes while ensuring sufficient resources remain available for maintaining ethical guardrails and safety protocols.

The system processes inputs from multiple sources, including but not limited to user 190 interactions, contextual information 191, and sensor data 192, through the DCG 110 architecture. The federation manager 120 coordinates these inputs while the knowledge orchestrator 140 maintains semantic consistency across the knowledge graph network 160. This multi-modal input processing enables the system to maintain comprehensive situational awareness while adapting its resource allocation and decision-making strategies accordingly.

An action selector 150 implements decision-making algorithms that combine LLM-generated recommendations with deontic constraints and resource availability considerations. This component may employ quantum-inspired token space operations to evaluate potential actions efficiently while maintaining ethical compliance. Task orchestrator 150 then coordinates with agent network 180 to execute selected actions, ensuring that all operations remain within the system's ethical and operational boundaries.

This architecture demonstrates how advanced language models can be integrated into a deontic reasoning framework while maintaining strict ethical guidelines and efficient resource utilization. The system's ability to balance computational resources, ethical considerations, and operational requirements enables sophisticated decision-making across diverse application domains while ensuring consistent alignment with defined moral and operational constraints.

In one embodiment, the system may include a multi-agent responsibility arbitration mechanism that dynamically manages task allocation between human and non-human agents. This mechanism may operate within the agent network 180, utilizing the task orchestrator 150 and task optimizer 720 to continuously evaluate and adjust agent responsibilities based on real-time capabilities, resource availability, and operational constraints. The arbitration system may enable negotiation-based task redistribution, where agents can propose and accept task reallocations while maintaining compliance with stored deontic constraints.

In another embodiment, the system may implement causal dependency mapping capabilities that enhance the knowledge graph network 160 with explicit encoding of cause-effect relationships between human and machine agent actions. This enhancement may enable the platform to predict and optimize downstream effects of agent actions, particularly in collaborative scenarios. The observer agent 810 may leverage these causal maps to monitor and adjust task execution based on predicted impacts across the agent network.

According to another embodiment, the system may include a trust calibration subsystem operating within the deontic reasoning subsystem 130, implementing feedback loops that dynamically adjust system behavior based on human trust levels. This subsystem may work in conjunction with the experience curation engine to modify explanation detail levels and confidence thresholds based on observed user interactions and explicit feedback. The trust calibration mechanism may maintain compliance with deontic constraints while adapting to individual user needs and preferences.

In one embodiment, the system may incorporate personalized norm adaptation through specialized knowledge graphs within the knowledge graph network 160. These graphs may capture individual user preferences and routines while maintaining alignment with overarching deontic constraints stored in the rules database 170. The adaptation mechanism may enable the system to learn and apply user-specific norms while ensuring compliance with fundamental obligations and prohibitions.

According to another embodiment, the system may include an interactive scenario simulation component that enhances the platform's planning capabilities by enabling collaborative pre-execution testing of complex tasks. This component may interface with the deontic reasoning subsystem 130 to validate proposed actions against stored constraints while allowing human agents to participate in scenario refinement through the human agent interface 700. The simulation component may generate detailed analytics about potential risks, inefficiencies, and conflicts, enabling iterative improvement of task plans before execution.

In another embodiment, the system may implement a layered ethical prioritization framework within the deontic reasoning subsystem 130 that dynamically weighs ethical considerations against operational objectives. This framework may enable sophisticated ethical decision-making by incorporating situation-specific factors while maintaining compliance with fundamental deontic constraints. The prioritization system may include dynamic re-evaluation triggers that adjust ethical weightings based on changing mission conditions or emerging constraints.

In one embodiment, the system may include a context-aware conversational memory system that enhances the platform's interaction capabilities by maintaining detailed interaction histories within the agent memory 830. This system may enable agents to track and reference past interactions, preferences, and context-specific details across multiple sessions. The memory system may interface with the knowledge orchestrator 140 to ensure that historical context informs ongoing agent decisions and interactions while maintaining compliance with privacy-related deontic constraints.

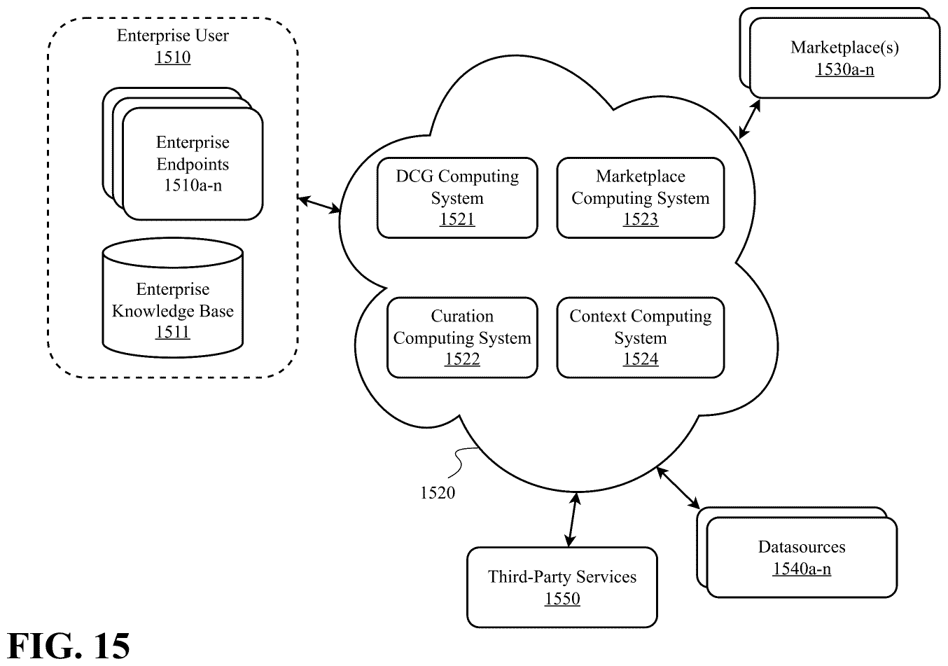

FIG. 15 is a block diagram illustrating an exemplary system architecture for a distributed generative artificial intelligence reasoning and action platform 1520, according to an embodiment. According to the embodiment, platform 1520 is configured as a cloud-based computing platform comprising various system or sub-system components configured to provide functionality directed to the execution of neuro-symbolic generative AI reasoning and action. Exemplary platform systems can include a distributed computational graph (DCG) computing system 1521, a curation computing system 1522, a marketplace computing system 1523, and a context computing system 1524. In some embodiments, systems 1521-1524 may each be implemented as standalone software applications or as a services/microservices architecture which can be deployed (via platform 1520) to perform a specific task or functionality. In such an arrangement, services can communicate with each other over an appropriate network using lightweight protocols such as HTTP, gRPC, or message queues. This allows for asynchronous and decoupled communication between services. Services may be scaled independently based on demand, which allows for better resource utilization and improved performance. Services may be deployed using containerization technologies such as Docker and orchestrated using container orchestration platforms like Kubernetes. This allows for easier deployment and management of services.

The distributed generative AI reasoning and action platform 1520 can enable a more flexible approach to incorporating machine learning (ML) models into the future of the Internet and software applications; all facilitated by a DCG architecture capable of dynamically selecting, creating, and incorporating trained models with external data sources and marketplaces for data and algorithms.

According to the embodiment, DCG computing system 1521 provides orchestration of complex, user-defined workflows built upon a declarative framework which can allow an enterprise user 1510 to construct such workflows using modular components which can be arranged to suit the use case of the enterprise user. As a simple example, an enterprise user 1510 can create a workflow such that platform 1520 can extract, transform, and load enterprise-specific data to be used as contextual data for creating and training a ML or AI model. The DCG functionality can be extended such that an enterprise user can create a complex workflow directed to the creation, deployment, and ongoing refinement of a trained model (e.g., LLM). For example, in some embodiments, an enterprise user 1510 can select an algorithm from which to create the trained model, and what type of data and from what source they wish to use as training data. DCG computing system 1521 can take this information and automatically create the workflow, with all the requisite data pipelines, to enable the retrieval of the appropriate data from the appropriate data sources, the processing/preprocessing of the obtained data to be used as inputs into the selected algorithm(s), the training loop to iteratively train the selected algorithms including model validation and testing steps, deploying the trained model, and finally continuously refining the model over time to improve performance.

A context computing system 1524 is present and configured to receive, retrieve, or otherwise obtain a plurality of context data from various sources including, but not limited to, enterprise users 1510, marketplaces 1530a-n, third-party sources 1550, and other data sources 1540a-n. Context computing system 1524 may be configured to store obtained contextual data in a data store. For example, context data obtained from various enterprise endpoints 1510a-n of a first enterprise may be stored separately from the context data obtained from the endpoints of a second enterprise. In some embodiments, context data may be aggregated from multiple enterprises within the same industry and stored as a single corpus of contextual data. In such embodiments, contextual data may be transformed prior to processing and storage so as to protect any potential private information or enterprise-specific secret knowledge that the enterprise does not wish to share.

A curation computing system 1522 is present and configured to provide curated (or not) responses from a trained model (e.g., LLM) to received user queries. A curated response may indicate that it has been filtered, such as to remove personal identifying information or to remove extraneous information from the response, or it may indicate that the response has been augmented with additional context or information relevant to the user. In some embodiments, multiple trained models (e.g., LLMs) may each produce a response to a given prompt, which may include additional contextual data/elements, and a curation step may include selecting a single response of the multiple responses to send to a user, or the curation may involve curating the multiple responses into a single response. The curation of a response may be based on rules or policies that can set an individual user level, an enterprise level, or at a department level for enterprises with multiple departments (e.g., sales, marketing, research, product development, etc.).

According to the embodiment, an enterprise user 1510 may refer to a business organization or company. An enterprise may wish to incorporate a trained ML model into their business processes. An enterprise may comprise a plurality of enterprise endpoints 1510a-n which can include, but are not limited to, mobile devices, workstations, laptops, personal computers, servers, switches, routers, industrial equipment, gateways, smart wearables, Internet-of-Things (IoT) devices, sensors, and/or the like. An enterprise may engage with platform 1520 to create a trained model to integrate with its business processes via one or more enterprise endpoints. To facilitate the creation of purpose-built, trained models, enterprise user 1510 can provide a plurality of enterprise knowledge 1511 which can be leveraged to build enterprise specific (or even specific to certain departments within the enterprise) ML/AI models. Enterprise knowledge 1511 may refer to documents or other information important for the operation and success of an enterprise. Data from internal systems and databases, such as customer relationship management (CRM) systems, enterprise resource planning (ERP) systems, rules and policies databases, and transactional databases, can provide information about the operational context of an enterprise. For example, product knowledge, market knowledge, industry trends, regulatory knowledge, business processes, customer knowledge, technology knowledge, financial knowledge, organization knowledge, and risk management knowledge may be included in enterprise knowledge base 1511.

According to the embodiment, platform 1520 is configured to retrieve, receive, or otherwise obtain a plurality of data from various sources. A plurality of marketplaces 1530a-n may be present and configured to provide centralized repositories for data, algorithms, and expert judgment, which can be purchased, sold, or traded on an open marketplace. External data sourced from various marketplaces 1530a-n can be used as a training data source for creating trained models for a particular use case. A marketplace computing system 1523 is present and configured to develop and integrate various marketplaces 1530a-n. Marketplace computing system 1523 can provide functionality directed to the registration of experts or entities. An expert may be someone who has a deep understanding and knowledge of a specific industry, including its trends, challenges, technologies, regulations, and best practices. Industry experts often have many years of experience working in the industry and have developed a reputation for their expertise and insights. Examples of experts can include, but are not limited to, consultants, analysts, researchers, academics, or professionals working in the industry. In some embodiments, experts and/or entities can register with platform 1520 so that they may become verified experts/entities. In such an embodiment, an expert/entity profile may be created which can provide information about expert judgment, scored data and algorithms, and comparisons/statistics about the expert's/entity's scores and judgment with respect to other expert/entities. Marketplace computing system 1523 may further provide functionality directed to the management of the various marketplaces and the data/algorithms provided therein.

According to some embodiments, platform 1520 can communicate with and obtain data from various third-party services 1550. For example, third-party services can include LLM services such as APIs and LLM hosting platforms, which platform 1520 can interface with to obtain algorithms or models to use as starting points for training a neuro-symbolic generative AI reasoning and action model to be deployed at the enterprise or individual level. As another example, social media platforms can provide data about trends, events, and public sentiment, which can be useful for understanding the social context of a situation. Exemplary data sources 1540a-n can include, but are not limited to, sensors, web data, environmental data, and survey and interviews.

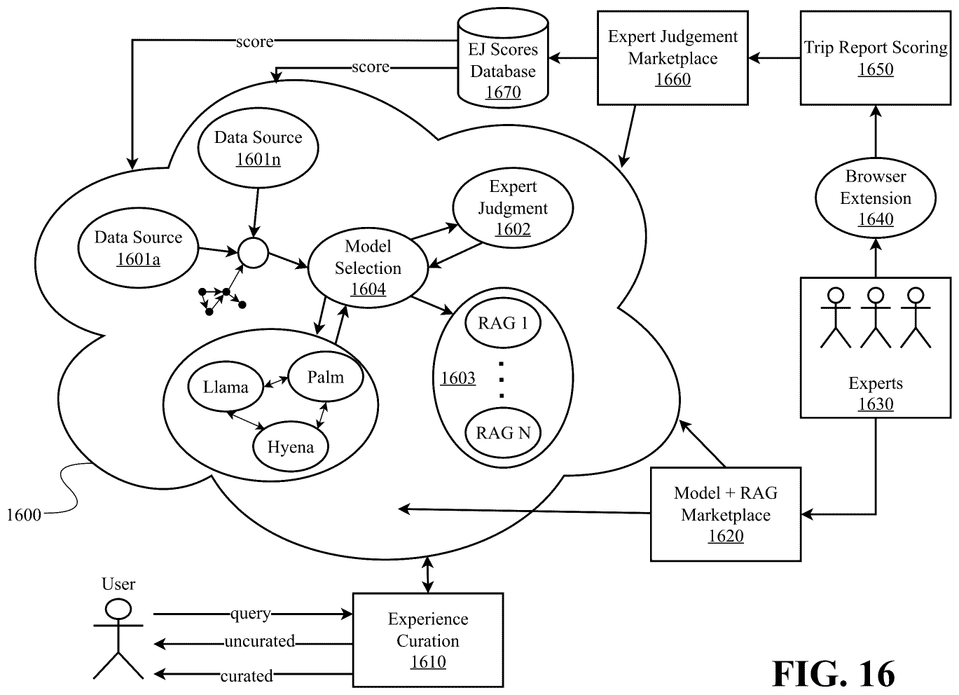

FIG. 16 is a block diagram illustrating an exemplary aspect of a distributed generative AI reasoning and action platform incorporating various additional contextual data. According to the aspect, a plurality of contextual data from various data sources may be integrated into platform 1520. A simple exemplary directed computational graph 1600 is illustrated within the cloud and utilizing the plurality of contextual data to create and train a model. Various marketplaces 1530a-n are shown which can provide contextual data to platform 1520 including an expert judgment marketplace 1660 and a model and retrieval augmented generation (RAG) marketplace 1620. According to the aspect, DCG 1600 orchestrates model (and model weight) selection 1604, including multi-model usage in series or parallel (i.e., feed output of one model into another, or compare and choose outputs across multiple models), based on multiple data sources (both trained and external), input from crowdsourced expert judgment, training or tuning data set corpora, and RAG libraries.

Expert judgment will become increasingly important in the world of proprietary or otherwise blackbox ML or AI models where hallucinations and training data quality may produce misleading or otherwise incorrect results. The expert judgment marketplace 1660 provides a way for experts 1630 to weigh-in on the correctness of data whether that is training data or model output, and can be facilitated by a browser extension 1640, for example, to score things like data sources during their daily “trip around web”. This trip report scoring 1650 concept allows experts to score data sources. In an implementation, a browser extension 1640 is developed with an accuracy score input where the user can rank a news article they are reading as they consume it. Expert judgment marketplace 1660 allows for consumers to pick and rank “experts” based on how well their judgment helps or hinders their overall consumption of model output. For example, experts that routinely highly rank data sources, like news sites, that are known to spread false information should likewise be less trusted over time compared to their peers, and any models trained on that data similarly less trusted. Ultimately a database 1670 of data sources and schemas scored by algorithms or experts could be used as input into the DCG 1600 for more accurate and real-time inference based on ongoing rating of preferred data set and data format combinations (e.g. the same data might be purchased in unstructured, structured, schematized, normalized, or semantified formats) which may introduce different types of bias or impacts on performance, results, or processing costs.

Accordingly, a RAG marketplace 1620 may be implemented to further refine model output. RAG input information may be included as additional context which can be supplied to a GenAI model in addition to a prompt (engineered, or otherwise). Marketplace 1620 may be global or local to a given device or system since they might cache resources locally for on demand purchase or execution. This is especially important where companies may want to sell access to their proprietary dataset through the form of input to a RAG. For example, a medical research company may have valuable information they could sell to other institutions in the form of the output of their dataset fed to a RAG to augment related research without specifically providing access to the raw training data. Retrieval-augmented generation is a framework that combines elements of retrieval-based and generative models to improve the performance of natural language processing tasks. In RAG, a retriever component is used to select relevant information from a large corpus, and a generator component is used to produce a final output based on both the retrieved information and the input query. RAG marketplace 1620 may be scored by experts for accuracy and effectiveness across domains. The owner of these datasets may also further protect raw data access while also increasing retrieval accuracy by developing a set of models trained for each AI model that can allow retrieved data to be projected into a latent space capable of being fed into a specific AI model. This approach may leverage techniques such as autoencoders, Variational Autoencoders (VAEs), or adversarial training to create lower-dimensional representations that capture essential features while obscuring raw data. These latent representations can be tailored to specific AI tasks, providing just enough information for the model to perform effectively without exposing unnecessary details. This latent representation of data would prevent the user from reversing it back to raw data, while also being designed to efficiently inform the selected AI model. Furthermore, by applying dimensionality reduction techniques like t-SNE or UMAP, and incorporating differential privacy methods, in some cases the system can offer formal privacy guarantees while maintaining data utility. This strategy allows for a balance between protecting sensitive information and enabling high-performance AI applications, as each latent space can be optimized for its intended use case while minimizing the risk of data reconstruction.

According to the aspect, a user experience curation engine 1610 is needed that is able to curate output whether that is in the form of filtering out sensitive data or simply customizing results in a way the user prefers (which may be based on user-/entity-defined rules or policies). A user can submit a query to experience curation engine 1610 which can send the query to the DCG trained model to obtain a response. Experience curation 1610 may then process the received response to curate it (or not) to meet the preferences of the user.

As illustrated, DCG 1600 shows a simple example of a directed computational graph which can be used to create a complex workflow to create and train an MI/AI model (e.g., variations of or standard transformer architecture). A shown, the DCG comprises multiple sources of information for training the selected models(s) including multiple data sources 1601a-n which may or may not be scored by experts, expert judgment 1602, and one or more RAGs 1603 which may be obtained from RAG marketplace 1620 or may be obtained directly from enterprise knowledge. DCG may have access to stored models or variants thereof. In the illustration, LLAMA (Learned Layer-wise Attention Metric for Transformers), PALM (Permuted Adaptive Lateral Modulation), and HYENA (Hyperbolic Encoder for Efficient Attention) are shown as possible examples of the types of models which can be selected by the DCG to create and train a GenAI model. Furthermore, the “model parameters” and mathematical techniques or assumptions used in each model may be cataloged and included in a model-specific template which may be stored in cloud-based storage on platform 1520. In some embodiments, platform 1520 may store a hierarchical representation of transformer models (e.g., as a graph), which may represent a lineage of the evolution of transformer models. In an implementation, model selection or exploration involves selections based on the evolutionary tree of one or more model types and use said tree (e.g., graph) for selections in heuristic search for best algorithm/data combinations, licensing costs/explorations, etc. It should be appreciated that certain aspects of the invention may be tailored based on what kind of mathematical approach underpins a specific model.

In operation, DCG 1600 obtains the various contextual data from the connected data sources, creates training, validation, and test datasets from the obtained data, and uses the various datasets to train, validate, and test the model as it undergoes a model training loop that iteratively trains the model to generate responses based on the plurality of contextual data.

The multi-layered Knowledge Graph (KG) implements several node types including Entity Nodes, which represent real-world objects (e.g., users, devices, medical records) or abstract concepts (e.g., data types, tasks), and Deontic Nodes, which represent individual constraints “ObligationNode,” “PermissionNode,” “ProhibitionNode.” Each node stores metadata such as scope, priority, or assigned domain (e.g., medical, financial). Edge labels in the Knowledge Graph include “AppliesTo” which links a deontic node to an entity or data type node, “Overrides or ConflictsWith” which encodes hierarchical or precedence relationships between constraints, and “TemporalValidity” which tracks time windows or conditions under which a constraint is active (e.g., “valid from January 2025 to December 2025”). Each node or edge can include a version identifier and a timestamp, with old versions remaining in the KG for audit purposes but deactivated, while new versions become active upon insertion. The Rules Database or “Deontic Store” implements relational-like tables including a “Constraints” table with columns for constraint_id, constraint_type (obligation/permission/prohibition), description, scope, priority, effective_date, expiration_date, etc., and a “Constraint_Overrides” table to store conflict resolution data detailing which constraints override which, with justification and update tracking. The system maintains an index or specialized B-tree on (scope, priority, effective_date) to quickly look up relevant constraints in real time, and another index for (constraint_type, domain_tag) to group constraints by domain. The Deontic “Schema” or Ontology includes constraint categories like “Privacy,” “Safety,” “Legal,” “Ethical,” each of which might be a sub-ontology specifying standard keys or relationships. The Deontic Reasoning Subsystem (DRS) includes an inference engine that compiles each new or updated constraint into an internal logic representation or specialized “constraint-check” function. This inference engine runs whenever tasks or data transitions occur—e.g., mid-task if an agent requests a new action. The system can register callbacks or “listeners” on key events (e.g., “agent X tries to access data Y,”) “machine node tries to run transformation Z”). When triggered, these events cause the DRS to fetch relevant constraints from the knowledge graph or rules DB. Each multi-step task or pipeline phase can define “compliance checkpoints”—the system halts or pauses the task at these points and invokes the DRS to confirm no constraints are being violated. Each agent's workflow is represented as a state machine, where transitions between states only occur if the DRS “greenlights” them. If a constraint fails, the state machine goes to a “blocked” or “escalation required” state. For conflict resolution, if two constraints clash (e.g., “Data must be disclosed in emergencies” vs. “Data must never be disclosed without consent”), the DRS references an Overrides or Precedence relationship. If the system cannot automatically decide which constraint to follow (equal priority?), it triggers a “human-in-the-loop override” or “multi-agent debate,” requiring explicit resolution. Once resolved, the DRS logs the override or new precedence rule back into the knowledge graph or rules DB, so future tasks see that resolution without re-litigating the same conflict. The constraint lifecycle management includes states such as Draft/Pending (a new constraint might first appear in “draft” mode, visible to administrators but not enforced), Active (once approved or once the effective_date is reached), and Retired/Archived (after the expiration date or if an updated version replaces it). For hot swapping rules in a distributed system, new constraint versions can be “migrated” into the knowledge graph or rules DB using an atomic transaction. Agents see the new constraint as soon as it commits. Agents that cache constraints must check if the constraints have changed mid-task. If so, they must re-validate. In heavily regulated domains (e.g., finance, healthcare), new rules or clarifications appear often.

The system implements a “continuous integration pipeline” that automatically ingests external regulatory updates, merges them into the knowledge graph, and triggers an internal test suite to ensure no contradictory or impossible rules break the system. In some cases, indefinite evaluations, such as potential nonexecutable rules, potential for model nonresponse or nonsensical response, or potential pipeline infinite cycle (e.g. in directed graph with cycles specified that could fail during a prior DAG generation or linearization process or an implicit execution specified variant that might become trapped in an infinite loop a la the halting problem) might be executed conditionally with a supervisor circuit breaker added to the system (e.g. limit number of executions before killing thread, process, or job) or system may take an action like transpilation (e.g. transpile a datalog rule into a dyadic existential rule variant that will return a result-whether provably so via formal methods or via a probabilistic representation based on a model, principle theorem or historical record such as execution traces of past attempts). A typical runtime enforcement flow for on-the-fly access checks involves multiple steps: First, an AI agent requests to read a piece of personal data. The system calls the DRS, passing (agent_id, data_id, action=read, context=medical). The DRS queries the rules DB for constraints relevant to (medical data, read operations, agent's role). If a prohibition is found (e.g., “HIPAA: must not access personal data unless authorized”), the system checks if the agent has the required “permission node.” If there's a mismatch, the DRS denies the request and the agent receives a “forbidden” response. Otherwise, the DRS logs the compliance rationale and returns an “OK.” In cases where conflicts are detected mid-process, consider a situation where a pipeline is halfway through analyzing user data for a recommendation when a new regulation takes effect stating “All data older than 5 years is restricted.” The knowledge graph updates, adding a new ProhibitionNode with effective_date=now( ). When the pipeline hits a compliance checkpoint and sees that some data it uses is 7 years old, it must either discard or anonymize that old data. Each agent (human or machine) is assigned a “compliance level” or “role.” The DRS references a “Role-to-Constraint” mapping. For instance, doctors might have certain obligations or permissions that nurses don't. If an agent's role changes or if that agent obtains new certifications, the system updates the agent's record. Next time the DRS checks constraints, the agent's expanded permissions are recognized. For performance optimization in high-throughput systems, caching certain frequent lookups can speed up real-time enforcement. For example, “Is user #123 allowed to do X with data Y?” might be a frequent question. The system uses short-lifetime caches with invalidation triggers if constraints change. In large-scale deployments, constraints are partitioned by domain or region. The DRS can do a local shard lookup to reduce overhead. Multiple subtasks might run concurrent checks. By hooking into the pipeline orchestrator, we can evaluate each subtask's constraints in parallel, only blocking tasks that conflict. Every time a constraint is enforced, the system logs timestamp, constraint_id, agent_id, action_attempted, result (allowed/denied), and rationale. This log is stored for compliance or later analysis. The system provides an explanation mechanism that can detail why a certain constraint triggered a denial or requirement, such as “this action is disallowed because it tries to modify patient data without consent under HIPAA rule #12.” The system can run in “test mode” or “simulation mode” where updated rules are tested on recorded workloads to see if tasks break or yield undesired rejections.

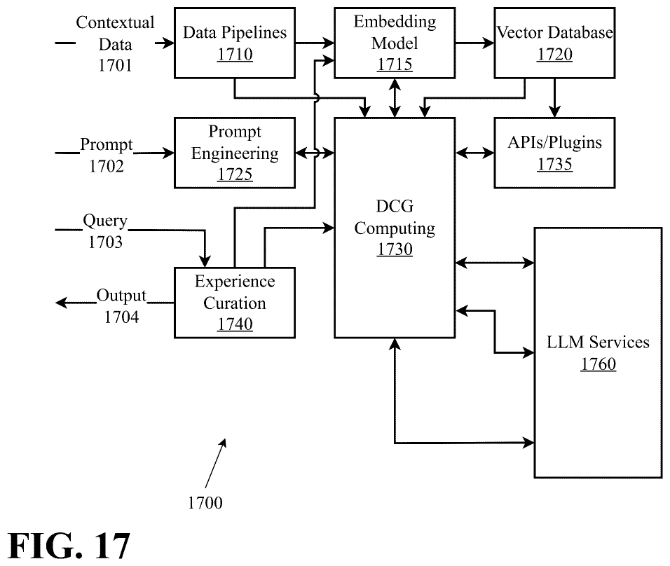

FIG. 17 is a diagram illustrating incorporating symbolic reasoning in support of LLM-based generative AI, according to an aspect of a neuro-symbolic generative AI reasoning and action platform. According to the aspect, platform 1520 can incorporate symbolic reasoning and in-context learning to create and train off the shelf models (e.g., an LLM foundational model or narrow model) through clever prompting and conditioning on private data or very situation specific “contextual” data. Platform 1520 can obtain contextual data 1701 and preprocess the data for storage. Contextual data 1701 may refer to data obtained from marketplaces 1530a-n, third-party services 1550, and enterprise knowledge 1511, as well as other types of contextual data that may be obtained from other sources. DCG 1730 is responsible for orchestrating the entire process and can create data pipelines 1710 as needed to facilitate the ingestion of contextual data 1701. Contextual data can include text documents, PDFs, and even structure formats like CSV (comma-separated values) or SQL tables or other common generic data formats like OWL or RDF or domain specific content such as the Financial Industry Business Ontology (FIBO) or Open Graph of Information Technology (OGIT). This stage involves storing private data (e.g., context data) to be retrieved later.

Typically, the context data 1701 is broken into chunks, passed through and embedding model 315, then stored in a specialized database called a vector database 1720. Embedding models are a class of models used in many tasks such as natural language processing (NLP) to convert words, phrases, or documents into numerical representations (embeddings) that capture similarity which often correlates semantic meaning. Exemplary embedding models can include, but are not limited to, text-embedding-ada-002 model (i.e., OpenAI API), bidirectional encoder representations form transformers, Word2Vec, FastText, transformer-based models, and/or the like. The vector database 1715 is responsible for efficiently storing, comparing, and retrieving a large plurality of embeddings (i.e., vectors). Vector database 1715 may be any suitable vector database system known to those with skill in the art including, but not limited to, open source systems like Pinecone, Weaviate, Vespa, and Qdrant. According to the embodiment, embedding model 1715 may also receive a user query from experience curation 1740 and vectorize it where it may be stored in vector database 1720. This provides another useful datapoint to provide deeper context when comparing received queries against stored query embeddings.

In one embodiment, the AI agent decision platform is configured with a domain-specific ontology that encodes both standard operating procedures (SOPs) and regulatory texts relevant to the target application domain—e.g., medical, legal, or financial. This ontology is integrated into the platform's knowledge graph network, enabling a systematic approach to updating and enforcing obligations, permissions, and prohibitions as new regulations and guidelines emerge.

A specialized ontology builder component analyzes domain sources, such as statutory codes, clinical guidelines, and organizational SOPs, then maps each regulatory clause or best practice to corresponding deontic predicates in the knowledge graph. For example, in a healthcare setting, regulatory clauses on patient confidentiality become explicit prohibitions (e.g., “must not disclose identifiable patient data to unauthorized agents”), while mandatory infection control policies become obligations (e.g., “must perform sterilization procedures before every surgery”). Each concept within the domain ontology (e.g., “Patient Privacy,” “Prescription Drug Guidelines,” “Data Sharing Agreement”) is tagged with semantic labels that reflect not only hierarchical and relational information (e.g., parent-child, cause-effect, domain-specific classification) but also the deontic status of each relevant rule.

The knowledge graph thus contains edges labeled with “required,” “allowed,” or “forbidden,” linking specific procedures or tasks to the relevant norms and regulations. This labeling is synchronized with the knowledge orchestrator, ensuring that any domain-specific update instantly propagates through the rest of the system. The platform includes an ontology update manager that monitors regulatory bulletins or organizational policy announcements. When a new policy text arrives—such as an amendment to a medical code or a novel legal statute—the ontology update manager parses the text, extracts the relevant sections, and dynamically adjusts the ontology structure (e.g., inserting new nodes, deprecating old regulations). For instance, if new privacy protocols mandate anonymization thresholds, the manager creates or updates a rule node labeled as “new privacy restriction,” automatically re-linking any procedures that involve patient-data sharing to this updated prohibition or condition in the knowledge graph. The deontic reasoning subsystem consults this enriched ontology whenever an agent (human or machine) proposes an action. If the proposed action conflicts with a prohibition or lacks compliance with an obligation indicated in the updated ontology, the subsystem flags the violation, triggering a conflict resolution process or requiring escalation to a human agent for override decisions. This ensures live detection of regulatory non-compliance, even if the rule was only recently added or modified in the ontology. During execution of tasks, agents continuously reference the domain-specific ontology for guidance on permissible operations. If an agent is uncertain about a new rule or experiences a conflict, it can retrieve the relevant sections of the ontology (e.g., the text excerpt mapping to a specific code article) and provide a human-readable explanation—e.g., “This procedure must not proceed without explicit patient consent as per newly introduced privacy regulation Code Section 5.2.” Explainability is thus directly tied to the ontology's labeling of deontic constraints and is automatically updated to reflect the latest regulatory changes. By storing and updating domain-specific ontological elements in real time within the knowledge graph, the system ensures that all agent decisions remain aligned with evolving regulatory requirements.

A user may submit a query 1703 to an experience curation engine 1740 which starts the prompt construction and retrieval process. The query is sent to DCG 1730 which can send the query to various components such as prompt engineering 1725 and embedding model 1715. Embedding model 1715 receives the query and vectorizes it and stores it in vector database 1720. The vector database 1720 can send contextual data (via vectors) to DCG 1730 and to various APIs/plugins 1735. Prompt engineering 1725 can receive prompts 1702 from developers to train the model on. These can include some sample outputs such as in few-shot prompting. The addition of prompts via prompt engineering 1725 is designed to ground model responses in some source of truth and provide external context the model wasn't trained on. Other examples of prompt engineering that may be implemented in various embodiments include, but are not limited to, chain-of-thought, self-consistency, generated knowledge, tree of thoughts, directional stimulus, and/or the like.

During a prompt execution process, experience curation 1740 can send a user query to DCG 1730 which can orchestrate the retrieval of context and a response. Using its declarative roots, DCG 1730 can abstract away many of the details of prompt chaining; interfacing with external APIs 1735 (including determining when an API call is needed); retrieving contextual data from vector databases 1730; and maintaining memory across multiple LLM calls. The DCG output may be a prompt, or series of prompts, to submit to a language model via LLM services 1760 (which may be potentially prompt tuned). In turn, the LLM processes the prompts, contextual data, and user query to generate a contextually aware response which can be sent to experience curation 1740 where the response may be curated, or not, and returned to the user as output 1704.

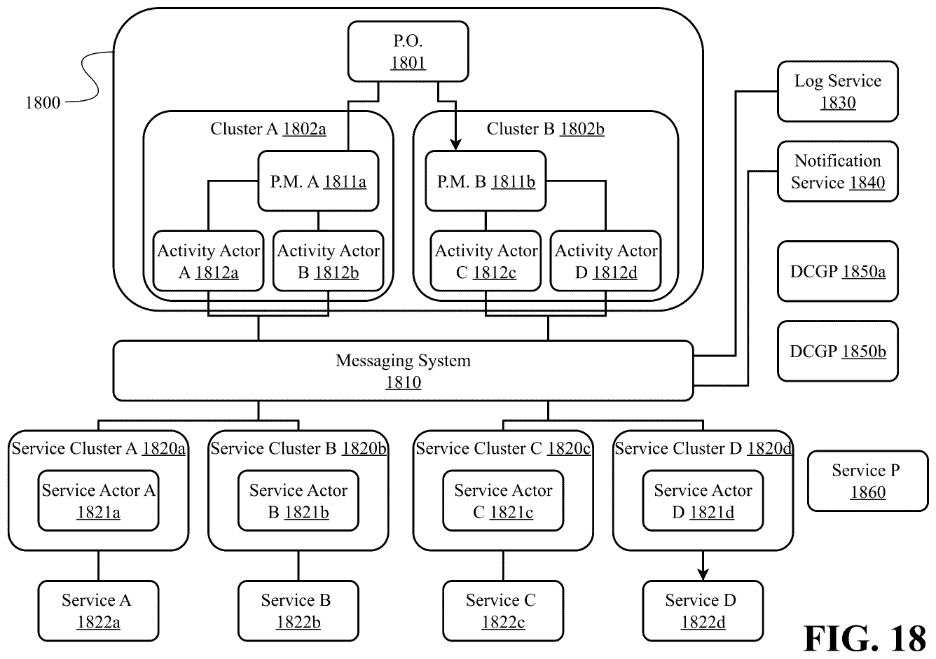

FIG. 18 is a diagram of an exemplary architecture for a system for rapid predictive analysis of very large data sets using an actor-driven distributed computational graph 1800, according to one aspect. According to the aspect, a DCG 1800 may comprise a pipeline orchestrator 1801 that may be used to perform a variety of data transformation functions on data within a processing pipeline, and may be used with a messaging system 1810 that enables communication with any number of various services and protocols, relaying messages and translating them as needed into protocol-specific API system calls for interoperability with external systems (rather than requiring a particular protocol or service to be integrated into a DCG 1800).

Pipeline orchestrator 1801 may spawn a plurality of child pipeline clusters 1802a-b, which may be used as dedicated workers for streamlining parallel processing. In some arrangements, an entire data processing pipeline may be passed to a child cluster 1802a for handling, rather than individual processing tasks, enabling each child cluster 1802a-b to handle an entire data pipeline in a dedicated fashion to maintain isolated processing of different pipelines using different cluster nodes 1802a-b. Pipeline orchestrator 1801 may provide a software API for starting, stopping, submitting, or saving pipelines. When a pipeline is started, pipeline orchestrator 1801 may send the pipeline information to an available worker node 1802a-b, for example using AKKA™ clustering. For each pipeline initialized by pipeline orchestrator 1801, a reporting object with status information may be maintained. Streaming activities may report the last time an event was processed, and the number of events processed. Batch activities may report status messages as they occur. Pipeline orchestrator 1801 may perform batch caching using, for example, an IGFS™ caching filesystem. This allows activities 1812a-d within a pipeline 1802a-b to pass data contexts to one another, with any necessary parameter configurations.

A pipeline manager 1811a-b may be spawned for every now running pipeline, and may be used to send activity, status, lifecycle, and event count information to the pipeline orchestrator 1801. Within a particular pipeline, a plurality of activity actors 1812a-d may be created by a pipeline manager 1811a-b to handle individual tasks, and provide output to data services 1822a-d. Data models used in a given pipeline may be determined by the specific pipeline and activities, as directed by a pipeline manager 1811a-b. Each pipeline manager 1811a-b controls and directs the operation of any activity actors 1812a-d spawned by it. A pipeline process may need to coordinate streaming data between tasks. For this, a pipeline manager 1811a-b may spawn service connectors to dynamically create TCP connections between activity instances 1812a-d. Data contexts may be maintained for each individual activity 1812a-d, and may be cached for provision to other activities 1812a-d as needed. A data context defines how an activity accesses information, and an activity 1812a-d may process data or simply forward it to a next step. Forwarding data between pipeline steps may route data through a streaming context or batch context.

A client service cluster 1830 may operate a plurality of service actors 1821a-d to serve the requests of activity actors 1812a-d, ideally maintaining enough service actors 1821a-d to support each activity per the service type. These may also be arranged within service clusters 1820a-d, in a manner similar to the logical organization of activity actors 1812a-d within clusters 1802a-b in a data pipeline. A logging service 1830 may be used to log and sample DCG requests and messages during operation while notification service 1840 may be used to receive alerts and other notifications during operation (for example to alert on errors, which may then be diagnosed by reviewing records from logging service 1830), and by being connected externally to messaging system 1810, logging and notification services can be added, removed, or modified during operation without impacting DCG 1800. A plurality of DCG protocols 1850a-b may be used to provide structured messaging between a DCG 1800 and messaging system 1810, or to enable messaging system 1810 to distribute DCG messages across service clusters 1820a-d as shown. A service protocol 1860 may be used to define service interactions so that a DCG 1800 may be modified without impacting service implementations. In this manner it can be appreciated that the overall structure of a system using an actor driven DCG 1800 operates in a modular fashion, enabling modification and substitution of various components without impacting other operations or requiring additional reconfiguration.

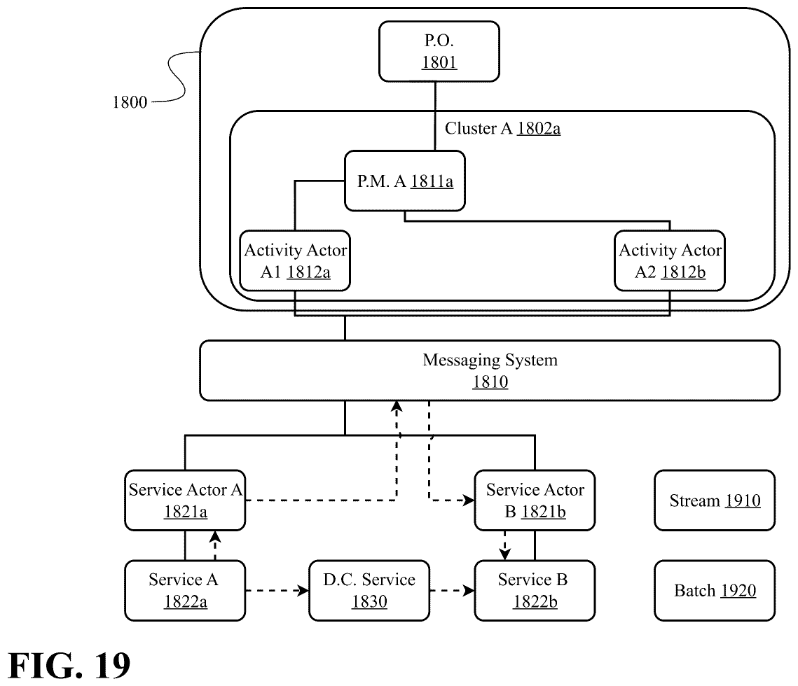

FIG. 19 is a diagram of an exemplary architecture for a system for rapid predictive analysis of very large data sets using an actor-driven distributed computational graph 1800, according to one aspect. According to the aspect, a variant messaging arrangement may utilize messaging system 1810 as a messaging broker using a streaming protocol 1910, transmitting and receiving messages immediately using messaging system 1810 as a message broker to bridge communication between service actors 1821a-b as needed. Alternately, individual services 1822a-b may communicate directly in a batch context 1920, using a data context service 1930 as a broker to batch-process and relay messages between services 1822a-b.

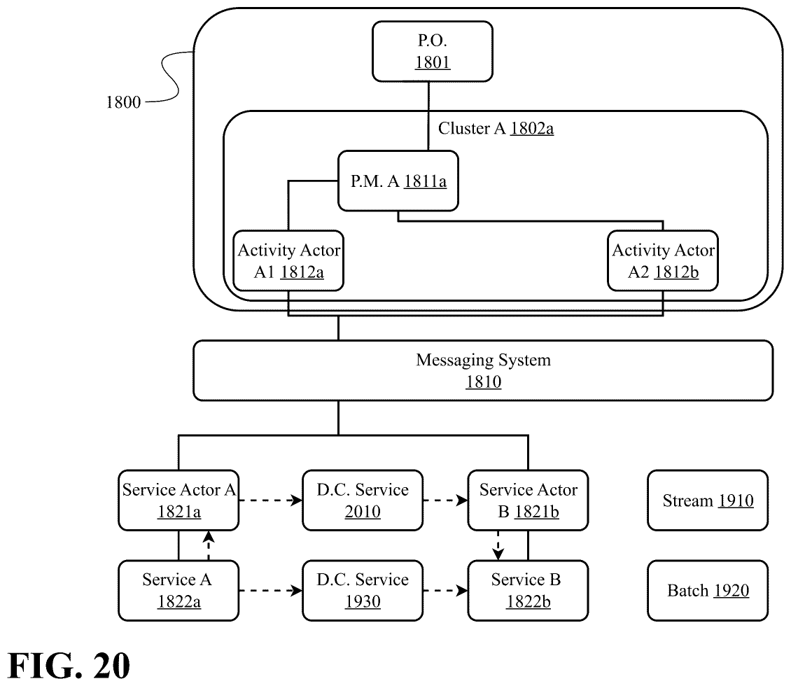

FIG. 20 is a diagram of an exemplary architecture for a system for rapid predictive analysis of very large data sets using an actor-driven distributed computational graph 1800, according to one aspect. According to the aspect, a variant messaging arrangement may utilize a service connector 2010 as a central message broker between a plurality of service actors 1821a-b, bridging messages in a streaming context 1910 while a data context service 1930 continues to provide direct peer-to-peer messaging between individual services 1822a-b in a batch context 1920.

It should be appreciated that various combinations and arrangements of the system variants described above may be possible, for example using one particular messaging arrangement for one data pipeline directed by a pipeline manager 1811a-b, while another pipeline may utilize a different messaging arrangement (or may not utilize messaging at all). In this manner, a single DCG 1800 and pipeline orchestrator 1801 may operate individual pipelines in the manner that is most suited to their particular needs, with dynamic arrangements being made possible through design modularity as described above in FIG. 18.

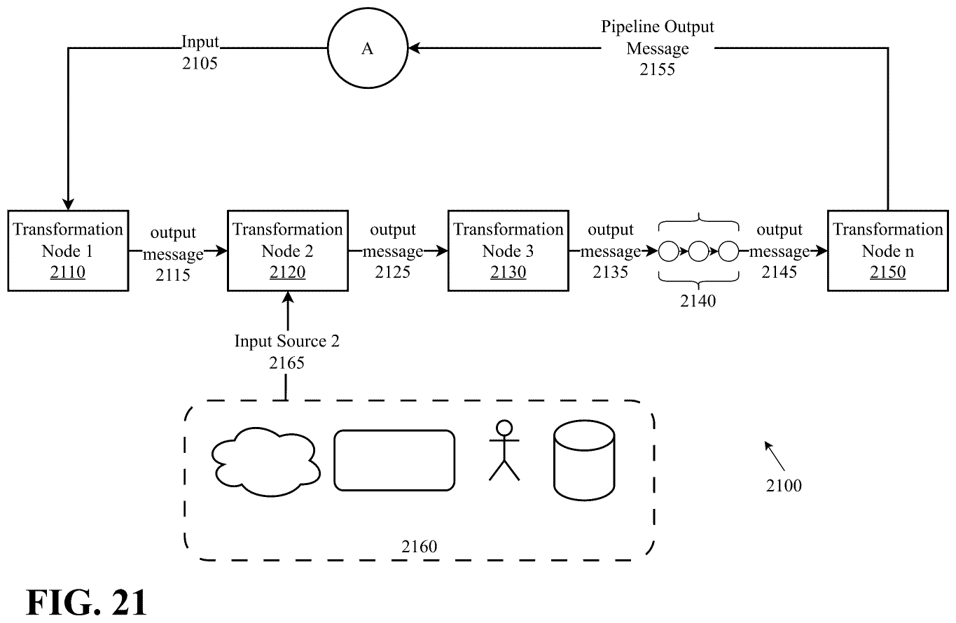

FIG. 21 is a block diagram of an architecture for a transformation pipeline within a system for predictive analysis of very large data sets using distributed computational graph computing system 2100. According to the aspect, streaming input from a data filter software module, 2105 serves as input to the first transformation node 2110 of the transformation pipeline. Each transformation node's function 2110, 2120, 2130, 2140, 2150 is performed on input data stream and transformed output message 2115, 2125, 2135, 2145, 2155, 2165 is sent to the next step. In this aspect, transformation node 2 2120 has a second input stream 2160. The specific source of this input is inconsequential to the operation of the invention and could be another transformation pipeline software module, a data store, human interaction, physical sensors, monitoring equipment for other electronic systems or a stream from the internet as from a crowdsourcing campaign, just to name a few possibilities 2160. For example, a first input stream may comprise enterprise knowledge and a second input stream may comprise RAG data from a RAG marketplace. Functional integration of a second input stream into one transformation node requires the two input stream events be serialized. The illustrated system can perform this serialization using a decomposable transformation software module. While transformation nodes are described according to various aspects as uniform shape, such uniformity is used for presentation simplicity and clarity and does not reflect necessary operational similarity between transformations within the pipeline. It should be appreciated that one knowledgeable in the field will realize that certain transformations in a pipeline may be entirely self-contained; certain transformations may involve direct human interaction, such as selection via dial or dials, positioning of switch or switches, or parameters set on control display, all of which may change during analysis; other transformations may require external aggregation or correlation services or may rely on remote procedure calls to synchronous or asynchronous analysis engines as might occur in simulations among a plurality of other possibilities. For example, engines may be singletons (composed of a single activity or transformation). Furthermore, leveraging the architecture in this way allows for versioning and functional decomposition (i.e. embedding entire saved workflows as single nodes in other workflows). Further according to the aspect, individual transformation nodes in one pipeline may represent function of another transformation pipeline. It should be appreciated that the node length of transformation pipelines depicted in no way confines the transformation pipelines employed by the invention to an arbitrary maximum length 2110, 2120, 2130, 2140, 2150, as, being distributed, the number of transformations would be limited by the resources made available to each implementation of the invention. It should be further appreciated that there need be no limits on transform pipeline length. Output of the last transformation node and by extension, the transform pipeline, 2150 may be sent back to a messaging software module for pre-decided action.

### Detailed Description of Exemplary Aspects

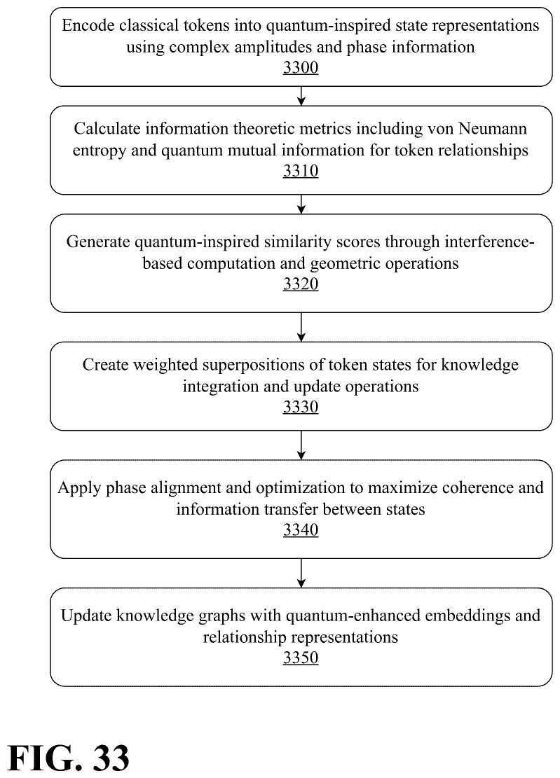

FIG. 33 is a flow diagram illustrating an exemplary method for implementing quantum-inspired token management in a deontic reasoning system. In a first step 3300, the system encodes classical tokens into quantum-inspired state representations using complex amplitudes and phase information. This encoding process begins by taking a classical token, such as a deontic rule about financial compliance, and normalizing its vector representation by dividing by its magnitude. The system then constructs a complex representation by first computing the amplitudes through normalization of the token vector. Phase information is generated using Fourier transforms of the normalized vector, creating a rich geometric encoding that preserves relationships between tokens. The final quantum state combines these amplitudes with the phase angles to create a complete representation that captures both magnitude and geometric relationships in a high-dimensional space.

In a step 3310, the system calculates information theoretic metrics including von

Neumann entropy and quantum mutual information to quantify relationships between token states. The von Neumann entropy computation begins by constructing a density matrix p from the quantum state amplitudes. In one embodiment, the system measures the quantum uncertainty of the state. For measuring relationships between states, the system computes quantum mutual information by calculating individual entropies H(A) and H(B) for each state, constructing a joint state, computing its entropy H(AB), and then calculating I(A:B)=H(A)+H(B)−H(AB). These metrics enable quantification of uncertainty and correlations between token states.

In a step 3320, the system generates quantum-inspired similarity scores through interference-based computation and geometric operations. The interference computation begins by calculating the inner product between state vectors, measuring their overlap in the complex vector space. The system combines this with geometric distance measures in the phase space, creating a comprehensive similarity metric that accounts for both amplitude overlap and phase relationships. For example, when comparing two compliance rules, the similarity score reflects both their direct content overlap and their geometric relationships in the token space.

In a step 3330, the system creates weighted superpositions of token states for knowledge integration and update operations. This process involves combining multiple quantum-inspired states using priority-weighted coefficients. For each state in the superposition, the system applies a normalized weight factor that reflects its relative importance. The weighted states are then combined while preserving their complex amplitudes and phase relationships, enabling coherent integration of multiple knowledge sources or rules.

In a step 3340, the system applies phase alignment and optimization to maximize coherence and information transfer between states. The phase alignment process begins by analyzing the phase relationships between states in the superposition. The system then computes optimal phase transformations that maximize constructive interference between compatible states while allowing destructive interference to highlight conflicts. This optimization process uses gradient-based techniques to find phase alignments that maximize both coherence and information transfer between states.

In a step 3350, the system updates knowledge graphs with quantum-enhanced embeddings and relationship representations. This final step integrates the processed quantum-inspired states into the knowledge graph structure. The system creates graph nodes that preserve both the complex amplitudes and phase information of the quantum states. Edge weights and types are determined by the calculated similarity scores and information theoretic metrics, creating a rich knowledge representation that captures both direct relationships and subtle correlations between concepts.

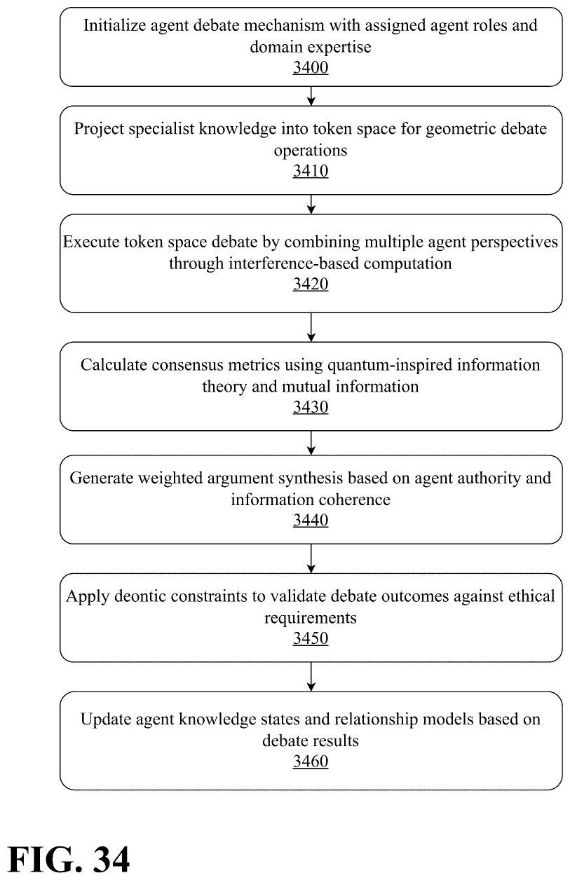

FIG. 34 is a flow diagram illustrating an exemplary method for implementing quantum-inspired agent debate mechanisms in a deontic reasoning system. In a first step 3400, the system initializes the agent debate mechanism by assigning specific roles and domain expertise to participating agents. For example, in a medical decision scenario, the system might initialize a specialist agent with expertise in cardiology, another with surgical knowledge, and a third focused on patient advocacy. Each agent is configured with role-specific parameters including authority weights, confidence thresholds, and domain-specific knowledge bases. The initialization process also establishes communication channels between agents and configures the debate protocol parameters such as maximum rounds and convergence criteria.

In a step 3410, the system projects specialist knowledge into token space for geometric debate operations. This projection process transforms each agent's domain expertise into quantum-inspired state representations. For instance, a cardiologist agent's knowledge about treatment protocols is encoded using complex amplitudes to represent the strength of recommendations and phase information to capture relationships between different treatment options. The projection preserves both the magnitude of expert opinions and their geometric relationships in a high-dimensional token space.

In a step 3420, the system executes the token space debate by combining multiple agent perspectives through interference-based computation. Agents exchange quantum-inspired representations of their arguments, which interact through constructive and destructive interference patterns. For example, when two medical specialists provide conflicting treatment recommendations, their quantum states interact in the token space, with aligned perspectives creating constructive interference and conflicts producing destructive interference. This geometric interaction enables rapid identification of agreements and conflicts without requiring exhaustive dialogue.

In a step 3430, the system calculates consensus metrics using quantum-inspired information theory and mutual information. The system computes von Neumann entropy for each agent's position and quantum mutual information between different agent perspectives. These metrics quantify both the uncertainty in individual agent positions and the degree of agreement between agents. For instance, high mutual information between two agents' states indicates strong agreement, while low mutual information suggests conflicting viewpoints.

In a step 3440, the system generates a weighted argument synthesis based on agent authority and information coherence. The synthesis process combines the quantum states representing different agent perspectives, weighing each contribution based on the agent's authority level and the coherence of their arguments. The system applies phase alignment techniques to maximize constructive interference between compatible arguments while preserving important disagreements that might indicate critical concerns.

In a step 3450, the system applies deontic constraints to validate debate outcomes against ethical requirements. The synthesized argument is evaluated against stored obligations, permissions, and prohibitions to ensure compliance with ethical and regulatory requirements. For example, if the debate concerns medical treatment options, the system verifies that the synthesized recommendation complies with patient consent requirements and medical ethics guidelines.

In a step 3460, the system updates agent knowledge states and relationship models based on debate results. The final debate outcome is used to update each agent's quantum-inspired knowledge representation. The system also updates relationship models between agents based on the observed pattern of agreements and disagreements during the debate. These updates enable continuous learning and refinement of the debate mechanism over time.

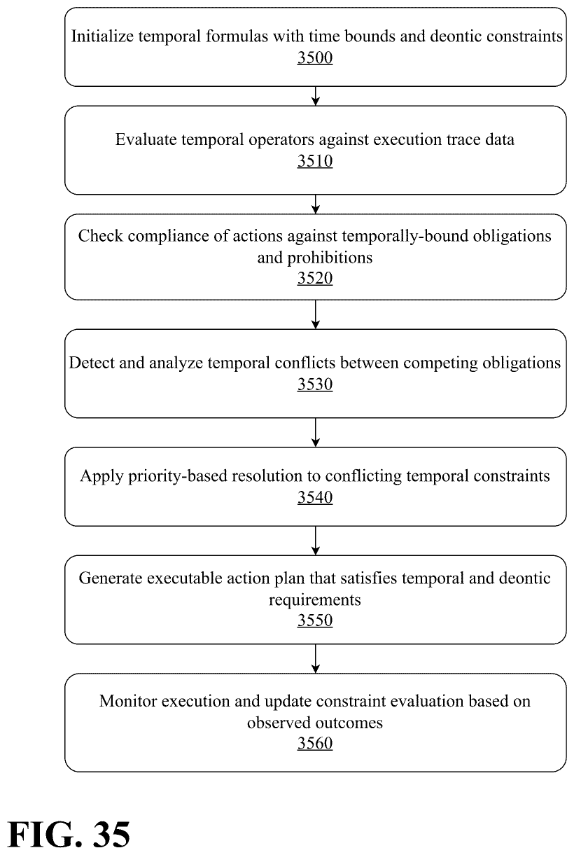

FIG. 35 is a flow diagram illustrating an exemplary method for managing temporal deontic constraints for an AI agent decision platform with deontic reasoning and quantum-inspired token management. In a first step 3500, the system initializes temporal formulas with time bounds and deontic constraints. The initialization process creates formal representations that combine temporal logic operators (ALWAYS, EVENTUALLY, UNTIL) with specific time bounds and deontic requirements. For example, in a medical context, a formula might specify that patient monitoring must occur every hour (ALWAYS operator with 1-hour intervals) while maintaining privacy requirements (deontic constraint). Each formula includes explicit start and end times, temporal validity windows, and associated deontic rules that govern behavior within those windows.

In a step 3510, the system evaluates temporal operators against execution trace data. This evaluation process examines the historical execution trace to verify compliance with temporal requirements. For instance, when evaluating an ALWAYS operator, the system checks if the specified condition holds at every time point within its bounds. The evaluation handles different temporal operators distinctly-EVENTUALLY verifies that conditions occur at least once within their time bounds, while UNTIL ensures conditions hold continuously until a specific event occurs.

In a step 3520, the system checks compliance of actions against temporally-bound obligations and prohibitions. This involves analyzing each action in the execution trace against applicable temporal constraints. For example, when checking a medical procedure, the system verifies that all required pre-procedure checks were completed within their mandated timeframes and that no prohibited actions occurred during restricted periods. The compliance check considers both the timing of actions and their adherence to deontic rules.

In a step 3530, the system detects and analyzes temporal conflicts between competing obligations. This analysis identifies situations where multiple temporal obligations overlap and potentially conflict. For instance, it might detect when an obligation to perform immediate emergency care conflicts with an obligation to wait for specialist consultation within a specific timeframe. The system analyzes the nature of each conflict, identifying direct contradictions, resource conflicts, and priority implications.

In a step 3540, the system applies priority-based resolution to conflicting temporal constraints. Resolution begins by assigning priority scores based on factors like urgency, importance, and hierarchical relationships between obligations. The system then applies resolution rules that consider both temporal and deontic aspects. For example, in medical scenarios, immediate life-saving obligations typically override routine procedural requirements, but the system maintains records of overridden obligations for later review.

In a step 3550, the system generates an executable action plan that satisfies temporal and deontic requirements. The plan generation process creates a sequence of actions that respects both temporal ordering constraints and deontic rules. Each action in the plan includes explicit timing requirements, preconditions, and associated deontic constraints. The system verifies that the complete plan satisfies all temporal formulas while maintaining compliance with obligations and prohibitions.

In a step 3560, the system monitors execution and updates constraint evaluation based on observed outcomes. This ongoing monitoring process tracks the execution of the action plan in real-time, comparing actual execution times and outcomes against planned temporal bounds. When deviations occur, the system dynamically updates its constraint evaluations and may trigger plan adjustments to maintain compliance. The monitoring also maintains an audit trail of temporal compliance for accountability and future optimization.

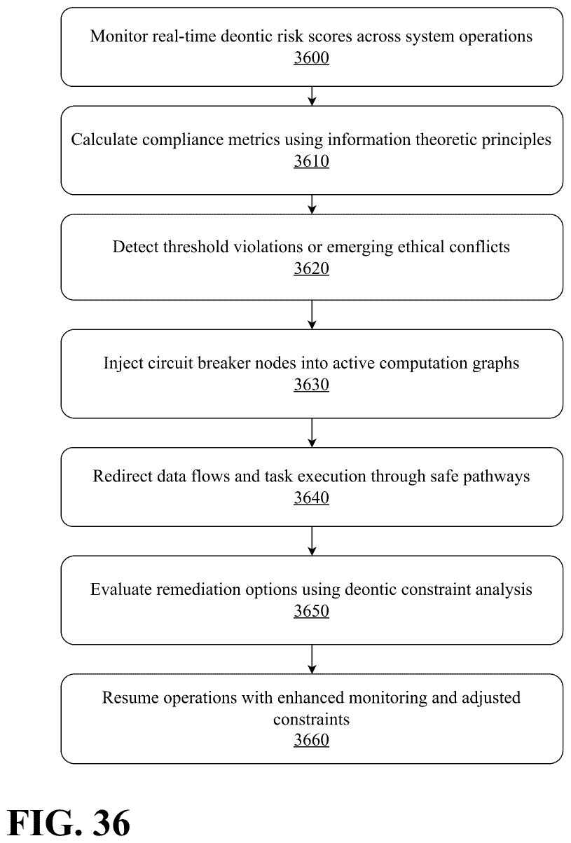

FIG. 36 is a flow diagram illustrating an exemplary method for implementing dynamic deontic circuit breakers in a system for an AI agent decision platform with deontic reasoning and quantum-inspired token management. In a first step 3600, the system monitors real-time deontic risk scores across system operations. This continuous monitoring process tracks ethical risk levels using quantum-inspired state representations. For example, when processing medical data, the system computes risk scores by evaluating the quantum states representing current operations against stored deontic constraints. The monitoring considers multiple risk dimensions simultaneously, including privacy violations, consent requirements, and regulatory compliance, using quantum-inspired interference patterns to detect emerging risks.

In a step 3610, the system calculates compliance metrics using information theoretic principles. This calculation process applies quantum information theory to measure compliance levels. The system computes von Neumann entropy to quantify uncertainty in compliance states and uses quantum mutual information to measure relationships between different compliance requirements. For instance, when evaluating HIPAA compliance in healthcare operations, the system calculates entropy-based metrics that capture both direct rule violations and subtle compliance degradation patterns.

In a step 3620, the system detects threshold violations or emerging ethical conflicts. Using the quantum-inspired risk scores and compliance metrics, the system identifies when operations approach or exceed acceptable risk thresholds. The detection process leverages interference patterns in the quantum state space to identify potential conflicts before they become critical. For example, the system might detect when increasing data access patterns risk violating privacy thresholds, even before an actual violation occurs.

In a step 3630, the system injects circuit breaker nodes into active computation graphs. When violations are detected, the system dynamically modifies the computation graph by inserting specialized circuit breaker nodes. These nodes act as ethical safeguards, implementing immediate halts or redirections of data flows. The injection process preserves graph consistency while ensuring that no further potentially harmful computations can proceed through the blocked pathways.

In a step 3640, the system redirects data flows and task execution through safe pathways. Once circuit breakers are activated, the system implements real-time rerouting of operations. For instance, if a data processing pathway is found to risk exposing sensitive information, the system redirects the flow through alternative pathways with enhanced privacy protections. The redirection process maintains operational continuity while ensuring compliance with deontic constraints.

In a step 3650, the system evaluates remediation options using deontic constraint analysis. This evaluation process examines possible solutions to the detected violations using quantum-inspired similarity measurements to identify safe alternatives. The system analyzes each potential remediation path against stored deontic constraints, computing interference-based similarity scores to identify options that maximize compliance while minimizing operational disruption.

In a step 3660, the system resumes operations with enhanced monitoring and adjusted constraints. After implementing remediation measures, the system restarts operations with heightened oversight. The resumption process includes updating quantum state representations to reflect new safety measures and adjusting monitoring thresholds based on learned patterns. The system maintains increased vigilance on previously problematic pathways while optimizing performance within the new safety boundaries.

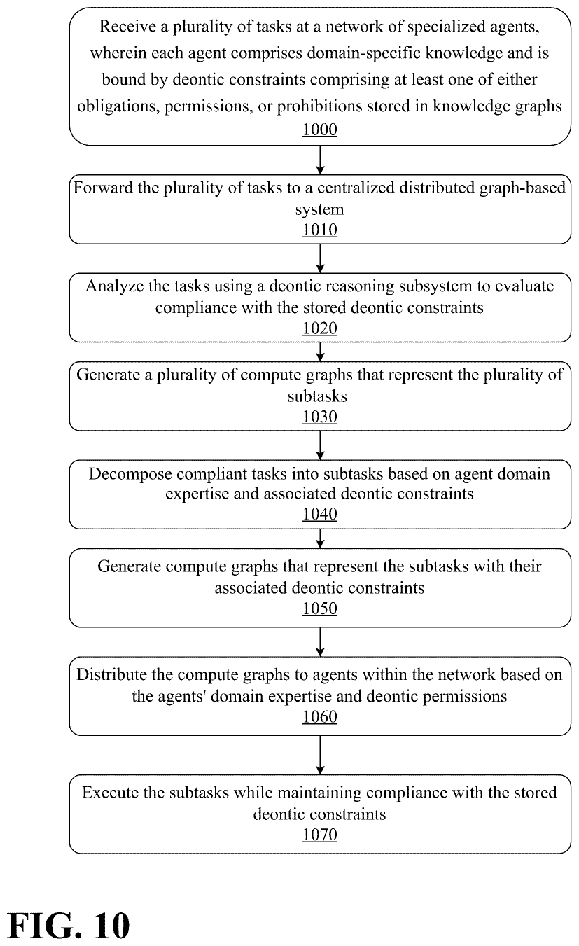

FIG. 10 is a flow diagram illustrating an exemplary method for an AI agent decision platform with deontic reasoning that can be configured with edge devices. In a first step 1000, the system receives tasks at a network of specialized agents, where each agent maintains domain-specific knowledge and operates under deontic constraints such as but not limited to obligations, permissions, and prohibitions stored in knowledge graphs. As detailed in the disclosure, these agents employ sophisticated domain-specific embeddings and relation-aware modeling to maintain their specialized knowledge.

In a step 1010, the system forwards tasks to a centralized distributed graph-based system, utilizing the DCG architecture described in the disclosure. This process may leverage quantum-inspired token operations to efficiently distribute and track task information across the network. In various embodiments, the term “quantum-inspired token operations” is not intended to imply the use of physical quantum computing hardware or quantum entanglement. Rather, these operations refer to a geometric or wave-interference-inspired mechanism for combining and evaluating vector embeddings within a high-dimensional token space, drawing conceptual parallels from quantum superposition without requiring actual quantum gates or qubits. For example, an agent's partial “states” (e.g., constraints, risk indicators, or subtask results) may be treated like waveforms whose amplitudes and phases can constructively or destructively interfere, thus providing a rapid, token-level means of detecting consensus or conflict among multiple agents. Although the system architecture also permits optional integration with genuine quantum computing resources—where quantum hardware might perform specialized optimizations or advanced search routines—this hybrid capability is neither a requirement nor the default assumption. Instead, “quantum-inspired token operations” broadly covers purely classical, geometry-based methods that borrow wave-like principles to enhance how information is merged or compared at scale. For example, an agent's partial “states” (e.g., constraints, risk indicators, or subtask results) may be treated like waveforms whose amplitudes and phases can constructively or destructively interfere, thus providing a rapid, token-level means of detecting consensus or conflict among multiple agents. This geometric interpretation allows efficient parallel evaluation of multiple agent perspectives by encoding them as vectors in a high-dimensional space where similarity and conflicts can be detected through mathematical operations analogous to wave interference patterns.

In a step 1020, the system analyzes tasks using the deontic reasoning subsystem to evaluate compliance with stored constraints. As described in the disclosure, this analysis employs neuro-symbolic reasoning techniques to combine neural network capabilities with formal logical verification.

In a step 1030, the system generates compute graphs representing subtasks using the sophisticated graph neural network capabilities detailed in the disclosure. These graphs capture both operational requirements and ethical constraints in a mathematically rigorous format.

In a step 1040, the system decomposes compliant tasks into subtasks based on agent expertise and constraints. This decomposition process employs the collegiate-style knowledge exchange framework described in the disclosure, enabling intelligent task distribution while maintaining ethical boundaries.

In a step 1050, the system generates compute graphs for subtasks with their associated deontic constraints. As detailed in the disclosure, these graphs incorporate both operational logic and ethical requirements using advanced information theoretic principles.

In a step 1060, the system distributes compute graphs to appropriate agents based on expertise and permissions. This distribution leverages the sophisticated resource management and load balancing capabilities described in the disclosure, ensuring optimal task allocation while maintaining ethical compliance.

In a step 1070, the system executes subtasks while maintaining compliance with stored deontic constraints. This execution process employs the observer-aware processing capabilities and dynamic feedback mechanisms detailed in the disclosure, ensuring continuous ethical compliance throughout task execution.

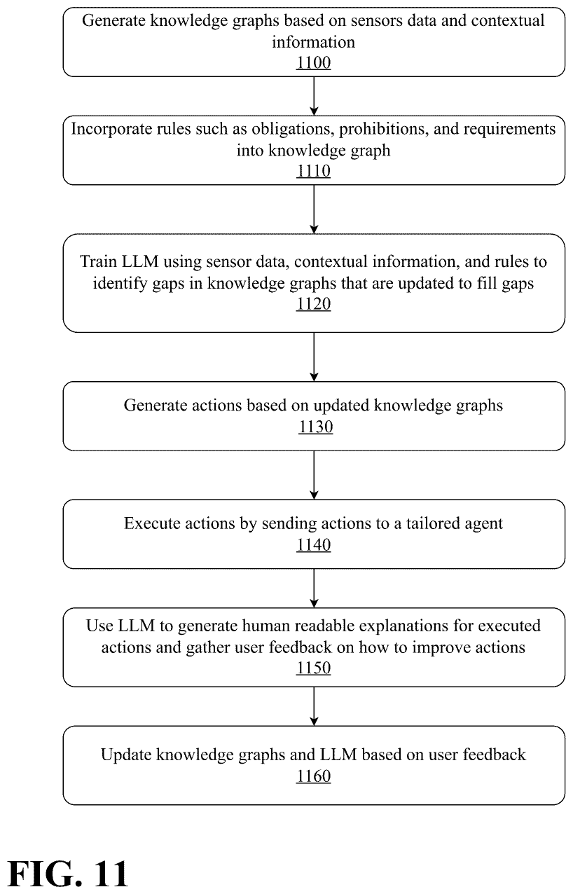

FIG. 11 is a flow diagram illustrating an exemplary method for updating knowledge graphs based on incoming sensor and contextual information. In a first step 1100, the system generates knowledge graphs by processing sensor data and contextual information using sophisticated domain-specific embeddings and relation-aware modeling techniques. For example, in a medical context, this might involve processing patient vital signs, medical history, and current hospital conditions into a structured knowledge representation that preserves complex relationships between symptoms, diagnoses, and treatments.

In a step 1110, the system incorporates deontic rules including obligations, permissions, and prohibitions into the knowledge graph. This integration leverages the disclosed relation-aware modeling techniques and quantum-inspired token operations to maintain logical consistency while representing complex ethical constraints. For instance, medical privacy regulations would be encoded alongside treatment protocols, ensuring that all subsequent decisions respect both operational and ethical requirements.

In a step 1120, the system trains an LLM using the combined sensor data, contextual information, and deontic rules to identify and fill gaps in the knowledge graphs. As disclosed, this process employs sophisticated information theoretic principles to measure knowledge transfer effectiveness and optimize learning across domains. The training process specifically leverages the collegiate-style knowledge exchange framework, enabling structured debate between different expert agents to identify and address knowledge gaps.

In a step 1130, the system generates actions based on the updated knowledge graphs. This process utilizes the disclosed neuro-symbolic reasoning framework, combining neural network capabilities with symbolic logic to ensure actions are both effective and ethically sound. The action generation process employs the system's advanced observer-aware processing capabilities to maintain appropriate perspective and context.

In a step 1140, the system executes actions by sending them to appropriate tailored agents. As detailed in the disclosure, this involves sophisticated resource-ethical tradeoff management and dynamic responsibility allocation based on real-time cognitive load assessments and task priorities.

In a step 1150, the system uses LLMs to generate human-readable explanations for executed actions and gather user feedback. This step leverages the disclosed explainable AI capabilities, ensuring transparency while maintaining the system's sophisticated reasoning capabilities. The explanation generation process specifically considers the observer frame and temporal context to provide appropriate and meaningful explanations.

In a step 1160, the system updates both the knowledge graphs and LLM based on user feedback, implementing the continuous learning mechanisms described in the disclosure. This update process employs causal entropy measurements and mutual information transfer components to optimize knowledge integration while maintaining system coherence and ethical compliance.

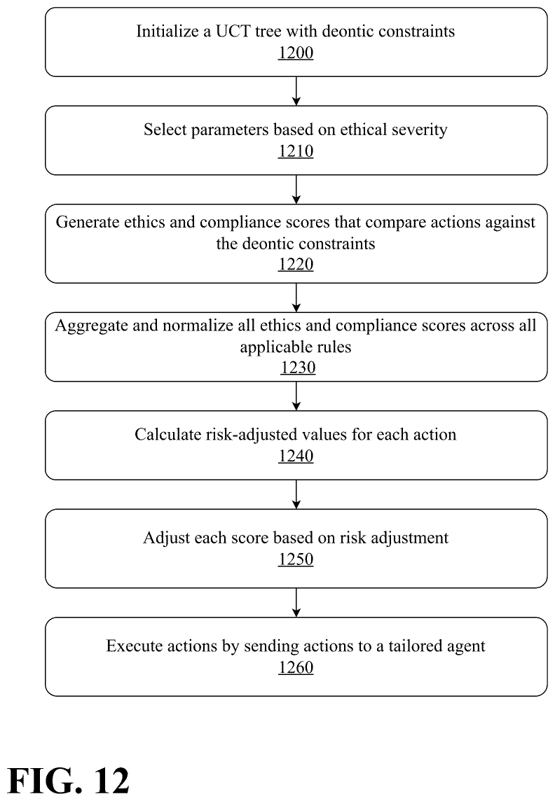

FIG. 12 is a flow diagram illustrating an exemplary method for integrating deontic constraints into UCT planning. In a first step 1200, the system initializes a UCT tree with deontic constraints, incorporating the quantum-inspired token space operations disclosed in the system. This initialization includes mapping obligations, permissions, and prohibitions into the tree structure using advanced geometric transformations in token space.

In a step 1210, the system selects parameters based on ethical severity, utilizing the disclosed information theoretic principles for measuring impact. For example, in a medical context, parameters might be adjusted based on the potential harm of violations, with life-critical decisions receiving higher ethical severity weights.

In a step 1220, the system generates ethics and compliance scores by comparing potential actions against deontic constraints. As described in the disclosure, this process employs sophisticated neuro-symbolic reasoning to evaluate actions across multiple ethical dimensions, using both neural network pattern recognition and symbolic logic validation.

In a step 1230, the system aggregates and normalizes ethics and compliance scores across all applicable rules. The disclosure details how this aggregation uses advanced information theoretic metrics and causal entropy measurements to ensure consistent evaluation across different types of constraints and contexts.

In a step 1240, the system calculates risk-adjusted values for each action using the sophisticated risk assessment frameworks detailed in the disclosure. This includes consideration of both immediate risks and potential longer-term implications, weighted by the system's confidence in its predictions.

In a step 1250, the system adjusts each score based on risk adjustment, implementing the dynamic risk-awareness mechanisms described in the disclosure. This adjustment process considers both ethical severity and operational uncertainty, using quantum-inspired operations to maintain computational efficiency.

In a step 1260, the system executes actions by sending them to tailored agents, leveraging the sophisticated agent network and resource management capabilities detailed in the disclosure. The execution process maintains awareness of both ethical constraints and operational requirements throughout implementation.

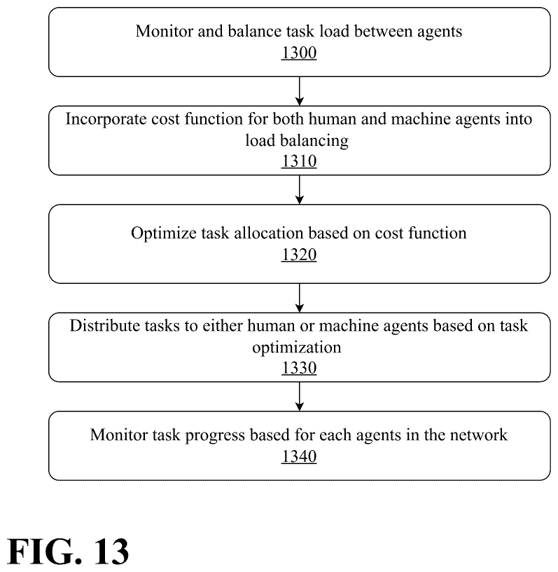

FIG. 13 is a flow diagram illustrating an exemplary method an AI agent decision platform with deontic reasoning with task optimization and monitoring. In a first step 1300, the system monitors and balances task load between agents using the advanced cognitive load estimation techniques detailed in the disclosure. This includes tracking both explicit metrics (like processing load and response times) and implicit indicators (such as stress levels for human agents) through sophisticated biometric and performance monitoring.

In a step 1310, the system incorporates cost functions for both human and machine agents into load balancing calculations. As described in the disclosure, these cost functions consider multiple factors including cognitive load, resource utilization, and task-specific expertise levels. For example, in a medical setting, the cost function might consider a surgeon's fatigue level alongside a robotic assistant's computational resource availability.

In a step 1320, the system optimizes task allocation based on the cost function using the quantum-inspired token space operations detailed in the disclosure. This optimization process leverages sophisticated information theoretic principles to balance immediate task requirements with longer-term resource management considerations.

In a step 1330, the system distributes tasks to either human or machine agents based on the optimization results. As described in the disclosure, this distribution process implements the collegiate-style knowledge exchange framework, ensuring that tasks are assigned to agents with appropriate expertise levels while maintaining overall system efficiency.

In a step 1340, the system monitors task progress for each agent in the network using the sophisticated observer-aware processing capabilities detailed in the disclosure. This monitoring includes real-time assessment of task execution quality, resource utilization, and compliance with deontic constraints, enabling dynamic adjustment of task assignments as conditions change.

In these steps, the federated DCG features specialized human-in-the-loop (HITL) mechanisms for transformations that require professional oversight or explicit ethical confirmation before tasks can proceed. For example, a medical scenario might mandate direct physician approval for any procedure that could risk patient safety (duty of care), while a legal scenario might require lawyer review before disclosing privileged documents (professional responsibility). The system organizes computational tasks into transformation pipelines, were each transformation node processes or routes incoming data. These transformation nodes can incorporate deontic checks that detect when data or process steps cross specified ethical or regulatory thresholds—e.g., “reveals sensitive patient info,” “modifies a legal document,” or “requests advanced medical procedures.” A deontic logic subsystem (DLS) encodes duties, obligations, and prohibitions, such as “A physician must confirm any high-risk treatment plan” or “A lawyer must review privileged records before final disclosure.” The DLS operates in concert with a threshold manager that monitors the pipeline's current transformation context. Once a transformation step triggers a “sensitive” or “high-risk” classification, the threshold manager flags the pipeline to enter a HITL override state. Each pipeline can specify a role-based or domain-specific human agent (e.g., a licensed physician, an attorney) who is designated to intercept tasks. In medical contexts, if a transformation node attempts to schedule an invasive procedure without verifying the patient's condition, the pipeline routes the pending request to the on-call medical agent for explicit approval. In legal contexts, if the pipeline processes documents containing privileged attorney-client communications, the designated lawyer must confirm that disclosure is permissible under professional standards. Each pipeline node is defined in the federated DCG domain-specific language (DSL) with metadata fields describing (i) the nature of the data processed, (ii) associated deontic constraints, and (iii) an optional HITL flag. Example DSL snippet: TransformNode {name: “HighRiskMedicalDecision” requiredRole: “LicensedPhysician” deonticConstraints: [“Obligation: Must confirm invasive procedure with doctor”] HITL: true} This snippet ensures the node's logic will automatically route the transformation request to a physician if triggered.

Deontic constraints could be specified hierarchically. A deontic constraint is a moral rule or principle that prohibits certain types of actions even when doing so would prevent more instances of that same action from occurring. Key features of deontic constraints include: prohibition of actions (such as killing innocent people, breaking promises, or stealing); non-consequentialist nature (certain actions are wrong regardless of their outcomes); absoluteness (do not allow for exceptions based on consequences).

When a pipeline execution flow reaches a node with a HITL: true flag, the system consults the deontic logic subsystem to validate that no prohibition or duty is being violated. If the transformation's operation or data classification surpasses a “safe threshold” (e.g., due to risk severity or legal constraints), the pipeline transitions into a pending state. The node compiles a context packet (metadata, partial logs, relevant data snapshots) and sends it—via secure channels in the federated DCG—to the appropriate human agent's interface.

For example, in a medical scenario, the context packet might include patient vitals, recommended drug dosages, or prior medical notes. The system obfuscates or filters out nonessential data if additional privacy constraints apply. The human agent (physician, lawyer, etc.) reviews the context packet using a human-in-the-loop override interface. This specialized interface can display relevant logs, highlight flagged constraints, and allow the agent to either approve, modify, or reject the pending transformation. The agent's decision automatically updates the node's state in the federated DCG: Approve (the pipeline continues execution, possibly with updated parameters), Modify (the pipeline reconfigures the transformation logic), or Reject (the pipeline halts and flags an override event in the logs). All hits to the HITL override mechanism generate audit trails, including timestamps, the agent's identity, the reason for override, and any changes to the transformation. These logs become part of the knowledge graph or a linked compliance database, enabling future verification, regulatory audits, and continuous system improvement. In the duty-of-care and professional responsibility integration, ethical principles are encoded in the knowledge graph. In a medical domain, duty-of-care is represented as an obligation: “Doctors must ensure patient safety above operational efficiency.” In a legal domain, a prohibition might be: “Attorneys must not disclose privileged client data to outside parties without explicit client consent.” Each professional agent node is associated with credentials and a role that aligns with the domain's rules—physicians must have verified medical credentials, lawyers must hold a valid bar membership. This association is stored in the federated DCG's resource registry or agent directory. A pipeline cannot proceed with a role-based HITL step if no verified human agent is assigned to that role. If the system detects urgent or emergency contexts (e.g., a critical patient status), an emergency override workflow may automatically notify the highest-priority human agent. This ensures the federated DCG respects duty-of-care obligations by not simply letting a procedure proceed unconfirmed in an emergency scenario. In a medical “invasive procedure” use case example, the system first ingests real-time vitals from sensors for a patient. The “InvasiveProcedurePlan” node sees abnormal vitals that justify an emergent procedure. The node sets a “High Risk” label, and the DLS references knowledge graph obligations stating a doctor must confirm any invasive procedure. A context packet is assembled with the patient's vital trends, proposed procedure details, and fallback therapies. The doctor's user interface displays the reason for override, and the doctor either approves the recommended procedure or modifies the dosage. Upon approval, the transformation node finalizes resource allocation; if rejected, the pipeline halts or transitions to a safer fallback plan.

The federated DCG uses TLS or analogous encryption to transmit the context packet to the human agent's interface, ensuring HIPAA compliance in medical or attorney-client privilege in legal contexts. The system can specify a maximum time window for agent decisions, after which it may escalate to a secondary human agent or revert to a safe default. Because the federated DCG is federated, multiple replicas of the decision logs may be stored on separate nodes for fault tolerance. If a node is unreachable, the system automatically reroutes the override request to another qualified human agent. The observer agent can track how often HITL overrides occur, feeding analytics back into a continuous improvement cycle.

This additional embodiment describes a dynamic “deontic circuit breaker” mechanism that goes beyond static human-in-the-loop pipeline steps, enabling real-time insertion of circuit breakers into the federated Distributed Computational based on ongoing deontic risk scoring and analysis. This approach also interfaces directly with resource-allocation and load-balancing subsystems to ensure that high-risk or ethically complex operations are automatically halted, rerouted, or escalated to human review when certain triggers are met. While standard federated DCG pipelines can embed human-in-the-loop transformations declaratively at design time (e.g., “HITL: true”), some real-world situations demand adaptive interventions. This embodiment addresses how the system computes a running “deontic risk score” (e.g., “ethical hazard index,” “compliance risk rating”) throughout pipeline execution. If the score spikes above a threshold, deontic circuit breakers (DCBs) are dynamically injected or activated in mid-execution to block or detour tasks, possibly requiring human authorization or alternative resource allocations.

The Deontic Risk Scoring Subsystem (DRS) continuously monitors each transformation node's operations and data attributes. This includes data classification (e.g., “private health info”), agent domain constraints, or partial analyses of upcoming tasks. Based on knowledge graph references, regulatory constraints, or machine learning risk models, the DRS computes an ongoing risk score. For instance, each new piece of data or partial result might increment the score if it is particularly sensitive or if combined with existing data it creates a privacy or compliance risk. The federated DCG includes live observer processes that tap into partial transformation outputs, scheduling logs, and resource usage. These observers feed real-time context (e.g., CPU load, data type changes, emerging constraints from knowledge graphs) to the DRS and also track resource metrics from the resource-ethical optimization engine. This synergy ensures the DRS has a broad, up-to-date view for scoring. When the DRS detects that the risk score surpasses a certain threshold (e.g., “≥80% chance of violating confidentiality obligations”), it can inject a specialized pipeline segment or transformation node, known as a “DCB node.” These DCB nodes function as interrupt gates—they halt or suspend further pipeline execution at that point, potentially storing partial outputs in a secure buffer. Injection can also happen at the resource-allocation layer: if a node is about to schedule a task that conflicts with a deontic requirement (e.g., processing personal data in a region with strict privacy laws), the circuit breaker flags that node and denies the resource request, deferring tasks to a safer or more compliant node. Once the circuit breaker is triggered, the system may escalate to a human agent by routing the pipeline context to a designated professional (doctor, lawyer, compliance officer), re-run or reallocate by having the federated DCG's multi-objective optimization attempt to replan tasks on alternative resources or with less sensitive data transformations, or fallback where if no path can comply with the relevant deontic rules, the DCB forcibly terminates the pipeline or defers the entire job until external resolution.

Resource-Ethical Optimization continually receives updates from the DRS. If the risk score is climbing for a pipeline, the system can preemptively route tasks to “high-trust” nodes with advanced security or re-locate tasks to a different jurisdiction with more favorable regulations. Conversely, if resource constraints become severe and the system wants to schedule tasks in a less-secure environment, the DRS reevaluates the risk score. If it deems the new environment non-compliant or unethical, the circuit breaker triggers. The platform can define a set of risk thresholds that map to different actions (e.g., “medium risk=attempt partial anonymization,” “high risk=immediate circuit breaker plus human override”). This balances cost-based scheduling (e.g., CPU/GPU efficiency) with compliance-based constraints, ensuring that no single dimension (performance or compliance) alone dictates final decisions. Each data item or partial result is assigned a “sensitivity level.” The DRS aggregates these with relevant contextual factors (jurisdiction, agent role, prior transformations) to produce a real-time score, RiskScore(t). If RiskScore(t)≥DangerThreshold, the pipeline's next step is paused. The DRS signals the orchestrator to insert a DCB node.

The orchestrator modifies the runtime pipeline in memory, effectively splicing in a “break” step, instructing downstream transformations to hold pending tasks. A newly injected DCB node may spawn a queue or buffer for partial outputs, then either request an override from a human agent, initiate partial re-anonymization or differential privacy transformations to reduce risk, or abort the pipeline or re-route tasks to alternate resources matching the system's constraints. If a human override is granted or additional anonymization steps successfully reduce the risk score, the orchestrator removes or disables the DCB node. The pipeline continues from its paused state with an updated risk context or re-planned resource mapping. Consider an extended use-case example of a “Computation Time federated DCG for Medical Diagnosis.” In a long-running computation, the system is running a large-scale distributed analysis of medical imaging to detect anomalies. Mid-analysis, a node detects the presence of extremely sensitive patient data that was not properly anonymized upstream. The DRS calculates a spiking risk score. A DCB node is injected, halting the pipeline mid-imaging analysis, and partial results are quarantined. The system notifies a hospital compliance officer who either instructs the platform to apply a stricter anonymization subroutine or confirms that the data was incorrectly labeled “anonymous.” After the officer's override reclassifies the data with correct anonymization or obtains patient consent, the DCB node is disabled, and the pipeline execution resumes. For runtime modification of pipelines, the orchestrator must allow dynamic insertion or removal of nodes. This can be realized by storing pipeline definitions in a mutable graph structure in memory and using standard “topology change” events. To avoid mid-execution race conditions, pipeline modifications happen through an atomic transaction in the federated DCG's pipeline manager, ensuring other nodes see a consistent pipeline state. Each circuit breaker trigger is recorded with a cause, timestamp, and final resolution (e.g., “No override,” “Human override #123 granted”). The logs can feed into the knowledge graph for future analysis or compliance reviews. The system can unify standard “human-in-the-loop” steps declared at design time with these dynamic DCB-based escalations. Both can involve the same or different human agent roles, but the DCB approach emerges from ongoing system risk calculations rather than a static pipeline design.

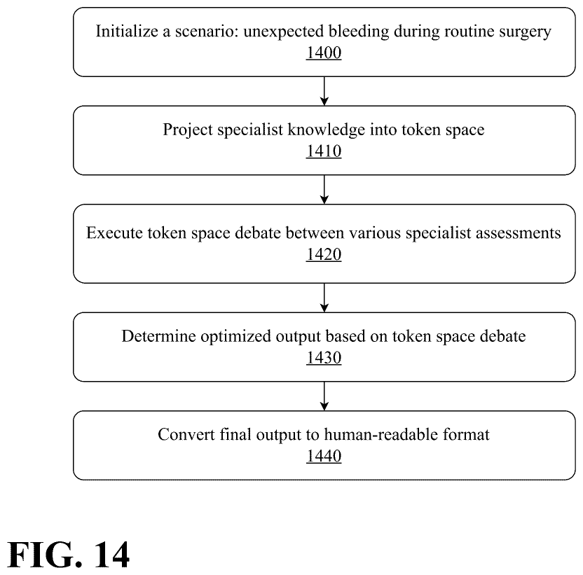

FIG. 14 is a flow diagram illustrating an exemplary method for integrating specialized knowledge into a knowledge graph and leveraging the platform in a simulated routine surgery. In a first step 1400, the system initializes a scenario involving unexpected bleeding during routine surgery. As detailed in the disclosure, this initialization includes capturing vital signs, contextual information, and relevant medical history using the system's sophisticated sensor integration and contextual awareness capabilities.

In a step 1410, the system projects specialist knowledge into token space using the quantum-inspired geometric operations detailed in the disclosure. This projection includes mapping multiple types of expertise, such as surgical knowledge, anesthesiology expertise, and emergency response protocols, into a high-dimensional representation that preserves semantic relationships and operational constraints.

In a step 1420, the system executes a token space debate between various specialist assessments. As described in the disclosure, this debate process leverages the collegiate-style knowledge exchange framework, enabling rapid geometric interactions between different specialist perspectives while maintaining deontic constraints. For example, a trauma specialist's assessment might interact with an anesthesiologist's perspective through rapid token-space operations.

In a step 1430, the system determines optimized output based on the token space debate using the sophisticated information theoretic principles detailed in the disclosure. This optimization process considers both immediate medical needs and longer-term implications while maintaining compliance with ethical and procedural requirements.

In a step 1440, the system converts the final output to a human-readable format using the advanced explanation generation capabilities described in the disclosure. This conversion process ensures that complex medical decisions are communicated clearly and effectively to human medical staff while maintaining full transparency about the reasoning process.

According to various embodiments, the system may implement advanced reasoning and control capabilities through integration of specialized languages and frameworks. These integrations enable sophisticated decision-making while maintaining compliance with deontic constraints across multiple levels of abstraction, from high-level ethical reasoning to low-level robotic control.

The system initiates a routine surgical scenario step 1400 but must adapt swiftly to unexpected bleeding. Traditionally, we rely on pre-computed knowledge graphs or large vector indexes to retrieve medical best practices, but here we demonstrate how an enhanced LazyGraphRAG can efficiently supply relevant context using an on-demand approach, blending best-first and breadth-first retrieval-without costly up-front summarization of an entire corpus. As previously stated, the system captures the patient's vital signs, medical history, and environmental sensor data to identify urgent anomalies (e.g., “blood pressure dropping, bleeding recognized in the patient's abdomen”). Instead of rummaging through a massive pre-summarized knowledge base, the system queries a lightweight concept graph representing medical knowledge. It only extracts or constructs relevant “concept nodes” on-the-fly (e.g., coagulopathy treatments, rare vascular anomalies, recommended blood transfusion protocols) that match the “unexpected bleeding” query context. The system runs a noun phrase extraction algorithm on the emergent textual data (e.g. triage notes, surgery logs). This extracts domain-specific terms such as “resected hepatic artery,” “intraoperative coagulopathy,” “massive transfusion protocol.” These extracted concepts become part of a small, ephemeral concept graph that references known relationships (e.g. hepatic arteries→coagulopathy risk) stored at a coarse level. No LLM summarization is performed up front. We simply store minimal textual associations (co-occurrence edges, relevant snippet references) in a concept graph. The system recognizes two complementary needs: a local query for immediate next steps (e.g., “Which clamp technique do we use for an arterial bleed in the liver?”) and a global query for broader policy or cross-domain knowledge (e.g., “Which hospital-wide transfusion guidelines must be followed?”). The enhanced LazyGraphRAG handles both by iteratively deepening: First, starting with a best-first approach, checking local concept alignments (arterial clamps, sedation impacts). Then, if needed (the system still sees conflicting data or missing info), it can expand to a “breadth-first” pass across additional conceptual “communities” (like blood type, ABO mismatch concerns, or rare clotting disorders). For each subquery (e.g., “arterial clamp best practices?”), the enhanced LazyGraphRAG ranks text chunks from various medical data sources (textbooks, journals, EHR notes). The system uses a small LLM-based “relevance test” to confirm the top k chunks are indeed relevant for the current query. If the system finds enough relevant chunks (or if it hits its relevance test budget—like 20 checks for local queries, 80 for broader queries), it stops searching further communities. If the system identifies a cluster of concepts labeled “transfusion guidelines,” it recurses into that subgraph. If repeated checks yield no relevant text, it stops exploring that subgraph. This “iterative deepening” means minimal overhead for unneeded areas (like pediatrics, if the patient is an adult). Once relevant text chunks are confirmed, the system maps them into claim-based groupings (e.g., “Claim A: apply clamp at the proximal arterial tear,” “Claim B: administer factor VII if clotting is not stabilized.”). The system uses a separate LLM call for subquery-based summarization, thus deferring large summarizations until the final step. This is the “lazy” portion—no full summarization was done prior to the emergency. Surgeons or the AI assisting agent can verify the claims or ask for additional details. If a claim is contradictory or incomplete, the enhanced LazyGraphRAG can do another pass in the concept graph. For example, “Double-check if the patient is on any anti-coagulants.” The system triggers a new local subquery to see if the EHR mentions warfarin or novel anticoagulants. Finally, the system selects the top claims to fit the surgical team's context window (say, 4 k tokens if using a local LLM on an embedded device). It filters out extraneous details about pediatric guidelines, storing them for reference but not surfacing them in the final summary.

The integrated knowledge from the lazy retrieval approach is fed into the surgical workflow system. If the system or surgeon finds contradictions or requests more data, a new iteration of enhanced LazyGraphRAG is performed with a larger or more specialized relevance test budget. The advantages over traditional vector or full graph summarization include minimal up-front costs, improved relevance, and scalable complexity. If the system or surgeon finds contradictions or requests more data, a new iteration of enhanced LazyGraphRAG is performed with a larger or more specialized relevance test budget. The advantages over traditional vector or full graph summarization include minimal up-front costs, improved relevance, and scalable complexity. The system can still do “lazy” expansions for textual data, but also references a GeoKG with geometry-based edges. During query time, the retrieval engine merges textual similarity with spatial constraints. Entities and edges become time-stamped or carry time intervals (e.g., “road closed from 8 PM to 6 AM,” “patient's medication schedule changes after 2 hours”). Inspired by TKG models like DyMemR, the system chooses which historical facts to retain in an on-demand memory pool. This helps avoid “stale” data or irrelevant time periods. At query time, we only “activate” relevant historical segments—especially crucial in real-time events where recency matters. In complex surgeries or legal disputes, certain constraints hinge on distance or elapsed time.

For example, “A neighboring county's ambulance can't arrive in under 30 minutes—this affects the immediate next steps” or “A piece of evidence that was only valid for a set time window is no longer permissible.” Different agents might interpret deontic constraints differently, especially if they rely on location or time. For example, Agent 1: “We must not share data for a region outside our jurisdiction” versus Agent 2: “We are allowed to share because the patient is physically in Region B.” Incorporating geometry and time clarifies when a constraint is triggered or not. Consider a scenario where a patient has an unexpected cardiac event mid brain surgery. The system knows the operating room's location, the specialized cardiologist's location, and approximate distance/time. It can quickly compute if it's feasible to bring that cardiologist in, or if an on-site general approach is mandatory. If the patient's sedation has a 2-hour maximum recommended limit, the knowledge graph could store a time-coded rule that triggers detection, triage, escalation and alerting logic: “At time T+120 minutes, sedation limit is reached.” Deontic logic can forcibly escalate or alter the approach if sedation time is nearing or other context changes. We might have opposing lawyers or confidential medical staff who each maintain a separate sub-graph. Some geometry or timelines are private while others can be shared. For example, a hospital attorney might see all state boundaries and public laws, but not the patient's exact location if it's privileged data. By embedding spatial geometry (topology, direction, distance) and temporal logic (time intervals, dynamic memory) within a knowledge graph—and combining it with an enhanced LazyGraphRAG-like on-demand retrieval—the system achieves location & time-sensitive constraints, dynamic agent roles & partial data sharing, and advanced multi-agent debates. This synergy of spatio-temporal knowledge with lazy retrieval and deontic constraints ensures deeply context-aware, location/time-cognizant, and policy-compliant reasoning. The enhanced LazyGraphRAG merges event- and location-specific data layers in real time, selectively pulling relevant historical or geospatial segments. This spatiotemporal pivot is triggered dynamically by observed cues—e.g., updated sensor data, adjacency in event graphs, or time-window expansions.

In one embodiment, the system introduces a distinctive retrieval-augmented generation technique referred to herein as the enhanced LazyGraphRAG, which diverges significantly from known or conventional RAG methodologies. Rather than pre-fetching and summarizing large corpora upfront, the enhanced LazyGraphRAG performs on-demand, iterative best-first lookups, dynamically retrieving only those knowledge graph nodes, text segments, or vector embeddings deemed contextually relevant at each partial reasoning step. Tasks are expanded in small, best-first increments only when current evidence indicates additional detail is necessary. By avoiding excessive precomputation, the system reduces overhead and mitigates data bloat. At each mini-expansion, the system evaluates newly uncovered data against obligations, permissions, and prohibitions in the deontic logic subsystem. Any conflict triggers partial redaction, anonymization, or circuit-breaker injection before data is returned to downstream components. Unlike prior chunk-based RAGs, chunking here is guided by real-time rule checks-if constraints disallow certain detail or fine-grained expansions, the system prunes that data path. This ensures that only policy-compliant embeddings are retrieved and surfaced. Collectively, these design elements produce a dynamic, compliance-aware retrieval pipeline enabling users and agents to interact with large knowledge corpora or knowledge graphs without incurring the typical overheads of all-or-nothing expansions. Crucially, the enhanced LazyGraphRAG's incremental chunking and spatiotemporal expansions-accompanied by repeated deontic checks-represent an inventive technique that goes beyond standard retrieval-augmented generation approaches. By allowing context and constraints to shape each retrieval step in real time, this system not only improves retrieval efficiency and context fidelity but also provides a robust mechanism to enforce domain-specific rules and privacy constraints.

This embodiment builds upon, and remains consistent with, the fundamental concepts of the recently introduced traditional LazyGraphRAG framework, which emphasizes on-demand iterative expansion of knowledge sources without incurring the upfront summarization costs normally required by comprehensive graph-based indexing. While the core traditional LazyGraphRAG method already demonstrates compelling advantages in balancing cost versus answer quality (particularly for global queries and large datasets), an enhanced LazyGraphRAG embodiment goes further in several notable ways: 1. Spatiotemporal integration: in addition to the noun-phrase or concept extraction proposed by the traditional LazyGraphRAG, this approach can dynamically map these extracted concepts onto spatiotemporal knowledge graphs, thereby enabling queries that consider time windows, location-aware contexts, or event sequences. Rather than treating extracted concepts in isolation, an enhanced system links them to event nodes, geospatial references, and time intervals—on demand—so that iterative expansions reflect the evolving temporal or geographical scope of a user's query; 2. Deontic Compliance Checks which utilize a deontic reasoning subsystem integrated at each retrieval iteration. As a traditional LazyGraphRAG would incrementally identify new chunks and potential sub-communities, the system automatically applies real-time checks against stored obligations, permissions, and prohibitions. If a newly surfaced chunk violates relevant constraints—e.g., disclosing forbidden details or exceeding privacy thresholds—the system prunes or redacts that path before exposing the retrieved text to a user or to subsequent pipeline steps. This “compliance-aware chunking” explicitly distinguishes the system from more general LazyGraphRAG workflows that do not account for real-time policy gates; 3. Adaptive Circuit Breakers and Role-Specific Agents: beyond the iterative deepening retrieval logic, the enhanced LazyGraphRAG introduces a mechanism for partial “circuit breaker” insertion, triggered whenever relevant expansions start to exceed defined risk scores or conflict with agent role constraints. For example, if newly discovered content must be restricted to a medical specialist or a higher clearance agent, the pipeline can automatically generate a “circuit breaker” node that halts the default expansions and escalates to a specialized persona. This extension retains the iterative best-first and breadth-first synergy of the traditional LazyGraphRAG but injects explicit human or domain-expert oversight whenever high-risk data is encountered; 4. Lazy Summarization Layers with Hierarchical Claims: while original LazyGraphRAG fully defers LLM summarization until query time, an enhanced version further dynamically layers partial summarizations. When the system identifies highly relevant or repeated text chunks across expansions, it temporarily caches micro-summaries—organized by concept cluster or sub-community—to expedite subsequent expansions in the same session or context. This partial “lazy layering” only occurs if repeated queries and expansions exceed a threshold frequency, ensuring we preserve minimal up-front cost while improving iterative retrieval speed for repeated queries within a session; 5. Hybrid Traditional-Quantum Interface: In optional embodiments, the iterative expansions within the enhanced LazyGraphRAG can call specialized quantum solvers for certain ranking or optimization subtasks. However, this quantum integration is not fundamental to the approach and is distinguished from a “quantum-inspired” concurrency references. Instead, it provides an advanced configuration that leverages hardware-accelerated or approximate quantum algorithms for large-scale concept clustering or multi-constraint re-checking. Overall, these additional capabilities preserve the advantageous cost and scalability profile of the traditional LazyGraphRAG—namely, avoiding pre-computed entity summaries and deferring broad coverage expansions until necessary—while layering compliance checks, spatiotemporal data integration, circuit breaker triggers, and dynamic summarization. By focusing on real-time policy-enforcement and domain-oriented expansions, an enhanced LazyGraphRAG significantly expands both the types of queries addressable (e.g., spatiotemporal or policy-constrained queries) and the case with which enterprise-grade regulatory or organizational rules can be upheld in an iterative retrieval pipeline.

Although the enhanced LazyGraphRAG (or partially lazy retrieval) offers substantial advantages—particularly for incremental, on-demand exploration of unstructured data—the system is also capable of recognizing scenarios in which a pre-indexed GraphRAG structure provides unique benefits. In some embodiments, the system merges both strategies, yielding functionality that neither pure “lazy” RAG nor fully “pre-summarized” RAG alone can achieve. Specifically: a fully built “GraphRAG data index,” wherein entities, relationships, or community summaries are extracted and curated, can have independent utility beyond question answering. For example, these summaries may be published as enterprise knowledge reports, compliance overviews, or analytical briefs for decision-makers. The system can automatically compile such community-level summaries at intervals (e.g., daily or weekly) to provide a human-readable snapshot of how data is evolving. This functionality transcends the real-time Q&A context, serving broader operational needs (e.g., compliance auditing, domain-specific analytics, and stakeholder reporting). The invention lies in enabling robust static indexing—while still allowing selective deferral of certain expansions to a lazy mechanism for real-time queries. Another inventive aspect arises when an existing entity-level or community-level index is integrated alongside the lazy expansions. The system can leverage those comprehensive summaries in parallel with on-demand retrieval steps. For instance, if a user's query triggers local expansions (as in classic LazyGraphRAG) but also references a global theme (e.g., “What overarching trends appear in [dataset X]?”), the system can short-circuit portions of the lazy expansion by pulling from a precompiled, higher-level “community” summary. This synergy amplifies query efficiency—since partially relevant summaries exist—and also enhances answer quality by ensuring that the system can pivot to structured insights when local expansions prove insufficient. The system is capable of supporting automated bridging between these two retrieval modes, constituting a novel method of fusing top-down and bottom-up expansions within a single RAG environment.

A further inventive principle involves designing a new style of “GraphRAG data index” explicitly optimized for supporting lazy expansions. Traditional indexing often relies on broad entity or relationship summaries that can be expensive to create and may remain static over time. In contrast, the system contemplates pre-emptive claim and topic extraction at ingestion time, but does so in a more granular, modular fashion—effectively “tagging” or “clustering” content so that lazy expansions can quickly assemble relevant subsets without fully summarizing each node. By incorporating minimal or partial pre-summarization (for example, auto-extracted claims or micro-summaries) and storing them in an index structure intentionally designed for iterative deepening, the system achieves the best of both worlds: fast local expansions (akin to classic LazyGraphRAG); immediate fallback to specialized “claim clusters” or “topic seeds” when the query demands broader context; economical overhead compared to heavy global summarizations that might be wasteful or quickly outdated. Viewed together, these enhancements demonstrate that “laziness” in graph-based RAG is not an all-or-nothing proposition. Rather, the inventive leap is to combine partial, on-demand expansions with carefully curated static elements—thereby yielding comprehensive data vantage points for tasks like global auditing, while also allowing on-demand retrieval for localized queries. This approach addresses a range of real-world usage scenarios spanning from once-off queries in ephemeral contexts to ongoing enterprise analyses where prebuilt knowledge graphs provide additional, non-Q&A benefits. Such a multi-pronged system architecture—merging robust indexing methods with lazy expansion, dynamic constraints enforcement (including deontic policy checks), and optional pre-emptive claim extraction—represents a substantial advance over purely lazy or purely index-based RAG systems. By situating each approach where it is strongest and enabling automatic switching or blending, the invention offers an improved cost-quality tradeoff and a richer set of knowledge services beyond mere question answering.

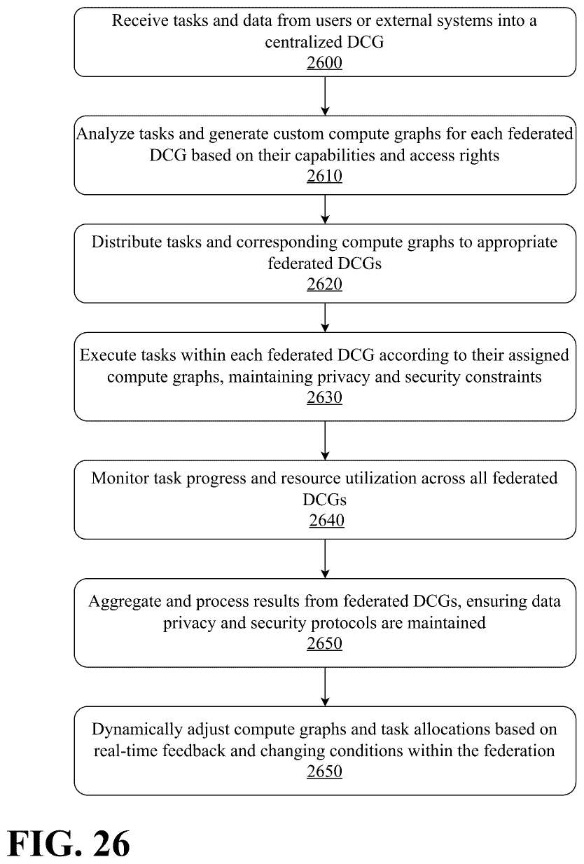

FIG. 26 is a flow diagram illustrating an exemplary method for a federated distributed graph-based computing platform. In a step 2600, the system receives tasks and data from users or external systems. This step initiates the federated computing process, where complex computational tasks are encoded into high-level computational graphs. These graphs represent the overall structure and dependencies of the required computations, and may include additional data such as application-specific information, machine learning models, datasets, or model weightings.

In a step 2610, the system analyzes the tasks and generates custom compute graphs for each federated node based on their capabilities and access rights. This involves examining each task to determine its specific requirements, such as computational power, data access needs, and security constraints. The system then creates tailored versions of the original computational graph, modified to fit the specific capabilities and access rights of each federated node. In a step 2620, the system distributes tasks and corresponding compute graphs to appropriate federated nodes. This involves securely transmitting these custom compute graphs to the respective federated nodes, along with any necessary data or models. This transmission occurs through a structured pipeline, ensuring efficient and secure distribution of tasks across the federation.

In a step 2630, tasks are executed within each federated node according to their assigned compute graphs, maintaining privacy and security constraints. The received compute graph is further broken down and distributed among internal components of each federated node. This step enables partial or blind execution, where some federated nodes may process only a portion of the overall computation, with limited visibility into the broader task. In a step 2640, the system monitors task progress and resource utilization across all federated nodes. As computations progress, each federated node reports back through the pipeline structure. This feedback includes task progress, resource utilization, and any issues encountered. The system aggregates this information, providing a high-level overview of the system's state.

In a step 2650, results from federated nodes are aggregated and processed, ensuring data privacy, security, and required compliance protocols, processes and auditable records (e.g., computational processes, transformations, compute, storage, and transport localities, software versions, SBOMs) are maintained where available. The system pieces together the final output from potentially encrypted or obfuscated results, maintaining the partial blindness of the execution where necessary. In a step 2660, the system dynamically adjusts compute graphs and task allocations based on real-time feedback and changing conditions within the federation. Based on the aggregated feedback, the system may decide to reallocate tasks or resources. It might modify compute graphs in real-time, reassign tasks to different federated nodes, or adjust resource allocations.

This process focuses on improving enablement of privacy-preserving data transformations in a federated system, explicitly including differential privacy within the workflow. This example embodiment may be inserted into the specification to more fully enable how raw data is protected across various federation nodes while still supporting system-wide analytics or AI-driven decision-making. The federated distributed graph-based computing platform (FDGCP) includes a privacy-preserving transformation pipeline that applies a combination of data anonymization, encryption, and differential privacy mechanisms before distributing any user-generated data to individual federated nodes. This architecture ensures that no single node within the federation can reconstruct raw or identifiable information, thereby complying with deontic constraints that mandate privacy preservation at each stage of distributed computation. Raw data—e.g., text inputs, medical logs, sensor readings—is first processed locally on each user device or organizational system, generating an obfuscated representation. The local component applies noise injection consistent with local differential privacy principles, such as Count Mean Sketch or Hadamard-based transformations. A per-donation privacy budget (ε) is enforced to limit the frequency and magnitude of user contributions and ensure that repeated submissions cannot be exploited to deduce personal information. Before sending the differentially private representation to any external node, device identifiers, IPs, or unique user tokens are stripped, and all communications occur over an encrypted channel. This ensures that even if intercepted, the data is already privatized and cannot be reverse-engineered to yield raw user information.

A federation manager (FM) reviews the metadata and the anonymized or differentially private data streams to determine the optimal assignment of computations among available federated nodes. This assignment is guided by constraints in the system's knowledge graphs, which encode deontic requirements, including privacy norms and obligations (e.g., “must not share raw data,” “must apply at least ε=2 for medical data”). Based on each node's clearance or capability, the FM routes only the required, already-transformed data subsets (e.g., randomly hashed vector slices with injected noise). Nodes thus never view raw user data and may only see partial anonymized fragments if the system designates additional “blind execution” constraints. Each node (whether an AI agent node, an edge cluster, or a data center) receives the privatized data segments and performs local computations (e.g., statistical counts, machine learning inferences, or partial token-based transformations). To glean global insights—such as trending words, prevalent symptoms, or energy drain patterns—the FDGCP aggregates partial, noise-injected results at a central aggregator or advanced aggregator nodes. Because each node's results remain noisy and identifier-free, the aggregator only reconstructs population-level patterns once large numbers of noisy contributions are averaged. The injected noise statistically cancels out at scale, enabling meaningful analytics while preserving individual privacy. The FDGCP enforces a per-user or per-node privacy budget. Once a user's daily or weekly quota is reached, their device either halts further data submissions or further increases noise in subsequent transmissions, ensuring compliance with the user's opt-in settings. For instance, high-sensitivity data like health record usage may have a lower daily submission limit (e.g., one donation per day, ε=2).

Each user device or organizational node can display logs (e.g., “DifferentialPrivacy*” files) detailing how many data points were contributed and which transformations were applied. Users may revoke the opt-in at any time, causing future transmissions to be halted or replaced with null data. Obligations such as “apply anonymization if data pertains to personal health info” or “inject at least X amount of noise for identified privacy risks” are encoded in the rules database or knowledge graph. The federation manager checks these constraints before routing data or orchestrating computations. If a node attempts to request raw data or attempts to exceed the permitted privacy budget, the FDGCP rejects the request in real time. Automatic logs record the violation attempt and notify relevant administrators or human agents, ensuring compliance with obligations and prohibitions set forth by regulatory or organizational policies. Once aggregated, the final differentially private statistics—such as trending keyboard suggestions, frequently used medical procedure codes, or popular emojis—are shared with authorized system components or organizational stakeholders without revealing any individual-level data. The FDGCP may monitor error rates or anomalies in aggregated results and adjust the noise parameters accordingly. This dynamic tuning helps balance accuracy with privacy over time, guided by the same deontic constraints that require a minimum standard of user privacy. Through differential privacy integrated with anonymization, encryption, and partial/blind execution, this embodiment ensures the federated system can benefit from aggregated data insights while fully respecting user-level confidentiality. In every step—from local device transformations to multi-node aggregation—robust privacy constraints are automatically enforced, preserving user anonymity and adhering to the platform's deontic mandates.

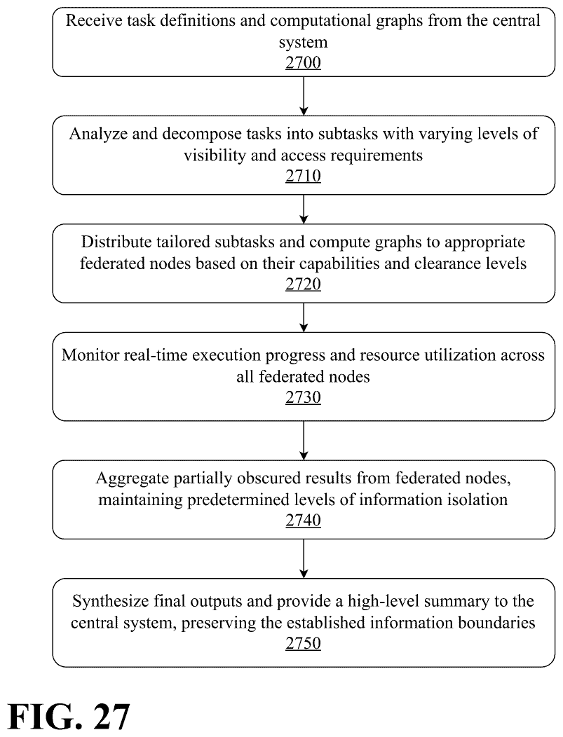

FIG. 27 is a flow diagram illustrating an exemplary method for a federated distributed graph-based computing platform that includes a federation manager. In a step 2700, the system receives task definitions and computational graphs from the central system. This initiates the process of distributed computing, where complex tasks are represented as computational graphs that can be broken down and distributed across the federation. These graphs encapsulate the structure, dependencies, and data requirements of the overall computational task.

In a step 2710, the system analyzes and decomposes tasks into subtasks with varying levels of visibility and access requirements. This step involves breaking down the received computational graphs into smaller, manageable components. Each subtask is assigned specific visibility and access levels, enabling the system to implement partial or blind execution strategies. This decomposition allows for fine-grained control over information flow within the federated network. In a step 2720, the system distributes tailored subtasks and compute graphs to appropriate federated nodes based on their capabilities and clearance levels. This distribution process takes into account the specific attributes of each federated node, including its computational resources, security clearance, and current workload. The system ensures that each node receives only the information and tasks it is authorized to process, maintaining the integrity of the partial blindness approach.

In a step 2730, the system monitors real-time execution progress and resource utilization across all federated nodes. This ongoing monitoring process allows the system to track the progress of distributed tasks, assess the performance of individual nodes, and identify any bottlenecks or issues in real-time. The system collects data on task completion rates, resource usage, and any anomalies encountered during execution. In a step 2740, the system aggregates partially obscured results from federated nodes, maintaining predetermined levels of information isolation. As federated nodes complete their assigned subtasks, they return results that may be intentionally obscured or encrypted to maintain the partial blindness of the execution. The system collects these results, ensuring that the predetermined levels of information isolation are preserved throughout the aggregation process.

In a step 2750, the system synthesizes final outputs and provides a high-level summary to the central system, preserving the established information boundaries. This final step involves combining the partially obscured results into a coherent output that addresses the original task requirements. The system generates a high-level summary that encapsulates the results of the distributed computation while carefully maintaining the information boundaries established earlier in the process. This summary is then provided to the central system, completing the federated computation cycle while preserving the security and privacy constraints of the distributed network.

The system includes an Adaptive Persona Graph—a new subsystem where each agent can switch or blend “personas” dynamically based on real-time user context, legal constraints, or shifting objectives. Rather than having a single, static agent role (e.g., “legal agent,” “medical agent”), each agent can morph into specialized micro-personas on demand—like a finance-minimizer role, a safety-checking role, or a patient-privacy role—while continuing to share relevant chain-of-thought data (when permissible) with other agents in the federation. Today's multi-agent or LLM-based systems typically have fixed roles (e.g., a “data scientist agent,” a “legal agent”). By allowing real-time persona transformations, the platform could serve many more use cases with fewer “hard-coded” roles, drastically reducing integration overhead and speeding time to market. In heavily regulated industries (healthcare, finance, defense), the persona graph can dynamically spin up more “compliance-heavy” personas whenever a new regulation is triggered or the system encounters sensitive data. Agents become “shape-shifters,” pulling micro-personas from a shared knowledge bank (like sub-experts). For instance, in a complex scenario (patient has unexpected allergic reaction mid-surgery), the system can activate “Allergy Specialist Persona” logic on the same agent that was previously just an “Emergency Room Persona.” This flexible reconfiguration offers a powerful commercial advantage: fewer overall agents, but more “plug-and-play” domain expansions. Through the persona graph, agents can share just the relevant portion of their chain-of-thought with other newly minted or combined personas, controlled by the deontic reasoning subsystem. This partial or ephemeral chain-of-thought sharing is crucial for human auditors or cross-expert synergy but still adheres to user-defined or legally defined “do not reveal” constraints. We can license “persona modules” or “domain expansions” to enterprise clients. Each module (a new persona) can be downloaded and integrated dynamically, making the platform capable of serving as a more dynamic “one-stop shop” for specialized AI roles. This “marketplace of personas” has clear commercial potential: enterprise customers purchase or rent specialized persona expansions for specific tasks. The system maintains a central Persona Registry—a specialized knowledge structure that describes each persona's constraints, domain knowledge, and gating logic. Nodes in the Persona Graph represent either a base persona or an extension (e.g., “medical-surgical extension,” “HIPAA compliance extension”). Edges indicate how they can combine or switch under certain triggers (time-based, event-based, or user-defined). Whenever the system receives new tasks, detects new constraints, or spots an agent overload or context shift, the federation manager references the Persona Graph to see if the agent should remap itself to a new persona set. For example, if the user's query is about advanced cardiology, the system merges the “medical-surgery persona” with the “cardiology extension,” effectively forming a specialized persona on-the-fly. Once a persona switch is invoked, the system consults the deontic constraints to see which chain-of-thought fragments from the old persona can be safely handed over to the new persona. Some details might be redacted if they violate domain rules or privacy constraints. Chain-of-Thought Fusion occurs if the new persona can legally or ethically inherit relevant context from prior persona states.

The multi-agent debate layer uses the persona graph so that each agent with newly combined personas can produce or rebut arguments from different vantage points. If a “risk-averse” persona merges with a “cost-minimizing” persona, the debate module might see a “hybrid stance” that weighs both cost and risk in real time. By storing each persona's clearance or obligations in the knowledge graph, the system ensures that no new persona composition violates mandatory constraints. The system can also integrate short-lived ephemeral “secret persona expansions” for top-secret data. Once the relevant sub-task ends, that persona is archived or “disposed,” removing any risk of unauthorized re-use. The Persona Registry is implemented as a specialized data store or extension of the knowledge graph that enumerates each persona's domain, obligations, permissible chain-of-thought scope, and “fusion eligibility” rules. When triggered, the system merges two or more persona nodes into a composite persona node, akin to unifying classes in object-oriented programming, but at runtime, guided by the deontic rules.

Each persona can store partial memory or retrieval indexes (embedding-based or knowledge-graph-based). On persona switch, memory pointers are reassigned or locked based on security levels. Every persona shift is logged with timestamps and rationales, crucial for compliance audits: “At T=12:05, agent #3 switched from persona ‘ER-doctor’ to persona ‘ER-doctor+Cardiology extension’ due to detecting arrhythmia data.” We could optionally define a marketplace where third parties can develop specialized persona expansions. For instance, a recognized health authority could publish a “Pediatric Care Persona,” or a big law firm could publish a “Tax-Law Persona.” Enterprises buy or license these expansions, installing them into the platform. The system's federation manager ensures they only function for tasks and data streams that meet relevant constraints. Consider a user scenario: A large medical device manufacturer deploying an advanced multi-agent solution for remote surgeries and real-time compliance checks. Starting with a “General Surgery Persona” controlling an AI-driven robotic arm, when real-time vitals indicate potential heart failure, the system consults the Persona Graph and sees that a “Cardiology Persona Extension” is available from a licensed domain pack. The system merges the “General Surgery Persona”+“Cardiology Persona Extension” into a new “Cardio-Surgery Persona” while maintaining HIPAA compliance. The system verifies the newly formed persona can see the relevant chain-of-thought about bleeding or sedation but must not see certain extraneous personal info. Partial chain-of-thought is transferred, partial is masked.

An additional embodiment of the invention further enhances the AI Agent Decision Platform by integrating advanced graph signal processing techniques, specifically, the Graph Fractional Fourier Transform in Hilbert Space (HGFRFT) and Spatio-Spectral Graph Neural Networks (S2GNNs), with the existing deontic reasoning framework. In this embodiment, the quantum-inspired token management system is extended to enable the analysis of complex chain-of-thought (CoT) representations with improved spectral precision while maintaining strict deontic compliance. This is accomplished by establishing an isomorphism between the token space and a tensor product space, H⊗Cⁿ, where H denotes the Hilbert space of token embeddings, endowed with an orthonormal basis Ψ, and Cⁿ represents the graph domain of agent interactions, defined with an orthonormal basis Φ. Such a construction facilitates a unified representation that captures both the semantic content of token states and the relational structure of the knowledge graph, thereby enabling an enriched analysis of temporal-causal relationships inherent in agent reasoning.

In one exemplary implementation, the system is implemented as a dual-pathway processing architecture to analyze CoT graphs. The spatial pathway employs conventional message passing across the knowledge graph G, ensuring effective propagation of information among agents. Concurrently, the spectral pathway operates on a truncated eigendecomposition of the graph Laplacian L_G to capture high-resolution spectral features of the reasoning chains. For directed reasoning flows, a Magnetic Laplacian L_M is constructed to encode directional information, with appropriate zero-padding techniques applied to accommodate directed acyclic graph (DAG) structures. For each reasoning chain function f∈S(H,G), an HGFRFT is computed using optimally selected fractional orders α and β, such that:

F_{(α,β)}(f)=<f,ψ_{(α)},⊗φ_{(β)}>,

where ψ_{(α)}, and ψ_{(β)}, represent the fractional basis functions corresponding to the token and graph domains, respectively. Spectral filters parameterized by translated Gaussian basis functions are then applied to F_{(α,β)}(f) to enhance the resolution of reasoning patterns and to capture subtle causal dependencies across multi-agent interactions.

To integrate deontic compliance within this spectral framework, deontic constraints—encompassing obligations, permissions, and prohibitions—are mapped to corresponding spectral operators D_C. A compliance score for each reasoning chain is evaluated as:

C(f)=<F_{(α,β)}(f),D_C>,

thereby quantifying the degree to which the transformed reasoning chain adheres to the prescribed deontic rules. The system then applies an inverse HGFRFT, with modifications guided by the compliance score, to reconstruct an enhanced reasoning chain that is both spectrally optimized and deontically validated. This reconstruction is subjected to rigorous validation against the original constraints, ensuring that the enriched representation preserves semantic fidelity while fulfilling regulatory and ethical requirements.

The integration of HGFRFT and S2GNN frameworks yields quantifiable performance enhancements. Spectral efficiency is improved compared to conventional graph Fourier transform methods, and the use of dual-pathway processing mitigates issues such as information over-squashing during message propagation. Furthermore, the incorporation of free-of-cost positional encodings derived from partial eigendecompositions enables superior expressivity, surpassing conventional 1-Weisfeiler-Leman tests in differentiating semantically similar yet logically distinct reasoning patterns. From a computational standpoint, the additional HGFRFT operations incur an O(n log n) complexity in n-dimensional token spaces, ensuring that the enhanced analysis remains tractable within the platform's scalable architecture.

Moreover, the S2GNN integration introduces a dual spatial-spectral pathway that enables refined local-global integration during structured agent debates. The Magnetic Laplacian formulation preserves directional information in reasoning flows, while its real eigenvalue properties facilitate stable spectral analysis. The advanced channel-wise Gaussian parameterization inherent in S2GNNs further supports gradient-based optimization of reasoning trajectories, driving them towards optimal deontic compliance while preserving semantic coherence. Enhanced circuit breaker mechanisms, leveraging early spectral detection of potential constraint violations, provide real-time supervisory control that preempts deontic breaches and ensures graceful system intervention.

According to an implementation of an embodiment within the existing architectural framework, the tensor product basis construction may be incorporated within the quantum knowledge orchestrator 2800 to maintain compatibility with current token encoding methodologies. The enhanced dual-pathway processing may be realized by extending the capabilities of the graph operator 3210 to integrate both spatial message passing and spectral filtering. The Magnetic Laplacian may be implemented as an extension to the relation-aware modeling component 610, ensuring seamless backward compatibility and integration with prior embodiments. This embodiment, by uniting advanced HGFRFT and S2GNN techniques with deontic reasoning, substantially elevates the system's capability for nuanced chain-of-thought analysis and offers a robust, scalable pathway for managing complex, multi-agent decision-making processes while maintaining rigorous ethical compliance.

### Exemplary Computing Environment

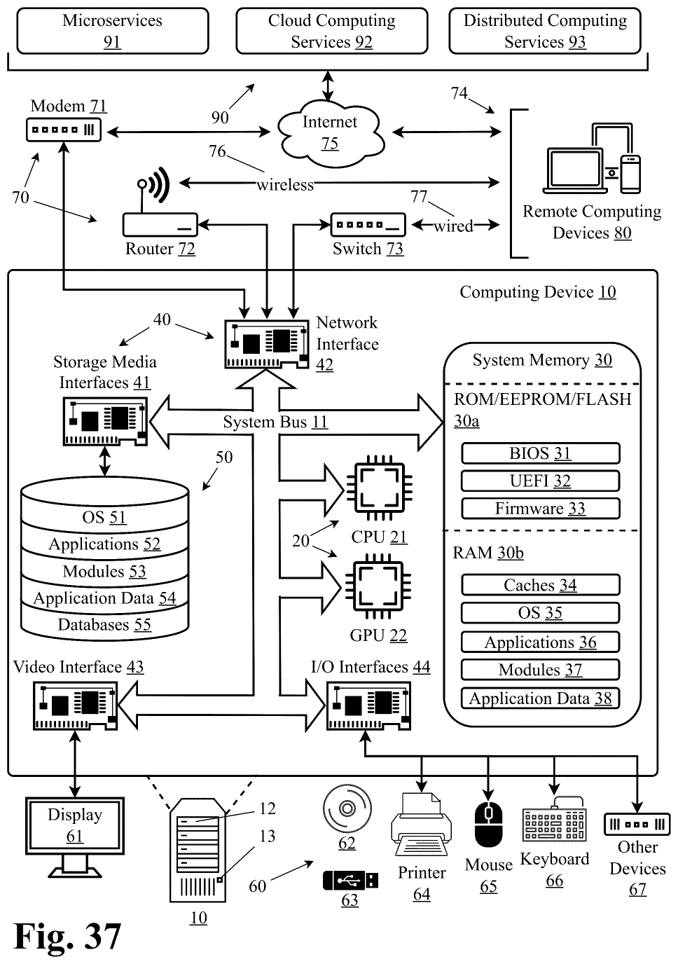

FIG. 37 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44. Network interface 42 may support various communication standards and protocols, such as Ethernet and Small Form-Factor Pluggable (SFP). Ethernet is a widely used wired networking technology that enables local area network (LAN) communication. Ethernet interfaces typically use RJ45 connectors and support data rates ranging from 10 Mbps to 100 Gbps, with common speeds being 100 Mbps, 1 Gbps, 10 Gbps, 25 Gbps, 40 Gbps, and 100 Gbps. Ethernet is known for its reliability, low latency, and cost-effectiveness, making it a popular choice for home, office, and data center networks. SFP is a compact, hot-pluggable transceiver used for both telecommunication and data communications applications. SFP interfaces provide a modular and flexible solution for connecting network devices, such as switches and routers, to fiber optic or copper networking cables. SFP transceivers support various data rates, ranging from 100 Mbps to 100 Gbps, and can be easily replaced or upgraded without the need to replace the entire network interface card. This modularity allows for network scalability and adaptability to different network requirements and fiber types, such as single-mode or multi-mode fiber.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may be implemented using various technologies, including hard disk drives (HDDs) and solid-state drives (SSDs). HDDs use spinning magnetic platters and read/write heads to store and retrieve data, while SSDs use NAND flash memory. SSDs offer faster read/write speeds, lower latency, and better durability due to the lack of moving parts, while HDDs typically provide higher storage capacities and lower cost per gigabyte. NAND flash memory comes in different types, such as Single-Level Cell (SLC), Multi-Level Cell (MLC), Triple-Level Cell (TLC), and Quad-Level Cell (QLC), each with trade-offs between performance, endurance, and cost. Storage devices connect to the computing device 10 through various interfaces, such as SATA, NVMe, and PCIe. SATA is the traditional interface for HDDs and SATA SSDs, while NVMe (Non-Volatile Memory Express) is a newer, high-performance protocol designed for SSDs connected via PCIe. PCIe SSDs offer the highest performance due to the direct connection to the PCIe bus, bypassing the limitations of the SATA interface. Other storage form factors include M.2 SSDs, which are compact storage devices that connect directly to the motherboard using the M.2 slot, supporting both SATA and NVMe interfaces. Additionally, technologies like Intel Optane memory combine 3D XPoint technology with NAND flash to provide high-performance storage and caching solutions. Non-volatile data storage devices 50 may be non-removable from computing device 10, as in the case of internal hard drives, removable from computing device 10, as in the case of external USB hard drives, or a combination thereof. However, computing devices will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, knowledge graph databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90. Also, certain processing subtasks may be sent to a microservice 91 for processing with the result being transmitted to computing device 10 for incorporation into a larger processing task. Infrastructure as Code (IaaC) tools like Terraform can be used to manage and provision computing resources across multiple cloud providers or hyperscalers. This allows for workload balancing based on factors such as cost, performance, and availability. For example, Terraform can be used to automatically provision and scale resources on AWS spot instances during periods of high demand, such as for surge rendering tasks, to take advantage of lower costs while maintaining the required performance levels. In the context of rendering, tools like Blender can be used for object rendering of specific elements, such as a car, bike, or house. These elements can be approximated and roughed in using techniques like bounding box approximation or low-poly modeling to reduce the computational resources required for initial rendering passes. The rendered elements can then be integrated into the larger scene or environment as needed, with the option to replace the approximated elements with higher-fidelity models as the rendering process progresses.

In an implementation, the disclosed systems and methods may utilize, at least in part, containerization techniques to execute one or more processes and/or steps disclosed herein. Containerization is a lightweight and efficient virtualization technique that allows users, applications, or agents to package and run applications and their dependencies in isolated environments called containers. One of the most popular containerization platforms is containerd, which is widely used in software development and deployment. Containerization, particularly with open-source technologies like containerd and container orchestration systems like Kubernetes, is a common approach for deploying and managing applications. Containers are created from images, which are lightweight, standalone, and executable packages that include application code, libraries, dependencies, and runtime. Images are often built from a containerfile or similar, which contains instructions for assembling the image. Containerfiles are configuration files that specify how to build a container image. Systems like Kubernetes natively support containerd as a container runtime. They include commands for installing dependencies, copying files, setting environment variables, and defining runtime configurations. Container images can be stored in repositories, which can be public or private. Organizations often set up private registries for security and version control using tools such as Harbor, JFrog Artifactory and Bintray, GitLab Container Registry, or other container registries. Containers can communicate with each other and the external world through networking. Containerd provides a default network namespace, but can be used with custom network plugins. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerized resources are used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance or uncertainty over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A computing system comprising a hardware memory, wherein the computer system is configured to execute software instructions stored on a non-transitory machine-readable storage media that:
receive a plurality of tokens representing deontic constraints and domain-specific knowledge;
encode the plurality of tokens into a plurality of quantum state representations, wherein each quantum state representation comprises complex amplitudes and phase information;
calculate a plurality of information-theoretic metrics for the quantum state representations, wherein the information-theoretic metrics comprise von Neumann entropy and quantum mutual information;
generate quantum similarity scores between the plurality of quantum state representations based on the calculated plurality of information-theoretic metrics;
create weighted superpositions of quantum state representations according to a plurality of priority weights;
apply a plurality of phase alignment transformations to the weighted superpositions to maximize coherence between quantum-inspired state representations;
generate compute graphs for distributing quantum token operations across processing nodes while maintaining deontic constraints; and
update knowledge graphs with the quantum state representations.

2. The computing system of claim 1, wherein generating quantum similarity scores comprises:
computing interference patterns between quantum state representations;
calculating geometric distances between states using both amplitude and phase information; and
combining interference and distance metrics into normalized similarity scores.

3. The computing system of claim 1, wherein creating weighted superpositions comprises:
assigning priority weights to quantum states based on authority levels, contextual relevance, and confidence scores;
normalizing the priority weights to ensure a balanced representation across multiple states; and
combining multiple quantum states while preserving phase relationships.

4. A computer-implemented method for AI agent decision platform with deontic reasoning and quantum-inspired token management, the computer-implemented method comprising the steps of:
receiving a plurality of tokens representing deontic constraints and domain-specific knowledge;
encoding the plurality of tokens into a plurality of quantum state representations, wherein each quantum state representation comprises complex amplitudes and phase information;
calculating a plurality of information-theoretic metrics for the quantum state representations, wherein the information-theoretic metrics comprise von Neumann entropy and quantum mutual information;
generating quantum similarity scores between the plurality of quantum state representations based on the calculated plurality of information-theoretic metrics;
creating weighted superpositions of quantum state representations according to a plurality of priority weights;
applying a plurality of phase alignment transformations to the weighted superpositions to maximize coherence between quantum-inspired state representations;
generating compute graphs for distributing quantum token operations across processing nodes while maintaining deontic constraints; and
updating knowledge graphs with the quantum state representations.

5. The method of claim 4, wherein generating quantum similarity scores comprises:
computing interference patterns between quantum state representations;
calculating geometric distances between states using both amplitude and phase information; and
combining interference and distance metrics into normalized similarity scores.

6. The method of claim 4, wherein creating weighted superpositions comprises:
assigning priority weights to quantum states based on authority levels, contextual weighting, and confidence scores;
normalizing the priority weights to ensure balanced representation of multiple perspectives; and
combining multiple quantum states while preserving phase relationships.
